(19) United States
(12) Patent Application Publication
(10) Pub. No.: US 2014/0161192 A1
(43) Pub. Date: Jun. 12, 2014

(54) IMAGE PROCESSING DEVICE AND METHOD

(71) Applicant: Sony Corporation, Minato-ku, TOKYO (JP)

(72) Inventor: Kazushi Sato, Kanagawa (JP)

(73) Assignee: SONY CORPORATION, Tokyo (JP)

(21) Appl. No.: 14/240,085

(22) PCT Filed: Oct. 19, 2012
(86) PCT No.: PCT/JP2012/077108

§ 371 Date: Feb. 21, 2014

(30) Foreign Application Priority Data
Oct. 20, 2011 (JP) 2011-230331
Jun. 15, 2012 (JP) 2012-135405

(51) Int. Cl. H04N 19/55

(52) U.S. Cl. CPC H04N 19/00642
USPC 375/240.16

(57) ABSTRACT

The present disclosure relates to an image processing device and method capable of causing the reduction of the amount of memory access and the amount of computation to be realized with suppressing image deterioration, in encoding or decoding a motion vector. In response to an operation of a user, input via an operation input unit not illustrated in a drawing, a temporal prediction control unit sets whether or not a temporal prediction motion vector out of prediction motion vectors is available, with respect to each of the prediction directions of List0 and List1. On the basis of the setting of whether or not the temporal prediction motion vector in each prediction direction is available, the temporal prediction control unit controls the use (generation) of the temporal prediction motion vector by a motion vector encoding unit. The present disclosure may be applied to, for example, an image processing device.

### TECHNICAL FIELD

The present disclosure relates to an image processing device and method and, in particular, an image processing device and method capable of causing the reduction of the amount of memory access and the amount of computation to be realized with suppressing image deterioration.

### BACKGROUND ART

In recent years, devices have been becoming prevalent that compression-code images by adopting an encoding method in which image information is digitally handled and, on this occasion, is compressed by an orthogonal transform such as a discrete cosine transform and by motion compensation, using a redundancy particular to image information for the purpose of achieving highly efficient transmission and accumulation of information. Examples of this encoding method include MPEG (Moving Picture Experts Group) and so forth.

In particular, MPEG2 (ISO/IEC 13818-2) is defined as a general-purpose image encoding format, and is a standard that covers both interlaced scanning images and progressive scanning images as well as standard-resolution images and high-definition images. For example, the MPEG2 is currently widely used in a wide range of applications for professional use and consumer use. With use of the MPEG2 compression method, in the case of a standard-resolution interlaced scanning image having, for example, 720×480 pixels, an amount of code (bit rate) of 4 to 8 Mbps is allocated. In addition, with use of the MPEG-2 compression method, in the case of a high-resolution interlaced scanning image having, for example, 1920×1088 pixels, an amount of code (bit rate) of 1.8 to 22 Mbps is allocated. Owing to this, it is possible to realize a high compression rate and favorable image quality.

The MPEG2 has been mainly used for high image quality encoding suitable for broadcasting, but has not been compatible with coding methods of an amount of code (bit rate) lower than that of MPEG1, in other words, a higher compression rate. With the widespread use of mobile terminals, it has been thought that the need for such coding methods will increase in the future, and in response to this, a MPEG4 coding method has been standardized. Regarding image encoding methods, the specification thereof was approved as an international standard as ISO/IEC 14496-2 in December 1998.

As a standardization schedule, an international standard called H.264 and MPEG-4 Part 10 (Advanced Video Coding, hereinafter referred to as AVC) was established in March 2003.

Furthermore, as an extension of the H.264/AVC, standardization of FRExt (Fidelity Range Extension), including encoding tools necessary for business use, such as RGB, 4:2:2, and 4:4:4, as well as 8×8 DCT and quantization matrices defined in MPEG-2, was completed in February 2005. Accordingly, a coding format capable of favorably expressing even film noise included in movies, using H.264/AVC, has been established, which is used for a wide range of applications such as Blu-Ray Discs (registered trademark).

However, there has recently been a growing need for encoding at a higher compression rate, for example, an intention to compress an image having about 4000×2000 pixels, which is four times that of a high-vision image, or an intention to distribute high-vision images in an environment with a limited transmission capacity, such as the Internet. Therefore, in VCEG (Video Coding Expert Group) under ITU-T, which is described above, studies for improving encoding efficiency have been continued and performed.

As one of such encoding efficiency improvements, adaptively using, as prediction motion vector information, either of a “Temporal Predictor” and a “Spatio-Temporal Predictor” in addition to a “Spatial Predictor” defined in AVC and obtained through median prediction (hereinafter, also referred to as MV competition (MV Competition)) has been proposed in order to improve the encoding of a motion vector utilizing the median prediction in the AVC (for example, refer to Non Patent Document 1).

In addition, in the AVC, in a case where the prediction motion vector information is selected, a cost function value is used that is based on High Complexity Mode or Low Complexity Mode implemented into reference software of the AVC called JM (Joint Model).

In other words, a cost function value in a case where the prediction motion vector information is used is calculated, and selection of optimal prediction motion vector information is performed. In image compression information, flag information is transmitted that indicates information relating to which prediction motion vector information has been used for each block.

Incidentally, there has been a possibility that setting a macroblock size to 16 pixels×16 pixels may not be most suitable with respect to a large image frame such as UHD (Ultra High Definition; 4000 pixels×2000 pixels), which is a target of a next generation encoding method.

Therefore, for the purpose of further improving an encoding efficiency compared with the AVC, standardization of a coding method called HEVC (High Efficiency Video Coding) is currently being conducted by JCTVC (Joint Collaboration Team-Video Coding), which is a joint standardization team of ITU-T and ISO/IEC (see, for example, Non Patent Document 2).

In the HEVC coding method, a coding unit (CU (Coding Unit)) is defined as a unit of processing which is similar to a macroblock used in the AVC. Unlike the macroblock used in the AVC, the size of this coding unit (CU) is not fixed to 16×16 pixels, and is specified within image compression information in each sequence. In addition, in each sequence, the maximum size (LCU (Largest Coding Unit)) and the minimum size (SCU (Smallest Coding Unit)) of a coding unit are also specified.

Furthermore, in addition, in Non Patent Document 2, it is possible to transmit a quantization parameter (QP) in a Sub-LCU (Sub-LCU) unit. Which size of a coding unit the quantization parameter is to be transmitted for is specified within the image compression information with respect to each picture. In addition, information relating to the quantization parameter, included within the image compression information, is transmitted in units of individual coding units.

In addition, one of encoding methods for motion information, a method called Motion Partition Merging (hereinafter, also referred to as a merge mode (Merge mode)) has been proposed (see, for example, Non Patent Document 3). In this method, in a case where the motion information of a relevant block is the same as the motion information of a neighboring block, only flag information is transmitted, and in a case of decoding, the motion information of the relevant block is reconstructed using the motion information of the neighboring block.

Furthermore, in the HEVC method, in addition to a sequence parameter set (SPS (Sequence Parameter Set)) and a picture parameter set (PPS (Picture Parameter Set)), specified in the AVC, such an adaptation parameter set (APS (Adaptation Parameter Set) as proposed in Non Patent Document 4 is specified.

The adaptation parameter set (APS) is a parameter set (Parameter Set) of a picture unit, and is syntax used for transmitting an encoding parameter to be adaptively updated in a picture unit, such as an adaptive loop filter (Adaptive Loop Filter).

Incidentally, in the above-mentioned MV competition (MV Competition) or merge mode (Merge mode), motion vector information is stored in a line buffer, the motion vector information relating to an spatially adjacent PU (Prediction Unit) necessary for applying a spatial prediction motion vector (Spatial predicor).

### CITATION LIST

### Non Patent Document

Non Patent Document 1: Joel Jung, Guillaume Laroche, “Competition-Based Scheme for Motion Vector Selection and Coding”, VCEG-AC06, ITU—Telecommunications Standardization SectorSTUDY GROUP 16 Question 6Video Coding Experts Group (VCEG) 29th Meeting: Klagenfurt, Austria, 17-18 July, 2006
Non Patent Document 2: Thomas Wiegand, Woo-Jin Han, Benjamin Bross, Jens-Rainer Ohm, Gary J. Sullivan, “Working Draft 4 of High-Efficiency Video Coding”, JCTVC-F803, Joint Collaborative Team on Video Coding (JCT-VC) of ITU-T SG16 WP3 and ISO/IEC JTC1/SC29/WG11 6th Meeting: Torino, IT, 14-22 July, 2011
Non Patent Document 3: Martin Winken, Sebastian Bosse, Benjamin Bross, Philipp Helle, Tobias Hinz, Heiner Kirchhoffer, Haricharan Lakshman, Detlev Marpe, Simon Oudin, Matthias Preiss, Heiko Schwarz, Mischa Siekmann, Karsten Suchring, and Thomas Wiegand, “Description of video coding technology proposed by Fraunhofer HHI”, JCTVC-A116, April, 2010
Non Patent Document 4: Stephan Wenger, Jill Boyce, Yu-Wen Huang, Chia-Yang Tsai, Ping Wu, and Ming Li, “Adaptation Parameter Set (APS)”, JCTVC-F747r3, Joint Collaborative Team on Video Coding (JCT-VC) of ITU-T SG16 WP3 and ISO/IEC JTC1/SC29/WG11 6th Meeting: Torino, IT, 14-22 July, 2

### SUMMARY OF INVENTION

### Technical Problem

However, in the above-mentioned MV competition (MV

Competition) or merge mode (Merge mode), motion vector information is stored in a memory, the motion vector information relating to an temporally adjacent PU (Prediction Unit) necessary for applying a temporal prediction motion vector (Temporal predicor). Therefore, there has been a possibility that it is necessary to extract information stored in the memory and memory access is caused to be increased.

On the other hand, if, in the MV competition (MV Competition) or the merge mode (Merge mode), encoding processing is performed using only a spatial prediction motion vector (Spatial predicor) without using a temporal prediction motion vector (Temporal predicor), there has been a possibility that an encoding efficiency is reduced.

The present disclosure has been made in view of these circumstances, and is directed to realizing the reduction of the amount of memory access and the amount of computation with suppressing image deterioration, in the encoding or the decoding of a motion vector.

### Technical Solution

An image processing device of one aspect of the present disclosure includes a reception unit that receives a flag with respect to each prediction direction and an encoded stream with a prediction motion vector as a target, the prediction motion vector being used in decoding a motion vector of a current region in an image, the flag indicating whether or not a temporal prediction vector generated using a motion vector of a temporally neighboring region temporally located on the periphery of the current region is available, a prediction motion vector generation unit that generates a prediction motion vector of the current region using a motion vector of a neighboring region located on the periphery of the current region, on the basis of whether or not the temporal prediction vector is available, which is indicated by the flag received by the reception unit, a motion vector decoding unit that decodes the motion vector of the current region using the prediction motion vector generated by the prediction motion vector generation unit, and a decoding unit that decodes, using the motion vector decoded by the motion vector decoding unit, the encoded stream received by the reception unit and generates the image.

The reception unit may receive a flag with respect to each prediction direction, the flag indicating whether or not the temporal prediction vector is available and being set in a parameter in a picture unit.

The temporal prediction vector is set to be available with respect to one of the prediction directions, and set to be unavailable with respect to the other of the prediction directions.

In a case where a current picture is a picture in which rearrangement exists, the one of the prediction directions is a List0 direction, and in a case where the current picture is a picture in which rearrangement does not exist, the one of the prediction directions is a List1 direction.

In a case where a distance of a reference picture from a current picture in a List0 direction is different from a distance of a reference picture from the current picture in a List1 direction, the one of the prediction directions is a direction with respect to a reference picture near to the current picture on a temporal axis.

The flag with respect to each prediction direction, which indicates whether or not the temporal prediction vector is available, is generated independently in AMVP (Advanced Motion Vector Prediction) and a merge mode.

In an image processing method of one aspect of the present disclosure, an image processing device receives a flag with respect to each prediction direction and an encoded stream with a prediction motion vector as a target, the prediction motion vector being used in decoding a motion vector of a current region in an image, the flag indicating whether or not a temporal prediction vector generated using a motion vector of a temporally neighboring region temporally located on the periphery of the current region is available, generates a prediction motion vector of the current region using a motion vector of a neighboring region located on the periphery of the current region, on the basis of whether or not the temporal prediction vector is available, which is indicated by the received flag, decodes the motion vector of the current region using the generated prediction motion vector, and decodes, using the decoded motion vector, the received encoded stream and generates the image.

An image processing device of another aspect of the present disclosure includes a temporal prediction control unit that sets, with respect to each prediction direction, whether or not a temporal prediction vector is available, with a prediction motion vector as a target, the prediction motion vector being used in encoding a motion vector of a current region in an image, the temporal prediction vector being generated using a motion vector of a temporally neighboring region temporally located on the periphery of the current region, a prediction motion vector generation unit that generates a prediction motion vector of the current region using a motion vector of a neighboring region located on the periphery of the current region, on the basis of whether or not the temporal prediction vector is available, which is set by the temporal prediction control unit, a flag setting unit that sets a flag with respect to each prediction direction, the flag indicating whether or not the temporal prediction vector is available, which is set by the temporal prediction control unit, and a transmitting unit that transmits the flag set by the flag setting unit and an encoded stream to which the image is encoded.

The flag setting unit may set, in a parameter in a picture unit, the flag with respect to each prediction direction, the flag indicating whether or not the temporal prediction vector is available, which is set by the temporal prediction control unit.

The temporal prediction control unit may set the temporal prediction vector to be available with respect to one of the prediction directions and set the temporal prediction vector to be unavailable with respect to the other of the prediction directions.

In a case where a current picture is a picture in which rearrangement exists, the one of the prediction directions is a List0 direction, and in a case where the current picture is a picture in which rearrangement does not exist, the one of the prediction directions is a List1 direction.

In a case where a distance of a reference picture from a current picture in a List0 direction is different from a distance of a reference picture from the current picture in a List1 direction, the one of the prediction directions is a direction with respect to a reference picture near to the current picture on a temporal axis.

The temporal prediction control unit may set independently whether or not the temporal prediction vector is available, in AMVP (Advanced Motion Vector Prediction) and a merge mode.

An image processing method of another aspect of the present disclosure includes setting, with respect to each prediction direction, whether or not a temporal prediction vector is available, with a prediction motion vector as a target, the prediction motion vector being used in encoding a motion vector of a current region in an image, the temporal prediction vector being generated using a motion vector of a temporally neighboring region temporally located on the periphery of the current region, generating a prediction motion vector of the current region using a motion vector of a neighboring region located on the periphery of the current region, on the basis of whether or not the temporal prediction vector is available, which is set, setting a flag with respect to each prediction direction, the flag indicating whether or not the temporal prediction vector is available, which is set, and transmitting the set flag and an encoded stream to which the image is encoded.

An image processing device of yet another aspect of the present disclosure includes a reception unit that receives encoded data of a parameter used in encoding an image and information indicating a pattern of whether or not temporal prediction is to be used that performs prediction using the parameter of a temporally neighboring region temporally located on the periphery of a current region, a prediction parameter generation unit that generates a prediction parameter serving as a prediction value of the parameter, in accordance with the pattern received by the reception unit, and a parameter decoding unit that decodes the encoded data of the parameter received by the reception unit, using the prediction parameter generated by the prediction parameter generation unit, and reconstructs the parameter.

The pattern may be a pattern specifying, for each picture, whether or not the temporal prediction is to be used, with respect to a plurality of pictures.

The pattern may classify whether or not the temporal prediction is to be used, on the basis of a layer of a hierarchical structure formed by the plural pictures.

The pattern may classify whether or not the temporal prediction is to be used, on the basis of an arrangement order of the plural pictures.

The parameter may be a motion vector, the prediction parameter may be a prediction motion vector, the reception unit may receive encoded data of the motion vector and the information indicating a pattern of whether or not the temporal prediction is to be used, the prediction parameter generation unit may generate the prediction motion vector using a prediction method specified in the encoded data of the motion vector, in accordance with the pattern received by the reception unit, and the parameter decoding unit may decode the encoded data of the motion vector received by the reception unit, using the prediction motion vector generated by the prediction parameter generation unit, and reconstruct the motion vector.

The parameter may be a difference between a quantization parameter of a block processed with preceding by one and a quantization parameter of a current block.

The parameter may be a parameter of a CABAC (Context-based Adaptive Binary Arithmetic Code) used for encoding of the image.

The reception unit may further receive encoded data of the image, and an image decoding unit may be further included that decodes the encoded data of the image received by the reception unit, using the parameter reconstructed by the parameter decoding unit.

An image processing method of yet another aspect of the present disclosure includes receiving encoded data of a parameter used in encoding an image and information indicating a pattern of whether or not temporal prediction is to be used that performs prediction using the parameter of a temporally neighboring region temporally located on the periphery of a current region, generating a prediction parameter serving as a prediction value of the parameter, in accordance with the received pattern, decoding the received encoded data of the parameter using the generated prediction parameter, and reconstructing the parameter.

An image processing device of yet another aspect of the present disclosure includes a setting unit that sets a pattern of whether or not temporal prediction is to be used that performs prediction using a parameter of a temporally neighboring region temporally located on the periphery of a current region, a prediction parameter generation unit that generates a prediction parameter serving as a prediction value of the parameter, in accordance with the pattern set by the setting unit, a parameter encoding unit that encodes the parameter using the prediction parameter generated by the prediction parameter generation unit, and a transmitting unit that transmits encoded data of the parameter, generated by the parameter encoding unit, and information indicating the pattern set by the setting unit.

A parameter generation unit that generates the parameter and an image encoding unit that encodes the image using the parameter generated by the parameter generation unit are further included, wherein the setting unit may set a pattern of whether or not the temporal prediction is to be used, the parameter encoding unit may encode the parameter generated by the parameter generation unit, using the prediction parameter, and the transmitting unit may further transmit encoded data of the image generated by the image encoding unit.

An image processing method of yet another aspect of the present disclosure includes setting a pattern of whether or not temporal prediction is to be used that performs prediction using a parameter of a temporally neighboring region temporally located on the periphery of a current region, generating a prediction parameter serving as a prediction value of the parameter, in accordance with the set pattern, encoding the parameter using the generated prediction parameter, and transmitting generated encoded data of the parameter and information indicating the set pattern.

In an aspect of the present disclosure, a flag with respect to each prediction direction and an encoded stream are received with a prediction motion vector as a target, the prediction motion vector being used in decoding a motion vector of a current region in an image, the flag indicating whether or not a temporal prediction vector generated using a motion vector of a temporally neighboring region temporally located on the periphery of the current region is available, and a prediction motion vector of the current region is generated using a motion vector of a neighboring region located on the periphery of the current region, on the basis of whether or not the temporal prediction vector is available, which is indicated by the received flag. In addition, the motion vector of the current region is decoded using the generated prediction motion vector, the received encoded stream is decoded using the decoded motion vector, and the image is generated.

In another aspect of the present disclosure, whether or not a temporal prediction vector is available is set with respect to each prediction direction, with a prediction motion vector as a target, the prediction motion vector being used in encoding a motion vector of a current region in an image, the temporal prediction vector being generated using a motion vector of a temporally neighboring region temporally located on the periphery of the current region, and a prediction motion vector of the current region is generated using a motion vector of a neighboring region located on the periphery of the current region, on the basis of whether or not the temporal prediction vector is available, which is set. In addition, a flag with respect to each prediction direction is set, the flag indicating whether or not the temporal prediction vector is available, which is set, and the set flag and an encoded stream to which the image is encoded are transmitted.

In yet another aspect of the present disclosure, encoded data of a parameter used in encoding an image and information indicating a pattern of whether or not temporal prediction is to be used that performs prediction using the parameter of a temporally neighboring region temporally located on the periphery of a current region are received, a prediction parameter serving as a prediction value of the parameter is generated in accordance with the received pattern, the received encoded data of the parameter is decoded using the generated prediction parameter, and the parameter is reconstructed.

In yet another aspect of the present disclosure, a pattern of whether or not temporal prediction is to be used that performs prediction using a parameter of a temporally neighboring region temporally located on the periphery of a current region is set, a prediction parameter serving as a prediction value of the parameter is generated in accordance with the set pattern, the parameter is encoded using the generated prediction parameter, and generated encoded data of the parameter and information indicating the set pattern are transmitted.

In addition, the above-mentioned image processing device may be an independent device, and may also be an internal block configuring one image encoding device or one image decoding device.

### Advantageous Effects

According to an aspect of the present disclosure, it is possible to decode an image. In particular, it is possible to realize the reduction of the amount of memory access and the amount of computation with suppressing image deterioration.

According to another aspect of the present disclosure, it is possible to encode an image. In particular, it is possible to realize the reduction of the amount of memory access and the amount of computation with suppressing image deterioration.

### BRIEF DESCRIPTION OF DRAWINGS

FIG. 1 is a block diagram illustrating an example of a main configuration of an image encoding device.

FIG. 2 is a diagram illustrating an example of motion prediction/compensation processing with decimal pixel accuracy.

FIG. 3 is a diagram illustrating an example of a macroblock.

FIG. 4 is a diagram explaining a median operation.

FIG. 5 is a diagram explaining a multi-reference frame.

FIG. 6 is a diagram explaining a temporal direct mode.

FIG. 7 is a diagram explaining a motion vector encoding method.

FIG. 8 is a diagram explaining an example of a configuration of a coding unit.

FIG. 9 is a diagram explaining Motion Partition Merging.

FIG. 10 is a diagram explaining encoding of a motion vector utilizing a temporal prediction motion vector in a case of bi-prediction.

FIG. 11 is a diagram explaining encoding of a motion vector utilizing a temporal prediction motion vector in a case of bi-prediction.

FIG. 12 is a block diagram illustrating examples of main configurations of a motion vector encoding unit, a temporal prediction control unit, and a lossless encoding unit.

FIG. 13 is a flowchart explaining an example of a flow of encoding processing.

FIG. 14 is a flowchart explaining an example of a flow of inter motion prediction processing.

FIG. 15 is a block diagram illustrating an example of a main configuration of an image decoding device.

FIG. 16 is a block diagram illustrating examples of main configurations of a lossless decoding unit, a motion vector decoding unit, and a temporal prediction control unit.

FIG. 17 is a flowchart explaining an example of a flow of decoding processing.

FIG. 18 is a flowchart explaining an example of a flow of motion vector reconstruction processing.

FIG. 19 is a block diagram illustrating another example of a configuration of an image encoding device.

FIG. 20 is a diagram explaining an example of a situation of encoding of motion vector information.

FIG. 21 is a diagram illustrating an example of a picture parameter set.

FIG. 22 is a diagram explaining an example of temporal prediction control.

FIG. 23 is a diagram explaining an example of a sequence parameter set.

FIG. 24 is a diagram explaining an example of a sequence parameter set and following FIG. 23.

FIG. 25 is a diagram explaining an example of temporal prediction control.

FIG. 26 is a diagram explaining an example of temporal prediction control.

FIG. 27 is a block diagram illustrating other examples of configurations of a temporal prediction control unit and a motion vector encoding unit.

FIG. 28 is a flowchart explaining another example of a flow of inter motion prediction processing.

FIG. 29 is a flowchart explaining an example of a flow of temporal prediction layer specification processing.

FIG. 30 is a flowchart explaining an example of a flow of candidate prediction motion vector generation processing.

FIG. 31 is a block diagram illustrating another example of a configuration of an image decoding device.

FIG. 32 is a block diagram illustrating other examples of configurations of a motion vector decoding unit and a temporal prediction control unit.

FIG. 33 is a flowchart explaining another example of a flow of decoding processing.

FIG. 34 is a flowchart explaining an example of a flow of temporal prediction control processing.

FIG. 35 is a flowchart explaining another example of a flow of motion vector reconstruction processing.

FIG. 36 is a diagram illustrating an example of syntax of a video parameter set.

FIG. 37 is a diagram illustrating an example of syntax of a buffering period SEI.

FIG. 38 is a diagram illustrating another example of syntax of a buffering period SEI.

FIG. 39 is a diagram illustrating an example of a multi-view image coding method.

FIG. 40 is a diagram illustrating an example of a main configuration of a multi-view image coding device to which the present technology is applied.

FIG. 41 is a diagram illustrating an example of a main configuration of a multi-view image decoding device to which the present technology is applied.

FIG. 42 is a diagram illustrating an example of a hierarchical image coding method.

FIG. 43 is a diagram illustrating an example of a main configuration of a hierarchical image coding device to which the present technology is applied.

FIG. 44 is a diagram illustrating an example of a main configuration of a hierarchical image decoding device to which the present technology is applied.

FIG. 45 is a block diagram illustrating an example of a main configuration of a computer.

FIG. 46 is a block diagram illustrating an example of a schematic configuration of a television device.

FIG. 47 is a block diagram illustrating an example of a schematic configuration of a mobile phone.

FIG. 48 is a block diagram illustrating an example of a schematic configuration of a recording/reproducing device.

FIG. 49 is a block diagram illustrating an example of a schematic configuration of an imaging device.

### DESCRIPTION OF EMBODIMENTS

Hereinafter, embodiments for implementing the present disclosure (hereinafter referred to as embodiments) will be described. In addition, the description will be performed in the following order.

1. First Embodiment (Image Encoding Device)

2. Second Embodiment (Image Decoding Device)

3. Third Embodiment (Image Encoding Device)

4. Fourth Embodiment (Image Decoding Device)

5. Fifth Embodiment (Syntax)

6. Sixth Embodiment (Multi-view image coding/Multi-View Image Decoding Device)

7. Seventh Embodiment (Hierarchical image coding/Hierarchical Image Decoding Device)

8. Eighth Embodiment (Computer)

9. Example of Application

### 1. First Embodiment

### Image Encoding Device

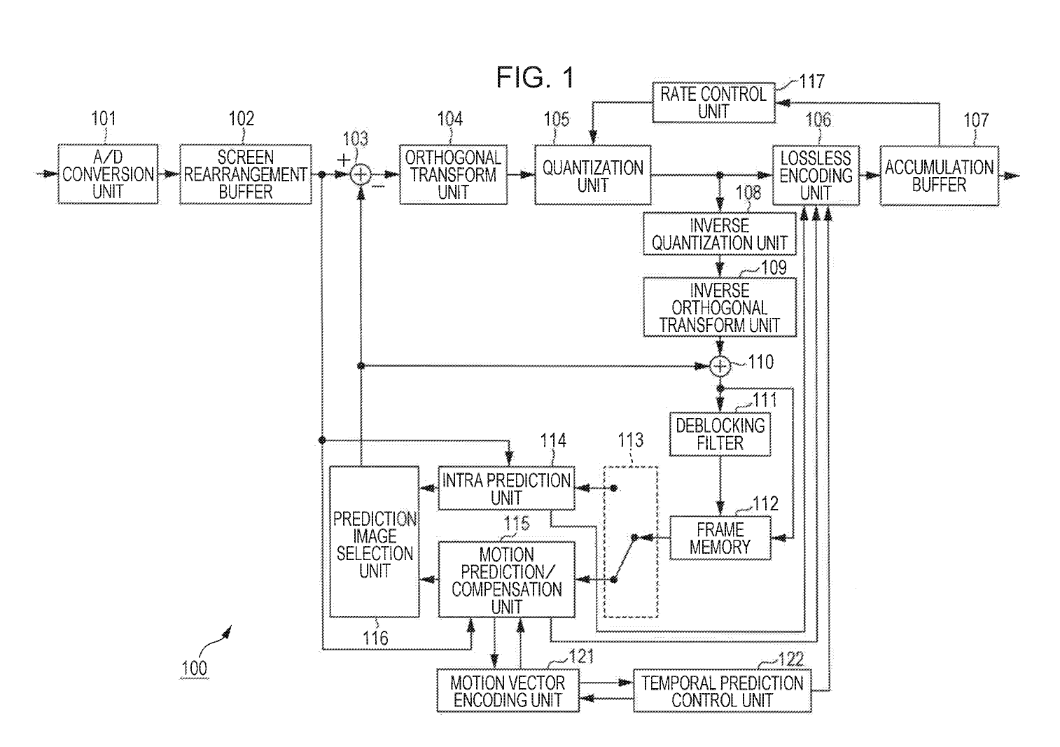

FIG. 1 is a block diagram illustrating an example of the main configuration of an image encoding device.

An image encoding device 100 illustrated in FIG. 1 encodes image data using prediction processing serving as a method based on, for example, HEVC (High Efficiency Video Coding).

As illustrated in FIG. 1, the image encoding device 100 includes an A/D conversion unit 101, a screen rearrangement buffer 102, a computing unit 103, an orthogonal transform unit 104, a quantization unit 105, a lossless encoding unit 106, an accumulation buffer 107, an inverse quantization unit 108, and an inverse orthogonal transform unit 109. In addition, the image encoding device 100 includes a computing unit 110, a deblocking filter 111, a frame memory 112, a selection unit 113, an intra prediction unit 114, a motion prediction/compensation unit 115, a prediction image selection unit 116, and a rate control unit 117.

The image encoding device 100 further includes a motion vector encoding unit 121 and a temporal prediction control unit 122.

The A/D conversion unit 101 A/D-converts input image data, supplies the image data (digital data) after the conversion to the screen rearrangement buffer 102, and causes the image data to be stored therein. The screen rearrangement buffer 102 rearranges, in accordance with a GOP (Group of Picture), a stored image of frames corresponding to a display order, in the order of frames for encoding, and supplies, to the computing unit 103, the image where the order of frames has been rearranged. In addition, the screen rearrangement buffer 102 also supplies, to the intra prediction unit 114 and the motion prediction/compensation unit 115, the image where the order of frames has been rearranged.

The computing unit 103 subtracts, from an image read out from the screen rearrangement buffer 102, a prediction image supplied from the intra prediction unit 114 or the motion prediction/compensation unit 115 via the prediction image selection unit 116, and outputs the difference information thereof to the orthogonal transform unit 104.

For example, in a case of an image on which inter encoding is performed, the computing unit 103 subtracts the prediction image supplied from the motion prediction/compensation unit 115, from the image read out from the screen rearrangement buffer 102.

The orthogonal transform unit 104 performs orthogonal transform such as discrete cosine transform or Karhunen-Loeve transform, on the difference information supplied from the computing unit 103. In addition, a method for the orthogonal transform is arbitrary. The orthogonal transform unit 104 supplies the transform coefficient thereof to the quantization unit 105.

The quantization unit 105 quantizes the transform coefficient supplied from the orthogonal transform unit 104. The quantization unit 105 sets a quantization parameter on the basis of information relating to the target value of the amount of code supplied from the rate control unit 117, and performs the quantization thereof. In addition, a method for this quantization is arbitrary. The quantization unit 105 supplies the quantized transform coefficient to the lossless encoding unit 106.

The lossless encoding unit 106 encodes the transform coefficient quantized in the quantization unit 105, using an arbitrary encoding method. Since coefficient data is quantized under control of the rate control unit 117, the amount of code thereof becomes the target value set by the rate control unit 117 (or approximate to the target value).

In addition, the lossless encoding unit 106 acquires, from the intra prediction unit 114, information indicating the mode of intra prediction, and so forth, and acquires, from the motion prediction/compensation unit 115, information indicating the mode of inter prediction, difference motion vector information, and so forth.

The lossless encoding unit 106 encodes these various kinds of information using an arbitrary encoding method, and sets these as a part of the header information of encoded data (also referred to as an encoded stream) (performs multiplexing). The lossless encoder 106 supplies the encoded data obtained by encoding, to the accumulation buffer 107, and causes the encoded data to be accumulated therein.

An encoding method for the lossless encoding unit 106, for example, variable-length coding, arithmetic coding, or the like is cited. As the variable-length coding, CAVLC (Context-Adaptive Variable Length Code) defined in the H.264/AVC method or the like may be cited. As the arithmetic coding, CABAC (Context-based Adaptive Binary Arithmetic Code) or the like may be cited.

The accumulation buffer 107 temporarily holds the encoded data supplied from the lossless encoding unit 106. The accumulation buffer 107 outputs the held encoded data to, for example, a recording device, a transmission path, or the like in a subsequent stage, not illustrated in a drawing, at a given timing. In other words, the accumulation buffer 107 also serves as a transmitting unit transmitting the encoded data.

In addition, the transform coefficient quantized in the quantization unit 105 is also supplied to the inverse quantization unit 108. The inverse quantization unit 108 performs inverse quantization on the quantized transform coefficient, using a method corresponding to the quantization performed by the quantization unit 105. A method for the inverse quantization may be any method if the method corresponds to the quantization processing performed by the quantization unit 105. The inverse quantization unit 108 supplies the obtained transform coefficient to the inverse orthogonal transform unit 109.

The inverse orthogonal transform unit 109 performs inverse orthogonal transform on the transform coefficient supplied from the inverse quantization unit 108, using a method corresponding to the orthogonal transform processing performed by the orthogonal transform unit 104. A method for the inverse orthogonal transform may be any method if the method corresponds to the orthogonal transform processing performed by the orthogonal transform unit 104. The output subjected to the inverse orthogonal transform (restored difference information) is supplied to the computing unit 110.

The computing unit 110 adds a prediction image from the intra prediction unit 114 or the motion prediction/compensation unit 115 via the prediction image selection unit 116, to the restored difference information serving as an inverse orthogonal transform result supplied from the inverse orthogonal transform unit 109, and obtains a locally decoded image (decoded image). The decoded image is supplied to the deblocking filter 111 or the frame memory 112.

The deblocking filter 111 arbitrarily performs deblocking filter processing on the decoded image supplied from the computing unit 110. For example, the deblocking filter 111 performs deblocking filter processing on the decoded image, and hence, removes the block distortion of the decoded image.

The deblocking filter 111 supplies a filter processing result (the decoded image after filter processing) to the frame memory 112. In addition, as described above, the decoded image output from the computing unit 110 may be supplied to the frame memory 112 without passing through the deblocking filter iii. In other words, the filter processing performed by the deblocking filter 111 may be skipped.

The frame memory 112 stores therein the supplied decoded image, and supplies, to the selection unit 113, the stored decoded image as a reference image, at a given timing.

The selection unit 113 selects the supply destination of the reference image supplied from the frame memory 112. For example, in a case of inter prediction, the selection unit 113 supplies, to the motion prediction/compensation unit 115, the reference image supplied from the frame memory 112.

Using pixel values within a processing target picture (also referred to as a current picture) serving as the reference image supplied from the frame memory 112 via the selection unit 113, the intra prediction unit 114 performs intra prediction (intra-screen prediction) in which a prediction image is generated with a prediction unit (PU (Prediction Unit)) basically serving as a processing unit. The intra prediction unit 114 performs the intra prediction using a plurality of intra prediction modes preliminarily prepared.

The intra prediction unit 114 generates a prediction image using all of the intra prediction modes serving as candidates, evaluates the cost relation value of each prediction image using the input image supplied from the screen arrangement buffer 102, and selects an optimal mode. When having selected the optimal intra prediction mode, the intra prediction unit 114 supplies a prediction image generated with the optimal mode, to the prediction image selection unit 116.

In addition, as described above, the intra prediction unit 114 arbitrarily supplies information, such as intra prediction mode information indicating the adopted intra prediction mode, to the lossless encoding unit 106, and causes the information to be encoded.

Using the input image supplied from the screen rearrangement buffer 102 and the reference image supplied from the frame memory 112 via the selection unit 113, the motion prediction/compensation unit 115 performs motion prediction (inter prediction) with the prediction unit (PU) basically serving as a processing unit. The motion prediction/compensation unit 115 supplies a detected motion vector to the motion vector encoding unit 121, performs motion compensation processing in accordance with the detected motion vector, and generates a prediction image (inter prediction image information). The motion prediction/compensation unit 115 performs such inter prediction using a plurality of inter prediction modes preliminarily prepared.

The motion prediction/compensation unit 115 generates the prediction image using all of the inter prediction modes serving as candidates. The motion prediction/compensation unit 115 generates a difference motion vector serving as a difference between the motion vector of a target region (also referred to as a current region) and the prediction motion vector of the target region from the motion vector encoding unit 121. In addition, the motion prediction/compensation unit 115 evaluates the cost function value of each prediction image using the input image supplied from the screen rearrangement buffer 102, the information of the generated difference motion vector, and so forth, and selects an optimal mode. When having selected the optimal inter prediction mode, the motion prediction/compensation unit 115 supplies the prediction image generated with the optimal mode, to the prediction image selection unit 116.

The motion prediction/compensation unit 115 supplies, to the lossless encoding unit 106, information indicating an adopted inter prediction mode, information necessary for performing processing using the inter prediction mode in a case of decoding encoded data, and so forth, and causes these pieces of information to be encoded. Examples of the necessary information include the information of the generated difference motion vector, a flag indicating the index of a prediction motion vector as prediction motion vector information, and so forth.

The prediction image selection unit 116 selects the supply source of a prediction image to be supplied to the computing unit 103 and the computing unit 110. For example, in the case of inter encoding, the prediction image selection unit 116 selects the motion prediction/compensation unit 115 as the supply source of the prediction image, and supplies the prediction image supplied from the motion prediction/compensation unit 115, to the computing unit 103 and the computing unit 110.

On the basis of the amount of code of encoded data accumulated in the accumulation buffer 107, the rate control unit 117 controls the rate of a quantization operation in the quantization unit 105 so that an overflow or an underflow does not occur.

The motion vector encoding unit 121 stores therein a motion vector obtained by the motion prediction/compensation unit 115. The motion vector encoding unit 121 predicts the motion vector of the target region. In other words, the motion vector encoding unit 121 generates a prediction motion vector used for encoding or decoding the motion vector.

Specifically, under control of the temporal prediction control unit 122, the motion vector encoding unit 121 generates the prediction motion vector (predictor) of the target region using the motion vector of an adjacent region temporally or spatially adjacent to the target region. The motion vector encoding unit 121 supplies, to the motion prediction/compensation unit 115 and the temporal prediction control unit 122, an optimal prediction motion vector identified as optimal one of generated prediction motion vectors.

Here, as the types of prediction motion vector, a temporal prediction motion vector (temporal predictor) and a spatial prediction motion vector (spacial predictor) exist. The temporal prediction motion vector is a prediction motion vector generated using the motion vector of an adjacent region temporally adjacent to the target region. The spatial prediction motion vector is a prediction motion vector generated using the motion vector of an adjacent region spatially adjacent to the target region.

In response to the operation of a user, input via an operation input unit not illustrated in a drawing, the temporal prediction control unit 122 sets whether or not the temporal prediction motion vector out of the prediction motion vectors is available, with respect to each of the prediction directions of List0 and List1. On the basis of the setting of whether or not the temporal prediction motion vector in each prediction direction is available, the temporal prediction control unit 122 controls the use (generation) of the temporal prediction motion vector by the motion vector encoding unit 121. In addition, the temporal prediction control unit 122 generates a flag indicating whether or not the temporal prediction motion vector in each prediction direction is available, and supplies the flag to the lossless encoding unit 106.

The flag that has been supplied from the temporal prediction control unit 122 and indicates whether or not the temporal prediction motion vector is available is set as a portion of the header information of the encoded data (multiplexed) by the lossless encoding unit 106.

In addition, in the present embodiment, the description will be performed with assuming that the prediction of the motion vector represents processing for generating the prediction motion vector and the encoding of the motion vector represents processing for generating the prediction motion vector and obtaining the difference motion vector using the generated prediction motion vector. In other words, the encoding processing for the motion vector includes the prediction processing for the motion vector. In the same way, the description will be performed with assuming that the decoding of the motion vector represents processing for generating the prediction motion vector and reconstructing the motion vector using the generated prediction motion vector. In other words, the decoding processing for the motion vector includes the prediction processing for the motion vector.

In addition, the above-mentioned adjacent region adjacent to the target region is also a neighboring region located on the periphery of the target region, and hereinafter, the description will be performed with assuming that the words of the two mean the same region.

[¼-Pixel Accuracy Motion Prediction]

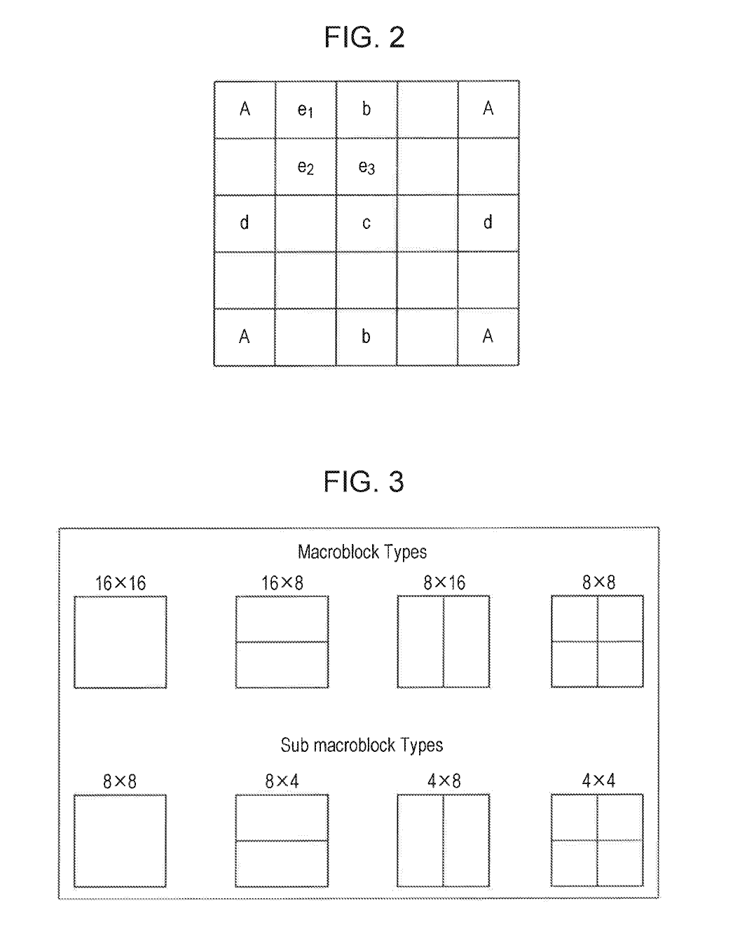

FIG. 2 is a diagram illustrating an example of the situation of motion prediction/compensation processing with ¼-pixel accuracy, specified in the AVC method. In FIG. 2, individual squares indicate pixels. In these, A indicates the position of an integer accuracy pixel stored in the frame memory 112, b, c, and d indicate positions with a ½-pixel accuracy, and e1, e2 and e3 indicate positions with a ¼-pixel accuracy.

In what follows, a function Clip1( ) is defined as in the following Expression (1).

$$\begin{matrix}[ Mathematical Expression 1 ] & \\ Clip 1 ( a ) = \{ \begin{matrix}0 \text{;} if ( a < 0 ) \\ a \text{;} otherwise \\ max\_pix \text{;} if ( a > max\_pix )\end{matrix} & ( 1 )\end{matrix}$$

For example, in a case where an input image has 8-bit accuracy, the value of the max_pix in Expression (1) becomes 255.

Pixel values in the positions of the b and the d are generated as in the following Expression (2) and Expression (3) using a 6-tap FIR filter.

[Mathematical Expression 2]

F=A₋₂−5·A₋₁+20·A₀+20A₁−5·A₂+A₃ (2)

[Mathematical Expression 3]

b,d=Clip1((F+16)>>5) (3)

A pixel value in the position of the c is generated as in the following Expression (4) to Expression (6) by applying a 6-tap FIR filter in a horizontal direction and a vertical direction.

[Mathematical Expression 4]

F=b₋₂−5·_{b-1}+20·b₀+20·b₁−5·b₂+b₃ (4)

or

[Mathematical Expression 5]

F=d₋₂−5·d₋₁+20·d₀+20·d₁−5·d₂d₃ (5)

[Mathematical Expression 6]

c=Clip1((F+512)>>10) (6)

In addition, the Clip processing is finally performed only once after the product-sum processing is performed in both the horizontal direction and the vertical direction.

The e1 to the e3 are generated using linear interpolation as in the following Expression (7) to Expression (9).

[Mathematical Expression 7]

e₁=(A+b+1)>>1 (7)

[Mathematical Expression 8]

e₂=(b+d+1)>>1 (8)

[Mathematical Expression 9]

e₃=(b+c+1)>>1 (9)

[Macroblock]

In addition, in the MPEG2, as for the unit of motion prediction/compensation processing, in a case of a frame motion compensation mode, motion prediction/compensation processing is performed with 16×16 pixels as the unit. In addition, in the case of a field motion compensation mode, motion prediction/compensation processing is performed with 16×8 pixels as the unit, with respect to each of a first field and a second field.

In contrast, in the AVC method, as illustrated in FIG. 3, it is possible to divide one macroblock, configured by 16×16 pixels, into partitions of any of 16×16, 16×8, 8×16, and 8×8, and it is possible to have mutually independent motion vector information for each sub-macroblock. Furthermore, as illustrated in FIG. 3, it is possible to divide an 8×8 partition into sub-macroblocks of any of 8×8, 8×4, 4×8, and 4×4, and it is possible to individually have independent motion vector information.

However, in the AVC method, in the same way as the case of the MPEG2, when such motion prediction/compensation processing has been caused to be performed, there has been a possibility that extensive motion vector information is generated. In addition, there has been a possibility that an encoding efficiency is lowered when the generated motion vector information is encoded without change.

[Median Prediction of Motion Vector]

As a method for solving such problems, in the AVC method, a reduction in the encoding information of a motion vector is realized using the following method.

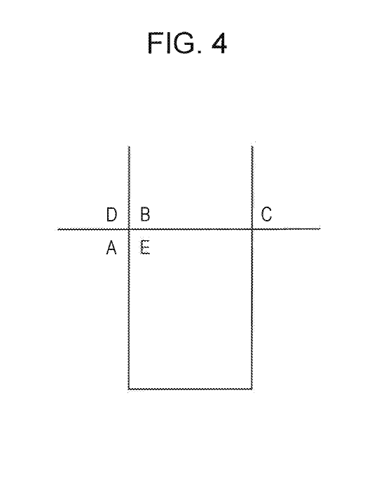

Each straight line illustrated in FIG. 4 indicates a boundary between motion compensation blocks. In addition, in FIG. 4, E indicates a relevant motion compensation block to be encoded from now, and A to D individually indicate motion compensation blocks that are adjacent to the E and for which encoding has already been completed.

Here, it is assumed that the motion vector information is mvx with respect to X with assuming X=A, B, C, D, or E.

First, using motion vector information relating to the motion compensation blocks A, B and C, prediction motion vector information pmvE with respect to the motion compensation block E is generated by a median operation as in the following Expression (10).

[Mathematical Expression 10]

pmv_{E}=med(mv_{A},mv_{B},mv_{C}) (10)

In a case where information relating to the motion compensation block C is unavailable (unavailable) by reason of being at the edge of the image frame, or the like, information relating to the motion compensation block D is substituted therefor.

In image compression information, the data mvdE encoded as motion vector information with respect to the motion compensation block E is generated using the pmvE as in the following Expression (ii).

[Mathematical Expression 11]

mvd_{E}=mv_{E}−pmv_{E} (11)

In addition, as for actual processing, processes are independently performed with respect to the individual components of the motion vector information in the horizontal direction and the vertical direction.

[Multi-Reference Frame]

In addition, a method called Multi-Reference Frame (multi (plural) reference frame) not specified in image encoding methods of the related art, such as the MPEG2 and the H.263, is specified in the AVC method.

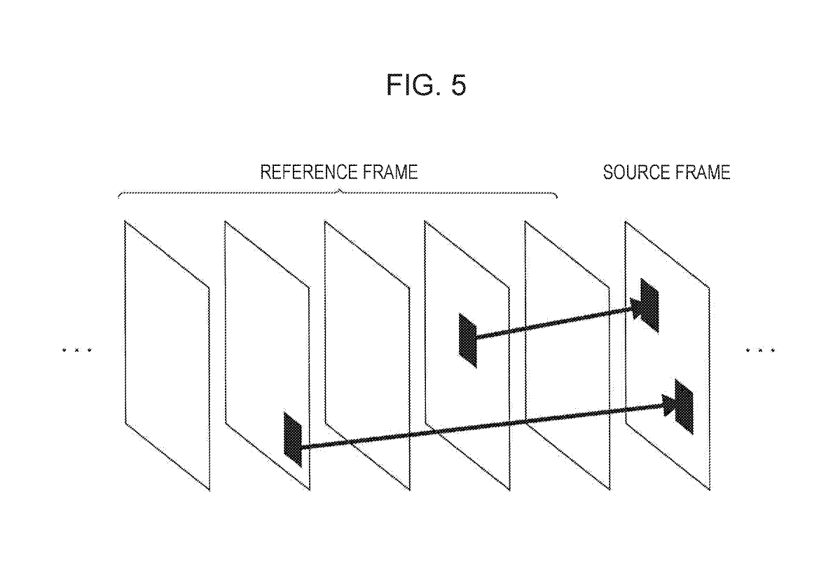

Using FIG. 5, the Multi-reference frame (Multi-Reference Frame) specified in the AVC method will be described.

In other words, in the MPEG-2 or the H.263, in the case of a P picture, motion prediction/compensation is performed by referencing only one reference frame stored in a frame memory. In contrast, in the AVC, as illustrated in FIG. 5, a plurality of reference frames are stored in the memory, and it is possible to reference a different memory for each macroblock.

[Direct Mode]

Incidentally, while the amount of information in motion vector information in a B picture is extensive, a mode called Direct Mode (direct mode) is prepared in the AVC method.

In this direct mode, the motion vector information is not stored in the image compression information. In an image decoding device, the motion vector information of a relevant block is calculated from the motion vector information of a neighboring block or the motion vector information of a Co-Located block which is a block in the same position as a processing target block (also referred to as a current block) in a reference frame.

In the direct mode (Direct Mode), two types of a Spatial Direct Mode (spatial direct mode) and a Temporal Direct Mode (temporal direct mode) exist, and are able to be switched for each slice.

In the spatial direct mode (Spatial Direct Mode), the motion vector information mvE of the processing target (current) motion compensation block E is calculated as illustrated in the following Expression (12).

mvE=pmvE (12)

In other words, the motion vector information generated by a Median (median) prediction is applied to the relevant block.

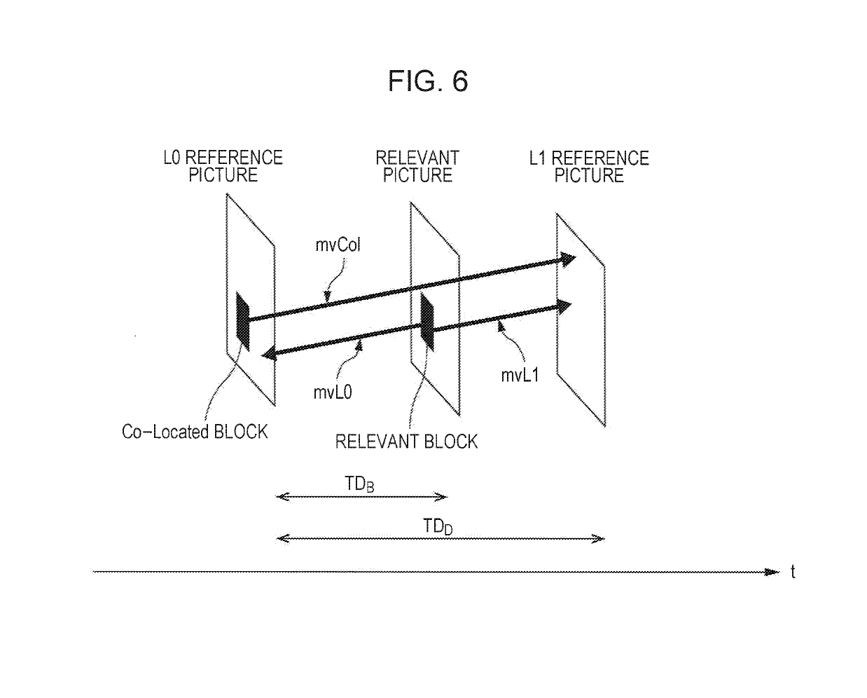

Hereinafter, the temporal direct mode (Temporal Direct Mode) will be described using FIG. 6.

In FIG. 6, it is assumed that, in an L0 reference picture, a block located at the same spatial address as the relevant block is a Co-Located block and the motion vector information in the Co-Located block is mvcol. In addition, it is assumed that a distance between a relevant picture and the L0 reference picture on a temporal axis is TDB and a distance between the L0 reference picture and an L1 reference picture on the temporal axis is TDD.

At this time, in the relevant picture, the motion vector information mvL0 of L0 and the motion vector information mvL1 of L1 are calculated as in the following Expression (13) and Expression (14).

$$\begin{matrix}[ Mathematical Expression 12 ] & \\ {mv}_{L 0} = \frac{{TD}_{B}}{{TD}_{D}} {mv}_{col} & ( 13 ) \\ [ Mathematical Expression 13 ] & \\ {mv}_{L 1} = \frac{{TD}_{D} - {TD}_{B}}{{TD}_{D}} {mv}_{col} & ( 14 )\end{matrix}$$

In addition, in the AVC image compression information, since no information TD representing a distance on the temporal axis exists, it is assumed that the computation of the above-mentioned Expression (12) and Expression (13) is performed using a POC (Picture Order Count).

In addition, in the AVC image compression information, it is possible to define the direct mode (Direct Mode) with a 16×16-pixel macroblock unit or an 8×8-pixel block unit.

[Selection of Prediction Mode]

Incidentally, in the AVC encoding method, selection of an appropriate prediction mode is important in order to achieve a higher encoding efficiency.

As such a selection method, a method implemented in the reference software of the AVC method (disclosed at http://iphome.hhi.de/suchring/tml/index.htm) called JM (Joint Model) may be cited.

In the JM, it is possible to select between two mode determination methods, a High Complexity Mode and a Low Complexity Mode, described below. In any of these cases, cost function values relating to individual prediction modes are calculated, and a prediction mode minimizing this is selected as an optimal mode with respect to a relevant sub-macroblock or a relevant macroblock.

The cost function in the High Complexity Mode is represented as in the following Expression (15).

Cost(ModeεΩ)=D+λ*R (15)

Here, the Ω is the universal set of candidate modes for encoding the relevant block and macroblock, and the D is difference energy between the decoded image and the input image in the case of being encoded using a relevant prediction mode. The λ is a Lagrange undetermined multiplier provided as the function of a quantization parameter. The R is the total amount of code in the case of being encoded in the relevant mode, which includes the orthogonal transform coefficient.

In other words, since, in performing encoding with the High Complexity Mode, the above-mentioned parameters D and R are calculated, it is necessary to perform provisional encoding processing once using all of the candidate modes, and a higher computation amount is required.

The cost function in the Low Complexity Mode is represented as in the following Expression (16).

Cost(ModeεΩ)=D+QP2Quant(QP)*HeaderBit (16)

Here, unlike in the case of the High Complexity Mode, the D is a difference energy between the prediction image and the input image. The QP2Quant(QP) is provided as the function of the quantization parameter QP, and the HeaderBit is the amount of code relating to information belonging to Header, such as the motion vector or a mode, the information not including the orthogonal transform coefficient.

In other words, in the Low Complexity Mode, while it is necessary to perform prediction processing regarding the individual candidate modes, the decoded image is not necessary, and hence, it is not necessary to perform the encoding processing. Therefore, it is possible to achieve realization with a lower amount of computation than the High Complexity Mode.

[MV Competition of Motion Vector]

Incidentally, in order to improve encoding of the motion vector utilizing such median prediction as described with reference to FIG. 4, a method as described below has been proposed in Non Patent Document 1.

In other words, in addition to the “Spatial Predictor (spatial prediction motion vector)” obtained through median prediction defined in the AVC, it is possible to adaptively use one of a “Temporal Predictor (temporal prediction motion vector)” and a “Spatio-Temporal Predictor (temporal and spatial prediction motion vector)”, described below, as prediction motion vector information. This proposed method is called MV competition (MV Competition) in the AVC. In contrast, in the HEVC, the method is called AMVP (Advanced Motion Vector Prediction), and hereinafter, this proposed method will be described with being referred to as the AMVP.

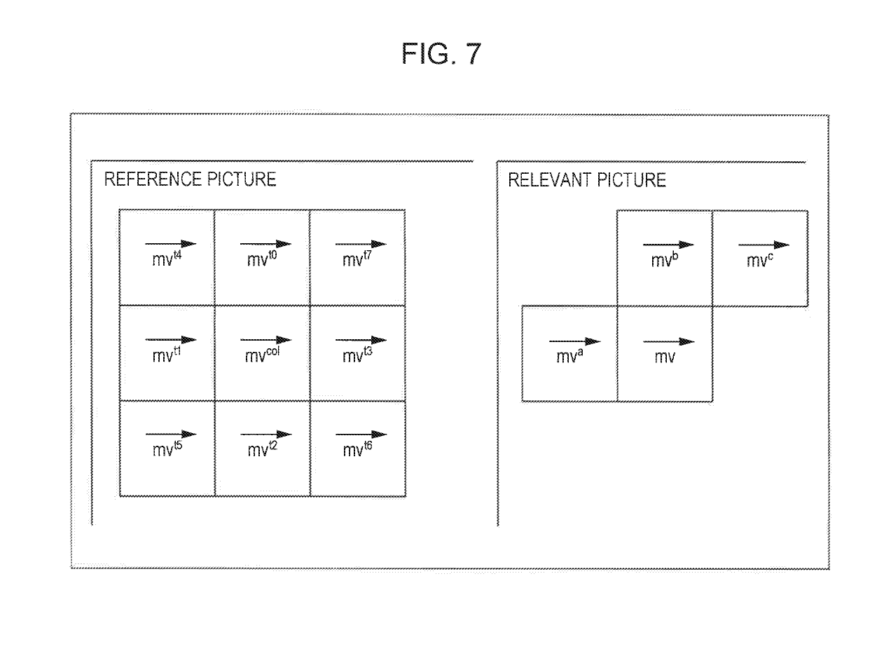

In FIG. 7, it is assumed that “mvcol” is motion vector information with respect to the Co-Located block corresponding to the relevant block. In addition, it is assumed that mvtk (k=0 to 8) is the motion vector information of the neighboring block thereof, and the individual pieces of prediction motion vector information (Predictor) are defined by the following Expressions (17) to (19). In addition, the Co-Located block corresponding to the relevant block is a block whose xy-coordinates are the same as the relevant block in the reference picture referenced by the relevant picture.

Temporal Predictor:

[Mathematical Expression 14]

mvₜₘ₅=median{mv_{col},mvₜ₀, . . . ,mvₜ₃} (17)

[Mathematical Expression 15]

mvₜₘ₉=median{mv_{col},mvₜ₀, . . . ,mvₜ₈} (18)

Spatio-Temporal Predictor:

[Mathematical Expression 16]

mvₛₚₜ=median{mv_{col},mv_{col},mvₐ,mv_{b},mv_{c}} (19)

In the image information encoding device 100, the cost function values are calculated in a case of using the individual pieces of prediction motion vector information regarding the individual blocks, and selection of optimal prediction motion vector information is performed. In the image compression information, a flag indicating information (index) relating to which piece of prediction motion vector information has been used with respect to each block is transmitted.

[Coding Unit]

Incidentally, setting a macroblock size to 16 pixels×16 pixels is not most suitable for a large image frame such as UHD (Ultra High Definition; 4000 pixels×2000 pixels) that is a target of a next generation encoding method.

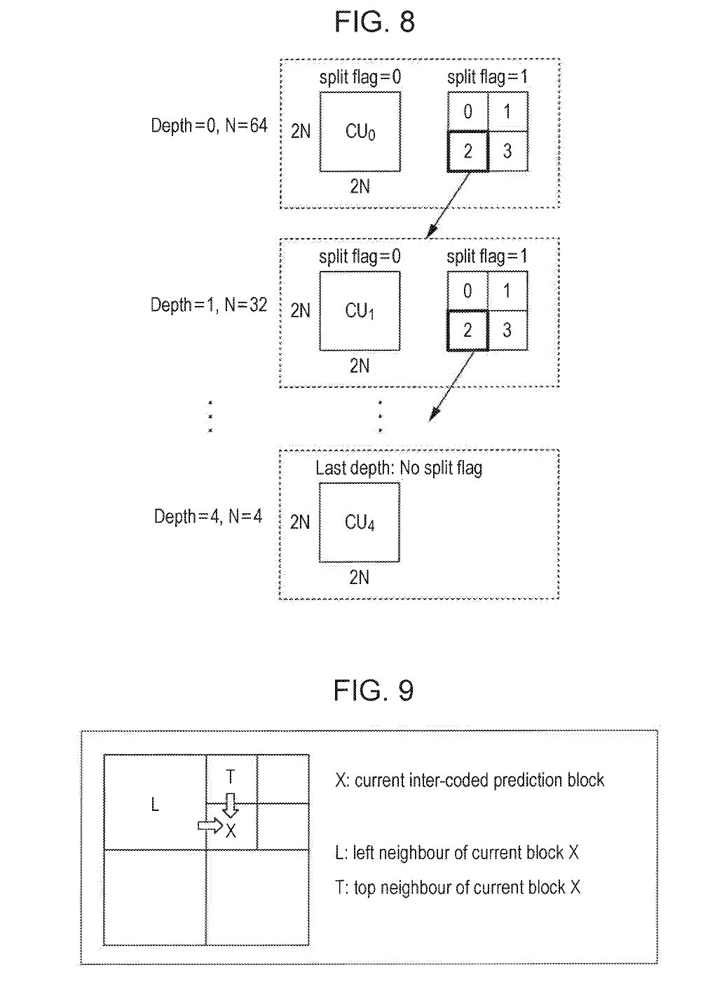

Therefore, while, in the AVC method, as described above in FIG. 3, a hierarchical structure based on macroblocks and sub-macroblocks is specified, a coding unit (CU (Coding Unit)) is specified in, for example, the HEVC method, as illustrated in FIG. 8.

The CU is also called a Coding Tree Block (CTB), and is a partial region of an image of a picture unit, which serves the same role as the macroblock in the AVC method. The latter is fixed to a size of 16×16 pixels, whereas the size of the former is not fixed, and is specified in the image compression information in each sequence.

For example, in a sequence parameter set (SPS (Sequence Parameter Set)) included in the encoded data to be the output, the maximum size (LCU (Largest Coding Unit)) and the minimum size (SCU (Smallest Coding Unit)) of the CU are specified.

Within each LCU, by setting split-flag=1 within a range not falling below the size of the SCU, division into CUs having smaller sizes is possible. In the example in FIG. 8, the size of the LCU is 128, and a maximum layer depth becomes 5. When the value of the split_flag is “1”, a CU having the size of 2N×2N is divided into CUs that have the size of N×N and become one layer lower.

Furthermore, the CU is divided into prediction units (Prediction Unit (PU)) which are regions (partial regions of an image of a picture unit) to serve as processing units of intra or inter prediction, and in addition, is divided into transform units (Transform Unit (TU)) which are regions (partial regions of an image of a picture unit) to serve as processing units of the orthogonal transform. Currently, in the HEVC method, in addition to 4×4 and 8×8, it is possible to use a 16×16 and 32×32 orthogonal transform.

As in the above HEVC method, in the case of an encoding method where the CU is defined and various types of processing are performed with the CU as a unit, the macroblock in the AVC method may be considered as corresponding to the LCU and the block (sub-block) therein may be considered as corresponding to the CU. In addition, the motion compensation block in the AVC method may be considered as corresponding to the CU. In this regard, however, since the CU has a hierarchical structure, the size of the LCU in the highest layer thereof is ordinarily set larger than the macroblock in the AVC method, such as, for example, 128×128 pixels.

Therefore, hereinafter, it is assumed that the LCU also includes the macroblock in the AVC method and the CU also includes the block (sub-block) in the AVC method.

[Merge of Motion Partitions]

Incidentally, as one encoding method for motion information, a technique (merge mode) called Motion Partition Merging, such as illustrated in FIG. 9, has been proposed. In this technique, two flags, called MergeFlag and MergeLeftFlag, are transmitted as merge information serving as information relating to the merge mode.

MergeFlag=1 indicates that the motion information of a relevant block X is the same as the motion information of a neighboring region T adjacent to the upper portion of the relevant region or a neighboring region L adjacent to the left portion of the relevant region. At this time, the MergeLeftFlag is transmitted with being included in the merge information. MergeFlag=0 indicates that the motion information of the relevant block X is different from any one of the neighboring region T and the neighboring region L. In this case, the motion information of the relevant region X is transmitted.

In a case where the motion information of the relevant region X is equal to the motion information of the neighboring region L, MergeFlag=1 and MergeLeftFlag=1 are satisfied. In a case where the motion information of the relevant region X is equal to the motion information of the neighboring region T, MergeFlag=1 and MergeLeftFlag=0 are satisfied.

[Temporal Prediction Motion Vector (Temporal Predictor)]

In the AMVP described above with reference to FIG. 7 or the merge mode described above with reference to FIG. 9, as the candidates of a prediction motion vector (predictor), a spatial prediction motion vector (spacial predictor) and a temporal prediction motion vector (temporal predictor) are generated.

The information of a motion vector is stored in a line buffer, the information of a motion vector relating to a spatially adjacent PU spatially adjacent to a relevant PU and being necessary for generating the spatial prediction motion vector. In contrast, the information of a motion vector is stored in a memory, the information of a motion vector relating to a temporally adjacent PU temporally adjacent to the relevant PU and being necessary for generating the temporal prediction motion vector. Accordingly, in a case of the temporal prediction motion vector, since it is necessary to read out the information stored in the memory, there has been a possibility of increasing a memory access.

On the other hand, if, in the AMVP or the merge mode, the temporal prediction motion vector is not used and the encoding processing of a motion vector is performed using only the spatial prediction motion vector, there has been a possibility the an encoding efficiency is reduced.

Therefore, in the image encoding device 100, whether or not the temporal prediction motion vector is to be used is set with respect to each of the prediction directions of the List0 and the List1, and a flag indicating that setting information is generated and added to an encoded stream, and sent to a decoding side.

Owing to this, the use of the temporal prediction motion vector in one prediction direction or the like is available. Therefore, it is possible to minimize a decrease in an encoding efficiency without increasing the amount of memory access and the amount of computation.

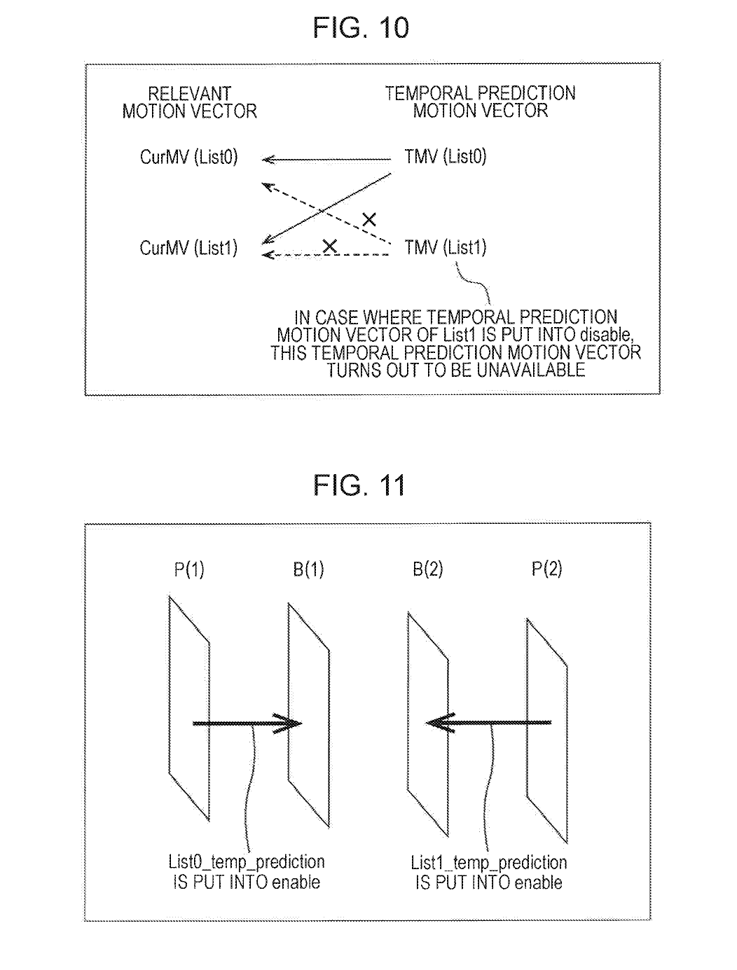

In addition, in the HEVC, as illustrated in FIG. 10, in encoding the motion vector CurMV (List0) of the List0 in the relevant PU, it is possible to use any of the temporal prediction motion vector TMV (List0) of the List0 and the temporal prediction motion vector TMV (List1) of the List1. In addition, in encoding the motion vector CurMV (List1) of the List1 in the relevant PU, it is possible to use any of the temporal prediction motion vector TMV (List0) of the List0 and the temporal prediction motion vector TMV (List1) of the List1.

Therefore, in the present embodiment, that the temporal prediction motion vector TMV (List1) of the List1 is set to be unavailable (disable) means that it is not possible to use the TMV (List1) for the encoding of any of the CurMV (List0) and the CurMV (List1), as illustrated by dotted lines.

With respect to each of the prediction directions of the List0 and the List1, the flag (for example, an L0_temp_prediction_flag or an L1_temp_prediction_flag) indicating whether or not the temporal prediction motion vector is to be used is added to the encoded stream, and transmitted to a decoding side.

Specifically, this flag is set in a parameter of a picture unit, such as, for example, the picture parameter set (PPS (Picture Parameter Set)) or the adaptation parameter set (APS (Adaptation Parameter Set)), and transmitted to a decoding side. Alternatively, this flag may also be set in, for example, the sequence parameter set (SPS (Sequence Parameter Set)) or a slice header (Slice Header) and transmitted to a decoding side.

In addition, in the image encoding device 100, for example, only the temporal prediction motion vector of L0 prediction may also be used continuously. In other words, at this time, the temporal prediction motion vector of L1 prediction is set to be unavailable. In addition, only the temporal prediction motion vector of the L1 prediction may also be used continuously. In other words, at this time, the temporal prediction motion vector of the L0 prediction is set to be unavailable. Alternatively, which of the prediction directions is only used may be switched in picture units.

Furthermore, in a case where the flag is transmitted in other than the above-mentioned Sequence Parameter Set, only the temporal prediction motion vector of the L1 prediction may be used when the rearrangement (reorder) of pictures exists, in accordance with a GOP structure. On the other hand, in a case of a picture where the rearrangement of pictures does not exist, only the temporal prediction motion vector of the L0 prediction may also be used.

In addition, a case where the flag is transmitted in the above-mentioned Sequence Parameter Set requires only a small increased amount of information due to the flag. On the other hand, in a case where the flag is set in other than that, there is an increased amount of information due to the flag. However, it is possible to reduce the amount of computation in response to a circuit size with a finer particle size.

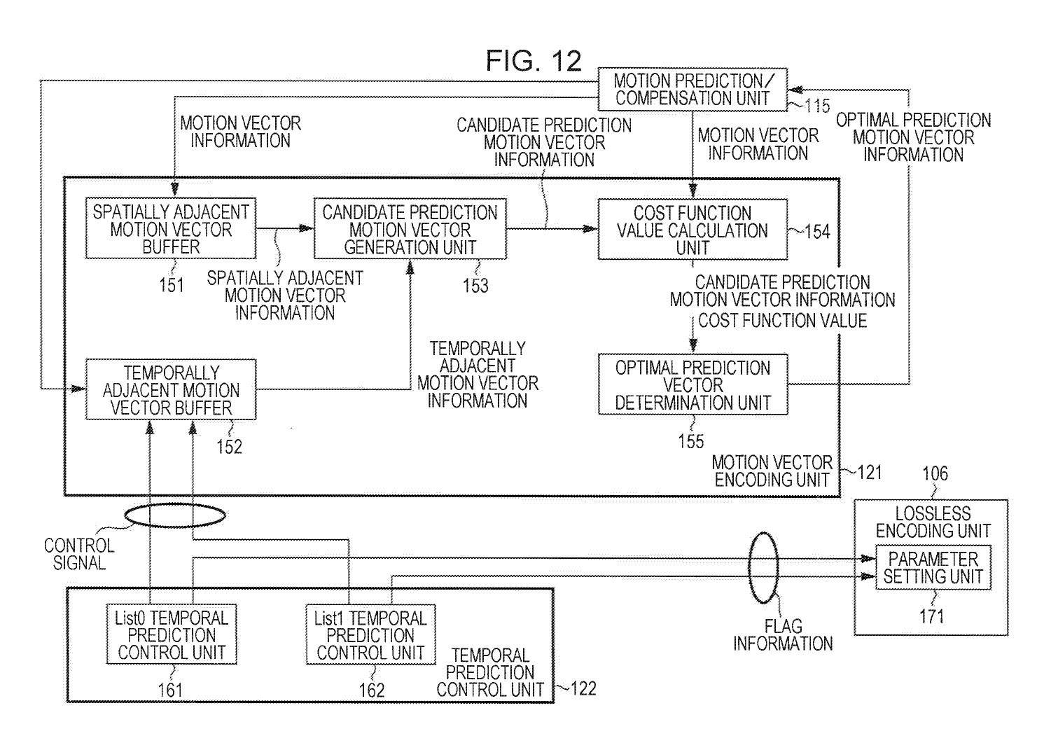

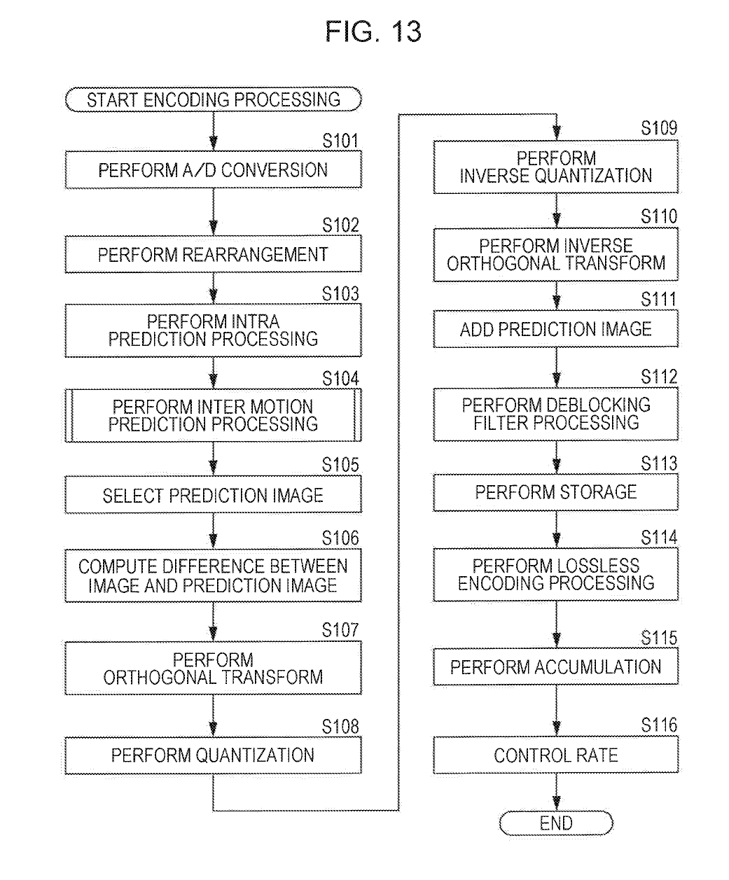

Furthermore, in an example in FIG. 11, a P(1) picture, a first B(1) picture, a second B(2) picture, and a P(2) picture in a case of m=3 are illustrated in a temporal order. The m is a parameter expressing a picture distance other than the B picture. In a case of the example illustrated in FIG. 11, in a case of the processing of the first B(1) picture, the prediction motion vector (Predictor) information of the P(1) picture relating to the temporally near List0 prediction. On the other hand, in a case of the processing of the second B(2) picture, the prediction motion vector (Predictor) information of the P(2) picture relating to the temporally near List1 prediction.

In this way, enable/disable (on/off) with respect to each prediction direction may also be set with taking into consideration a distance with the reference picture on a temporal axis.

As described above, in the image encoding device 100, on/off of the use of the temporal prediction motion vector is set independently in the prediction direction of each of the List0/List1. Owing to this, it becomes possible for a user utilizing the image encoding device 100 to adjust the amount of computation and the amount of memory access to desired values with minimizing image deterioration.

In addition, the above-mentioned flag indicating whether or not the temporal prediction motion vector is to be used may not only be generated with respect to the prediction direction of each of the List0/List1 but also be generated independently with respect to each of the AMVP and the merge mode described above with reference to FIG. 7 and FIG. 9. In other words, whether or not the temporal prediction motion vector is to be used may also be set independently with respect to each of the AMVP and the merge mode.

In this case, for example, with respect to the AMVP, an AMVP_L0_temp_prediction_flag and an AMVP_L1_temp_prediction_flag are generated. In addition, for example, as for the merge mode, a merge_L0_temp_prediction_flag and a merge_L1_temp_prediction_flag are generated.

In addition, since the merge mode has the merit of using the temporal prediction motion vector, compared with the AMVP, it becomes possible to reduce candidate prediction motion vectors with respect to each of the AMVP and the merge mode by independently generating a flag with respect to each of the AMVP and the merge mode. As a result, it is possible to reduce the amount of computation in a case of estimating candidate prediction motion vectors.

In addition, in some cases processing is easier in the merge mode than in the AMVP, and in a case where the flag of the AMVP is on, the flag of the merge mode rarely becomes off. Accordingly, in a case where the flag of the AMVP is on, it is also possible to send no flag of the merge mode.

[Examples of Configurations of Motion Vector Encoding Unit, Temporal Prediction Control Unit, and Lossless Encoding Unit]

FIG. 12 is a block diagram illustrating examples of the main configurations of the motion vector encoding unit 121, the temporal prediction control unit 122, and the lossless encoding unit 106.

The motion vector encoding unit 121 in the example in FIG. 12 is configured so as to include a spatially adjacent motion vector buffer 151, a temporally adjacent motion vector buffer 152, a candidate prediction motion vector generation unit 153, a cost function value calculation unit 154, and an optimal prediction motion vector determination unit 155.

The temporal prediction control unit 122 is configured so as to include a List0 temporal prediction control unit 161 and a List1 temporal prediction control unit 162.

The lossless encoding unit 106 is configured so as to include a parameter setting unit 171.

The information of a motion vector searched for by the motion prediction/compensation unit 115 is supplied to the spatially adjacent motion vector buffer 151, the temporally adjacent motion vector buffer 152, and the cost function value calculation unit 154. The spatially adjacent motion vector buffer 151 is configured by the line buffer as described above. The spatially adjacent motion vector buffer 151 accumulates therein the motion vector information from the motion prediction/compensation unit 115 as the information of the motion vector of a spatially adjacent region spatially adjacent. The spatially adjacent motion vector buffer 151 reads out information indicating a motion vector obtained with respect to a spatially adjacent PU spatially adjacent to a relevant PU, and supplies the information (spatially adjacent motion vector information) read out, to the candidate prediction motion vector generation unit 153.

As described above, the temporally adjacent motion vector buffer 152 is configured by the memory. The temporally adjacent motion vector buffer 152 accumulates therein the motion vector information from the motion prediction/compensation unit 115 as the information of the motion vector of a temporally adjacent region temporally adjacent. In addition, the temporally adjacent region means a region located at the same spatial address as the relevant region in a picture different on a temporal axis.

The temporally adjacent motion vector buffer 152 reads out information indicating a motion vector obtained with respect to a temporally adjacent PU temporally adjacent to the relevant PU, and supplies the information (temporally adjacent motion vector information) read out, to the candidate prediction motion vector generation unit 353. On that occasion, under control of the List0 temporal prediction control unit 161, the temporally adjacent motion vector buffer 152 performs the reading of the temporally adjacent motion vector information in the List0 direction or inhibits the reading thereof. Under control of the List1 temporal prediction control unit 162, the temporally adjacent motion vector buffer 152 performs the reading of the temporally adjacent motion vector information in the List1 direction or inhibits the reading thereof.

On the basis of the method based on the AMVP or the merge mode, described above with reference to FIG. 7 or FIG. 9, the candidate prediction motion vector generation unit 153 references the spatially adjacent motion vector information from the spatially adjacent motion vector buffer 151, and generates a spatial prediction motion vector to be a candidate of the relevant PU. The candidate prediction motion vector generation unit 153 supplies, to the cost function value calculation unit 154, information indicating the generated candidate spatial prediction motion vector.

On the basis of the method based on the AMVP or the merge mode, the candidate prediction motion vector generation unit 153 references the temporally adjacent motion vector information from the temporally adjacent motion vector buffer 152, and generates a temporal prediction motion vector to be a candidate of the relevant PU. The candidate prediction motion vector generation unit 153 supplies, to the cost function value calculation unit 154, information indicating the generated candidate temporal prediction motion vector.

The cost function value calculation unit 154 calculates a cost function value relating to each candidate prediction motion vector, and supplies, to the optimal prediction motion vector determination unit 155, the calculated cost function value along with the information of the candidate prediction motion vector.

The optimal prediction motion vector determination unit 155 regards a candidate prediction motion vector minimizing a cost function value from the cost function value calculation unit 154, as an optimal prediction motion vector with respect to the relevant PU, and supplies the information thereof to the motion prediction/compensation unit 115.

In addition, using the information of the optimal prediction motion vector from the optimal prediction motion vector determination unit 155, the motion prediction/compensation unit 115 generates a difference motion vector serving as a difference with a motion vector, and calculates a cost function value with respect to each prediction mode. The motion prediction/compensation unit 115 determines a prediction mode, which minimizes the cost function value, to be an inter optimal prediction mode, from thereamong.

The motion prediction/compensation unit 115 supplies the prediction image of the inter optimal prediction mode to the prediction image selection unit 116. In addition, the motion prediction/compensation unit 115 supplies the generated difference motion vector information to the parameter setting unit 171.

In response to the operation of a user, input via an operation input unit not illustrated in a drawing, the List0 temporal prediction control unit 161 sets whether or not the temporal prediction motion vector in the List0 prediction direction out of the prediction motion vectors is available. In a case of having set that the temporal prediction motion vector in the List0 prediction direction is available, the List0 temporal prediction control unit 161 causes the temporally adjacent motion vector buffer 152 to read out a temporally adjacent motion vector in the List0 prediction direction. In a case of having set that the temporal prediction motion vector in the List0 prediction direction is unavailable, the List0 temporal prediction control unit 161 causes the temporally adjacent motion vector buffer 152 to read out a temporally adjacent motion vector in the List0 prediction direction.

The List0 temporal prediction control unit 161 generates a flag indicating whether or not the temporal prediction motion vector in the List0 prediction direction is available, and supplies the information of the generated flag to the parameter setting unit 171.

In response to the operation of a user, input via an operation input unit not illustrated in a drawing, the List1 temporal prediction control unit 162 sets whether or not the temporal prediction motion vector in the List1 prediction direction out of the prediction motion vectors is available. In a case of having set that the temporal prediction motion vector in the List1 prediction direction is available, the List1 temporal prediction control unit 162 causes the temporally adjacent motion vector buffer 152 to read out a temporally adjacent motion vector in the List1 prediction direction. In a case of having set that the temporal prediction motion vector in the List1 prediction direction is unavailable, the List1 temporal prediction control unit 162 causes the temporally adjacent motion vector buffer 152 to read out a temporally adjacent motion vector in the List1 prediction direction.

The List1 temporal prediction control unit 162 generates a flag indicating whether or not the temporal prediction motion vector in the List1 prediction direction is available, and supplies the information of the generated flag to the parameter setting unit 171.

In addition, in the List0 temporal prediction control unit 161 and the List1 temporal prediction control unit 162, a flag indicating whether or not the temporal prediction motion vector in each prediction direction is available is set in a sequence unit, a picture unit, or a slice unit.

The parameter setting unit 171 receives pieces of information of flags from the List0 temporal prediction control unit 161 and the List1 temporal prediction control unit 162, the information of the prediction motion vector and the information of the difference motion vector from the motion prediction/compensation unit 115, prediction mode information, and so forth. The parameter setting unit 171 sets the received information as a portion of the header information of the encoded data (encoded stream).

For example, by setting, in the Picture Parameter Set of the encoded data, the flag indicating whether or not the temporal prediction motion vector in each prediction direction is available, the parameter setting unit 171 adds to the encoded data.

[Flow of Encoding Processing]

Next, the flow of individual processes executed by the image encoding device 100 as described above will be described. First, with reference to a flowchart in FIG. 13, an example of the flow of encoding processing will be described.

In step S101, the A/D conversion unit 101 A/D-converts an input image. In step S102, the screen rearrangement buffer 102 stores therein the A/D-converted image and performs rearrangement thereon from the display order of each picture to an encoding order. In step S103, the intra prediction unit 114 performs intra prediction processing for an intra prediction mode.

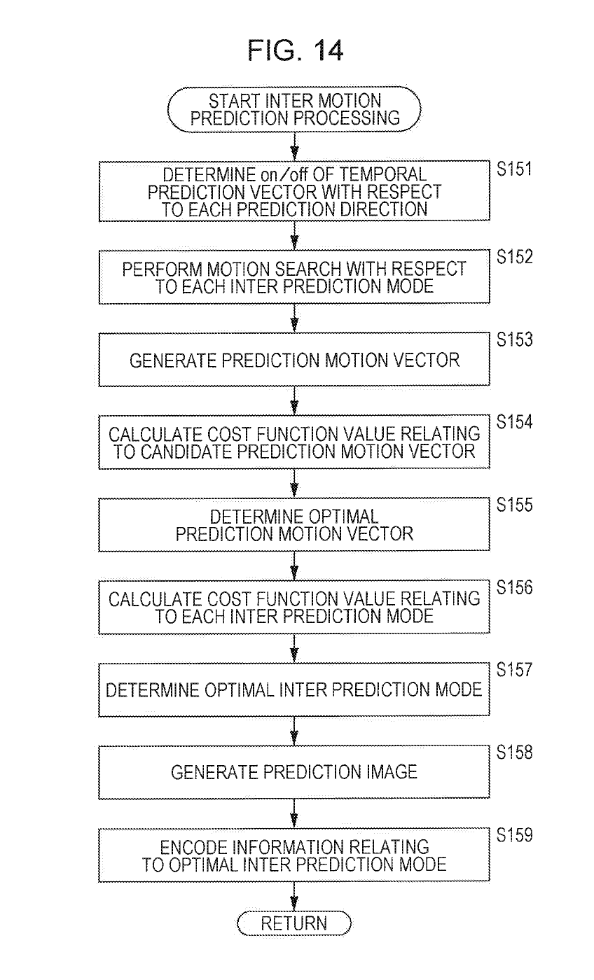

In step S104, the motion prediction/compensation unit 115, the motion vector encoding unit 121, and the temporal prediction control unit 122 perform inter motion prediction processing for performing motion prediction and motion compensation in an inter prediction mode. The detail of this inter motion prediction processing will be described later with reference to FIG. 14.

Owing to a process in step S104, the motion vector of a relevant PU is searched for, individual prediction motion vectors of the relevant PU are generated on the basis of whether or not temporal prediction vectors in individual prediction directions are available, and an optimal prediction motion vector for the relevant PU is determined from thereamong. In addition, the optimal inter prediction mode is determined, and the prediction image of the optimal inter prediction mode is generated. In addition, a flag indicating whether or not a temporal prediction vector in each prediction direction is available, and the information of the generated flag is supplied to the lossless encoding unit 106 and lossless-encoded in after-mentioned step S114.

The prediction image and the cost function value of the determined optimal inter prediction mode are supplied from the motion prediction/compensation unit 115 to the prediction image selection unit 116. In addition, the information of the determined optimal inter prediction mode, information indicating the index of the prediction motion vector regarded as most appropriate, and information indicating a difference between the prediction motion vector and the motion vector are also supplied to the lossless encoding unit 106 and lossless-encoded in the after-mentioned step S114.

In step S105, on the basis of individual cost function values output from the intra prediction unit 114 and the motion prediction/compensation unit 115, the prediction image selection unit 116 determines an optimal mode. In other words, the prediction image selection unit 116 selects one of the prediction image generated by the intra prediction unit 114 and the prediction image generated by the motion prediction/compensation unit 115.

In step S106, the computing unit 103 computes a difference between an image rearranged by the process in step S102 and the prediction image selected by the process in step S105. Difference data has a reduced amount of data compared with original image data. Accordingly, compared with a case of encoding an image without change, it is possible to compress the amount of data.

In step S107, the orthogonal transform unit 104 performs an orthogonal transform on the difference information generated by the process in step S106. Specifically, an orthogonal transform, such as discrete cosine transform or Karhunen-Loeve transform, is performed and a transform coefficient is output.

In step S108, using a quantization parameter from the rate control unit 117, the quantization unit 105 quantizes the orthogonal transform coefficient obtained by the process in step S107.

The difference information quantized by the process in step S108 is locally decoded in the following way. In other words, in step S109, the inverse quantization unit 108 performs inverse quantization on the quantized orthogonal transform coefficient (also referred to as a quantization coefficient) generated by the process in step S108, in accordance with a characteristic corresponding to the characteristic of the quantization unit 105. In step S110, the inverse orthogonal transform unit 109 performs inverse orthogonal transform on the orthogonal transform coefficient obtained by the process in step S109, in accordance with a characteristic corresponding to the characteristic of the orthogonal transform unit 104.

In step S111, the computing unit 110 adds the prediction image to the locally decoded difference information, and generates a locally decoded image (an image corresponding to an input to the computing unit 103). In step S112, the deblocking filter 111 arbitrarily performs deblocking filter processing on the locally decoded image obtained by the process in step S111.

In step S113, the frame memory 112 stores therein the decoded image subjected to the deblocking filter processing by the process in step S112. In addition, an image not subjected to filter processing by the deblocking filter 111 is also supplied from the computing unit 110 to the frame memory 112, and stored.

In step S114, the lossless encoding unit 106 encodes the transform coefficient quantized by the process in step S108. In other words, lossless encoding such as variable-length coding or arithmetic coding is performed on a difference image.

In addition, at this time, the lossless encoding unit 106 encodes and adds information relating to the prediction mode of the prediction image selected by the process in step S105, to encoded data obtained by encoding the difference image. In other words, the lossless encoding unit 106 also encodes and adds, to the encoded data, optimal intra prediction mode information supplied from the intra prediction unit 114 or information according to the optimal inter prediction mode supplied from the motion prediction/compensation unit 115, or the like.

In addition, in a case where the prediction image of the inter prediction mode has been selected by the process in step S106, a flag is also encoded that indicates the information of the difference motion vector calculated in step S105 or the index of the prediction motion vector. In addition, the lossless encoding unit 106 also encodes and adds, to the encoded data, the information of the flag that has been generated in step S104 and indicates whether or not the temporal prediction vector in each prediction direction is available.

In step S115, the accumulation buffer 107 accumulates therein the encoded data obtained by the process in step S114. The encoded data accumulated in the accumulation buffer 107 is arbitrarily read out, and transmitted to a decoding side via a transmission path or a recording medium.

In step S116, on the basis of the amount of code (the amount of generated code) of the encoded data accumulated in the accumulation buffer 107 by the process in step S115, the rate control unit 117 controls the rate of the quantization operation in the quantization unit 105 so that an overflow or an underflow does not occur. In addition, the rate control unit 117 supplies information relating to the quantization parameter to the quantization unit 105.

When the process in step S116 has finished, the encoding processing is finished.

[Flow of Inter Motion Prediction Processing]

Next, with reference to a flowchart in FIG. 14, an example of the flow of inter motion prediction processing executed in step S104 in FIG. 13 will be described.

In step S151, in response to the operation of a user, input via an operation input unit not illustrated in a drawing, the temporal prediction control unit 122 determines the setting of whether or not the temporal prediction motion vector out of the prediction motion vectors is available, with respect to each of the prediction directions of the List0 and the List1.

In other words, in response to the operation of a user, input via an operation input unit not illustrated in a drawing, the List0 temporal prediction control unit 161 sets whether or not the temporal prediction motion vector in the List0 prediction direction out of the prediction motion vectors is available. On the basis of the setting of whether or not the temporal prediction motion vector in the List0 prediction direction is available, the List0 temporal prediction control unit 161 controls the reading of a temporally adjacent motion vector in the List0 prediction direction with respect to the temporally adjacent motion vector buffer 152.

In response to the operation of a user, input via an operation input unit not illustrated in a drawing, the List1 temporal prediction control unit 162 sets whether or not the temporal prediction motion vector in the List1 prediction direction out of the prediction motion vectors is available. On the basis of the setting of whether or not the temporal prediction motion vector in the List1 prediction direction is available, the List1 temporal prediction control unit 162 controls the reading of a temporally adjacent motion vector in the List1 prediction direction with respect to the temporally adjacent motion vector buffer 152.

In addition, the List0 temporal prediction control unit 161 and the List1 temporal prediction control unit 162 generate flags indicating whether or not the temporal prediction motion vectors in the List0 prediction direction and the List1 prediction direction are available, respectively.

In step S152, the motion prediction/compensation unit 115 performs a motion search with respect to each inter prediction mode. Motion vector information searched for by the motion prediction/compensation unit 115 is supplied to the spatially adjacent motion vector buffer 151, the temporally adjacent motion vector buffer 152, and the cost function value calculation unit 154.

In step S153, on the basis of the method based on the AMVP or the merge mode, described above with reference to FIG. 7 or FIG. 9, the candidate prediction motion vector generation unit 153 generates a candidate prediction motion vector to be a candidate of the relevant PU.

In other words, the candidate prediction motion vector generation unit 153 references the adjacent motion vector information from the spatially adjacent motion vector buffer 151, and generates a spatial candidate prediction motion vector to be a candidate of the relevant PU.

At this time, as described above in step S151, in the temporally adjacent motion vector buffer 152, the reading of a temporally adjacent motion vector in the List0 prediction direction is controlled by the List0 temporal prediction control unit 161. In addition, as described above in step S151, in the temporally adjacent motion vector buffer 152, the reading of a temporally adjacent motion vector in the List1 prediction direction is controlled by the List1 temporal prediction control unit 162.

In a case where the temporal prediction motion vector in the List0 prediction direction is available, under control of the List0 temporal prediction control unit 161, the temporally adjacent motion vector buffer 152 performs the reading of the temporally adjacent motion vector in the List0 prediction direction. In response to this, the candidate prediction motion vector generation unit 153 generates a temporal prediction motion vector using the temporally adjacent motion vector in the List0 prediction direction.

In a case where the temporal prediction motion vector in the List1 prediction direction is available, under control of the List1 temporal prediction control unit 162, the temporally adjacent motion vector buffer 152 performs the reading of the temporally adjacent motion vector in the List1 prediction direction. In response to this, the candidate prediction motion vector generation unit 153 generates a temporal prediction motion vector using the temporally adjacent motion vector in the List prediction direction.

In a case where the temporal prediction motion vector in the List0 prediction direction is unavailable, under control of the List0 temporal prediction control unit 161, the temporally adjacent motion vector buffer 152 inhibits the reading of the temporally adjacent motion vector in the List0 prediction direction. Therefore, the temporal prediction motion vector in the List0 prediction direction is not generated.

In a case where the temporal prediction motion vector in the List1 prediction direction is unavailable, under control of the List1 temporal prediction control unit 162, the temporally adjacent motion vector buffer 152 inhibits the reading of the temporally adjacent motion vector in the List1 prediction direction. Therefore, the temporal prediction motion vector in the List1 prediction direction is not generated.

The information of the generated prediction motion vector is supplied, as candidate prediction motion vector information, to the cost function value calculation unit 154.

In step S154, the cost function value calculation unit 154 calculates a cost function value relating to the candidate prediction motion vector generated by the candidate prediction motion vector generation unit 153. The calculated cost function value and the corresponding candidate prediction motion vector information are supplied to the optimal prediction motion vector determination unit 155.

In step S155, the optimal prediction motion vector determination unit 155 regards a candidate prediction motion vector minimizing a cost function value from the cost function value calculation unit 154, as an optimal prediction motion vector with respect to the relevant PU, and supplies the information thereof to the motion prediction/compensation unit 115.

In step S156, using the information of the optimal prediction motion vector from the optimal prediction motion vector determination unit 155, the motion prediction/compensation unit 115 generates a difference motion vector serving as a difference with a motion vector, and calculates a cost function value with respect to each inter prediction mode.

In step S157, from among the individual prediction modes, the motion prediction/compensation unit 115 determines a prediction mode, which minimizes the cost function value, to be an optimal inter prediction mode. In step S158, the motion prediction/compensation unit 115 generates and supplies the prediction image of the optimal inter prediction mode to the prediction image selection unit 116.

In step S159, the motion prediction/compensation unit 115 supplies information relating to the optimal inter prediction mode to the parameter setting unit 171 in the lossless encoding unit 106, and causes the information relating to the optimal inter prediction mode to be encoded. In addition, at this time, the List0 temporal prediction control unit 161 and the List1 temporal prediction control unit 162 also supply, to the parameter setting unit 171, the information of the flags indicating whether or not the temporal prediction motion vectors in the List0 prediction direction and the List1 prediction direction are available, respectively, the information of the flags being generated in step S151.

In addition, examples of the information relating to the optimal inter prediction mode include the information of the optimal inter prediction mode, the difference motion vector information of the optimal inter prediction mode, the reference picture information of the optimal inter prediction mode, and a flag indicating the index of the prediction motion vector.

In response to the process in step S159, these supplied pieces of information are encoded in step S114 in FIG. 13.

As described above, since whether or not a temporal prediction motion vector in each prediction direction is available is set, it becomes possible for a user utilizing the image encoding device 100 to adjust the amount of computation and the amount of memory access to desired values with minimizing image deterioration.

### 2. Second Embodiment

### Image Decoding Device

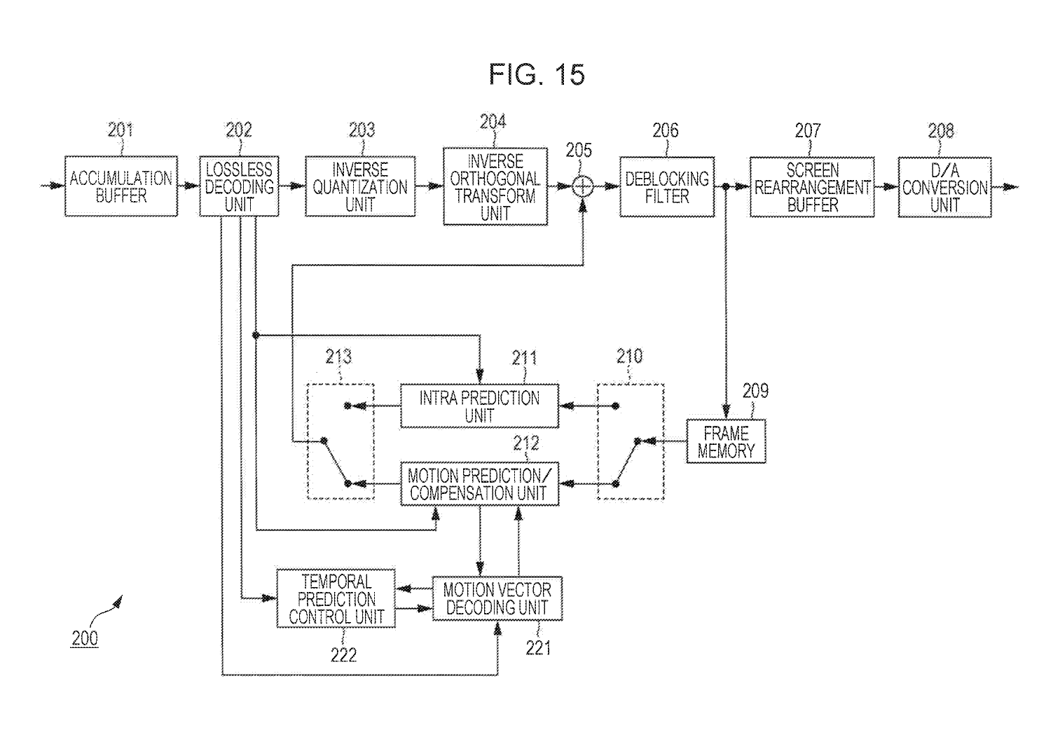

Next, decoding of encoded data (an encoded stream) encoded as described above will be described. FIG. 15 is a block diagram illustrating an example of the main configuration of an image decoding device corresponding to the image encoding device 100 in FIG. 1.

An image decoding device 200 illustrated in FIG. 15 decodes the encoded data generated by the image encoding device 100, using a decoding method corresponding to the encoding method thereof. In addition, it is assumed that, in the same way as the image encoding device 100, the image decoding device 200 performs inter prediction with respect to each prediction unit (PU).

As illustrated in FIG. 15, the image decoding device 200 includes an accumulation buffer 201, a lossless decoding unit 202, an inverse quantization unit 203, an inverse orthogonal transform unit 204, a computing unit 205, a deblocking filter 206, a screen rearrangement buffer 207, and a D/A conversion unit 208. In addition, the image decoding device 200 includes a frame memory 209, a selection unit 210, an intra prediction unit 211, a motion prediction/compensation unit 212, and a selection unit 213.

Furthermore, the image decoding device 200 includes a motion vector decoding unit 221 and a temporal prediction control unit 222.

The accumulation buffer 201 is also a reception unit receiving encoded data transmitted thereto. The accumulation buffer 201 receives and accumulates therein the encoded data transmitted thereto, and supplies the encoded data to the lossless decoding unit 202 at a given timing. To the encoded data, pieces of information necessary for decoding, such as the prediction mode information, the motion vector difference information, the index of the prediction motion vector, and the flag information indicating whether or not a temporal prediction vector is available, are added. The lossless decoding unit 202 decodes information, supplied from the accumulation buffer 201 and encoded by the lossless encoding unit 106 in FIG. 1, using a method corresponding to the encoding method of the lossless encoding unit 106. The lossless decoding unit 202 supplies, to the inverse quantization unit 203, the quantized coefficient data of a difference image obtained by decoding.

In addition, the lossless decoding unit 202 determines whether the intra prediction mode has been selected or the inter prediction mode has been selected, as the optimal prediction mode, and supplies information relating to the optimal prediction mode to one of the intra prediction unit 211 and the motion prediction/compensation unit 212, the one corresponding to a mode determined to be selected. In other words, for example, in a case where the inter prediction mode has been selected as an optimal prediction mode in the image encoding device 100, information relating to the optimal prediction mode is supplied to the motion prediction/compensation unit 212.

The inverse quantization unit 203 performs inverse quantization on a quantized coefficient obtained by being decoded by the lossless decoding unit 202, using a method corresponding to the quantization method of the quantization unit 105 in FIG. 1, and supplies the obtained coefficient data to the inverse orthogonal transform unit 204.

The inverse orthogonal transform unit 204 performs inverse orthogonal transform on the coefficient data supplied from the inverse quantization unit 203, using a method corresponding to the orthogonal transform method of the orthogonal transform unit 104 in FIG. 1. Owing to this inverse orthogonal transform processing, the inverse orthogonal transform unit 204 obtains decoded residual data corresponding to residual data before the orthogonal transform is performed in the image encoding device 100.

The decoded residual data obtained by being subjected to inverse orthogonal transform is supplied to the computing unit 205. In addition, a prediction image is supplied from the intra prediction unit 211 or the motion prediction/compensation unit 212 to the computing unit 205 via the selection unit 213.

The computing unit 205 adds the decoded residual data and the prediction image to each other, and obtains decoded image data corresponding to image data before a prediction image is subtracted by the computing unit 103 in the image encoding device 100. The computing unit 205 supplies the decoded image data to the deblocking filter 206.

The deblocking filter 206 arbitrarily performs deblocking filter processing on the supplied decoded image, and supplies that to the screen rearrangement buffer 207. By performing deblocking filter processing on the decoded image, the deblocking filter 206 removes the block distortion of the decoded image.

The deblocking filter 206 supplies a filter processing result (a decoded image after filter processing) to the screen rearrangement buffer 207 and the frame memory 209. In addition, the decoded image output from the computing unit 205 may be supplied to the screen rearrangement buffer 207 or the frame memory 209 without passing through the deblocking filter 206. In other words, the filter processing performed by the deblocking filter 206 may be skipped.

The screen rearrangement buffer 207 rearranges images. In other words, the order of the frames rearranged for the encoding order by the screen arrangement buffer 102 in FIG. 1 is rearranged in the original display order. The D/A conversion unit 208 D/A-converts an image supplied from the screen rearrangement buffer 207, and outputs the image to a display not illustrated in a drawing to display the image thereon.

The frame memory 209 stores therein the supplied decoded image, and supplies, as the reference image, the stored decoded image to the selection unit 210, at a given timing or on the basis of a request from outside, such as the intra prediction unit 211 or the motion prediction/compensation unit 212.

The selection unit 210 selects the supply destination of the reference image supplied from the frame memory 209. In a case of decoding an intra encoded image, the selection unit 210 supplies, to the intra prediction unit 211, the reference image supplied from the frame memory 209. In addition, in a case of decoding an inter encoded image, the selection unit 210 supplies, to the motion prediction/compensation unit 212, the reference image supplied from the frame memory 209.

To the intra prediction unit 211, information indicating the intra prediction mode, or the like, obtained by decoding header information, is arbitrarily supplied from the lossless decoding unit 402. The intra prediction unit 211 performs intra prediction using the reference image acquired from the frame memory 209, in the intra prediction mode used in the intra prediction unit 114 in FIG. 1, and generates a prediction image. The intra prediction unit 211 supplies the generated prediction image to the selection unit 213.

The motion prediction/compensation unit 212 acquires, from the lossless decoding unit 202, information (the optimal prediction mode information, the reference image information, and so forth) obtained by decoding the header information.

The motion prediction/compensation unit 212 performs inter prediction using the reference image acquired from the frame memory 209, in the inter prediction mode indicated by the optimal prediction mode information acquired from the lossless decoding unit 202, and generates a prediction image. In addition, at this time, the motion prediction/compensation unit 212 performs inter prediction using motion vector information reconstructed by the motion vector decoding unit 221.

The selection unit 213 supplies, to the computing unit 205, the prediction image from the intra prediction unit 211 or the prediction image from the motion prediction/compensation unit 212. In addition, in the computing unit 205, the prediction image generated using the motion vector and the decoded residual data (difference image information) from the inverse orthogonal transform unit 204 are added, and an original image is decoded. In other words, the motion prediction/compensation unit 212, the lossless decoding unit 202, the inverse quantization unit 203, the inverse orthogonal transform unit 204, and the computing unit 205 are also a decoding unit decoding the encoded data using the motion vector and generating the original image.

The motion vector decoding unit 221 acquires the information of the index of the prediction motion vector and the information of the difference motion vector out of pieces of information obtained by decoding the header information, from the lossless decoding unit 202. Here, the index of the prediction motion vector is information indicating, with respect to each PU, a region out of spatio-temporally adjacent regions, which has a motion vector with which the prediction processing of a motion vector (the generation of a prediction motion vector) is performed. The information relating to the difference motion vector is information indicating the value of the difference motion vector.

Under control of the temporal prediction control unit 222, the motion vector decoding unit 221 reconstructs a prediction motion vector using the motion vector of a PU indicated by the index of the prediction motion vector. By adding the reconstructed prediction motion vector and the difference motion vector from the lossless decoding unit 202, the motion vector decoding unit 221 reconstructs a motion vector, and supplies the information of the reconstructed motion vector to the motion prediction/compensation unit 212.

From among the pieces of information obtained by decoding the header information, the temporal prediction control unit 222 acquires the information of a flag indicating whether or not a temporal prediction motion vector in each prediction direction is available. On the basis of whether or not a temporal prediction motion vector in each prediction direction is available, which is indicated by the flag, the temporal prediction control unit 222 controls the use (generation) of a temporal prediction motion vector, performed by the motion vector decoding unit 221.

In addition, a basic operating principle relating to the present technology, in the motion vector decoding unit 221 and the temporal prediction control unit 222, is the same as the motion vector encoding unit 121 and the temporal prediction control unit 122 in FIG. 1. In this regard, however, in the image encoding device 100 illustrated in FIG. 1, in response to the operation of a user, which of the temporal prediction motion vector being used/unused (on/off) processing is performed on the basis of is set and controlled in each of the prediction directions of the List0 and the List1.

On the other hand, in the image decoding device 200 illustrated in FIG. 15, the information of a flag indicating whether or not a temporal prediction motion vector in each prediction direction is available is sent from an encoding side. Accordingly, in the image decoding device 200, on the basis of a result obtained by decoding the information of the flag, which of the temporal prediction motion vector being used/unused (on/off) processing is performed on the basis of is set and controlled in each of the prediction directions of the List0 and the List1.

[Examples of Configurations of Motion Vector Decoding Unit, Region Determination Unit, and Lossless Decoding Unit]

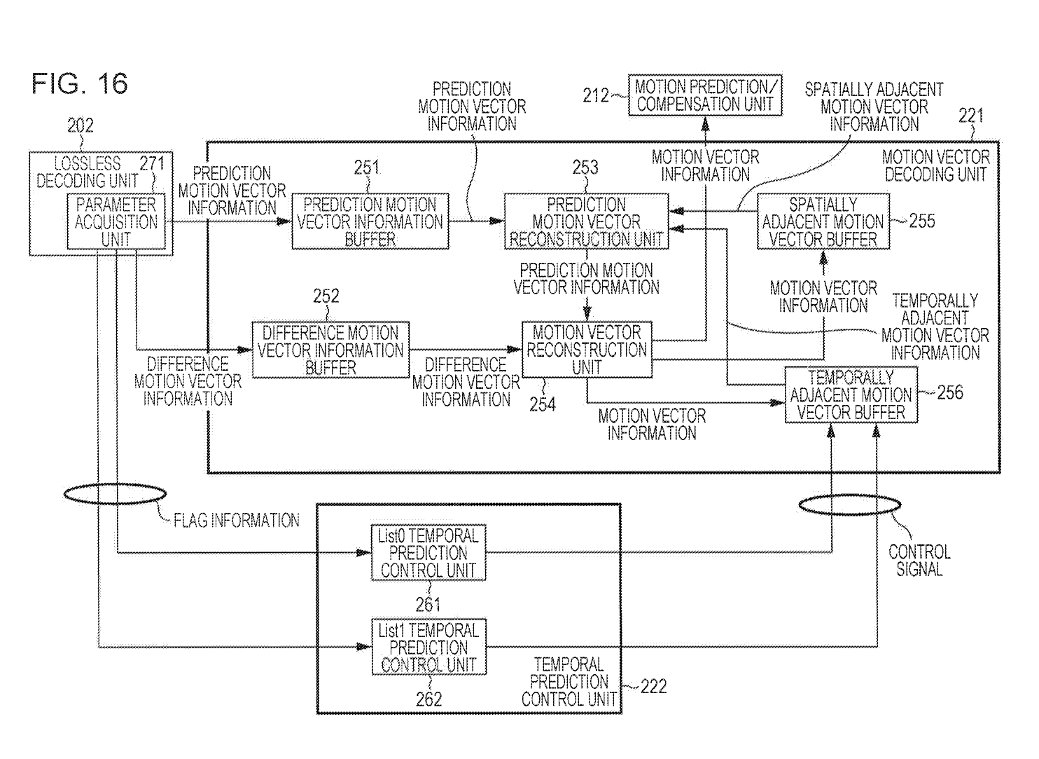

FIG. 16 is a block diagram illustrating examples of the main configurations of the motion vector decoding unit 221, the temporal prediction control unit 222, and the lossless decoding unit 202.

In the example in FIG. 16, the motion vector decoding unit 221 is configured so as to include a prediction motion vector information buffer 251, a difference motion vector information buffer 252, a prediction motion vector reconstruction unit 253, and a motion vector reconstruction unit 254. The motion vector decoding unit 221 is configured so as to further include a spatially adjacent motion vector buffer 255 and a temporally adjacent motion vector buffer 256.

The temporal prediction control unit 222 is configured so as to include a List0 temporal prediction control unit 261 and a List1 temporal prediction control unit 262.

The lossless decoding unit 202 is configured so as to include a parameter acquisition unit 271.

The prediction motion vector information buffer 251 accumulates therein information (hereinafter, referred to as the information of a prediction motion vector) indicating the index of the prediction motion vector of a target (current) region (PU) decoded by the lossless decoding unit 202. The prediction motion vector information buffer 251 reads out and supplies the information of the prediction motion vector of the relevant PU, to the prediction motion vector reconstruction unit 253.

The difference motion vector information buffer 252 accumulates therein the information of the difference motion vector of the target region (PU) decoded by the lossless decoding unit 202. The difference motion vector information buffer 252 reads out and supplies the information of the difference motion vector of the target PU (current PU), to the motion vector reconstruction unit 254.

The prediction motion vector reconstruction unit 253 reads out, from the spatially adjacent motion vector buffer 255, spatially adjacent motion vector information spatially adjacent to the target PU, and generates the spatial prediction motion vector of the relevant PU on the basis of a method based on the AMVP or the merge mode. The prediction motion vector reconstruction unit 253 reads out, from the temporally adjacent motion vector buffer 256, temporally adjacent motion vector information temporally adjacent to the target PU, and generates the temporal prediction motion vector of the relevant PU on the basis of a method based on the AMVP or the merge mode.

The prediction motion vector reconstruction unit 253 reconstructs, as the prediction motion vector of the relevant PU, one of the generated spatial prediction motion vector and temporal prediction motion vector of the relevant PU, the one being indicated by the index of the prediction motion vector of the target PU from the prediction motion vector information buffer 251. The prediction motion vector reconstruction unit 253 supplies the information of the reconstructed prediction motion vector to the motion vector reconstruction unit 254.

By adding the difference motion vector of the target PU, indicated by information from the difference motion vector information buffer 252, and the reconstructed prediction motion vector of the target PU to each other, the motion vector reconstruction unit 254 reconstructs a motion vector. The motion vector reconstruction unit 254 supplies information indicating the reconstructed motion vector to the motion prediction/compensation unit 212, the spatially adjacent motion vector buffer 255, and the temporally adjacent motion vector buffer 256.

The spatially adjacent motion vector buffer 255 is configured by a line buffer in the same way as the spatially adjacent motion vector buffer 151 in FIG. 12. The spatially adjacent motion vector buffer 255 accumulates therein the motion vector information reconstructed by the motion vector reconstruction unit 254, as spatially adjacent motion vector information for the prediction motion vector information of a subsequent PU within the same picture.

The temporally adjacent motion vector buffer 256 is configured by a memory in the same way as the temporally adjacent motion vector buffer 152 in FIG. 12. The temporally adjacent motion vector buffer 256 accumulates therein the motion vector information reconstructed by the motion vector reconstruction unit 254, as temporally adjacent motion vector information for the prediction motion vector information of a PU in a different picture.

In addition, using the motion vector reconstructed by the motion vector reconstruction unit 254, the motion prediction/compensation unit 212 performs inter prediction using the reference image, in the inter prediction mode indicated by the optimal prediction mode information acquired from the lossless decoding unit 202, and generates a prediction image.

The List0 temporal prediction control unit 261 acquires the information of a flag from the parameter acquisition unit 271, the flag indicating whether or not a temporal prediction motion vector in the List0 prediction direction is available. In response to the acquired information of the flag, the List0 temporal prediction control unit 261 sets whether or not a temporal prediction motion vector in the List0 prediction direction out of prediction motion vectors is available.

In a case of having set that a temporal prediction motion vector in the List0 prediction direction is available, the List0 temporal prediction control unit 261 causes the temporally adjacent motion vector buffer 256 to read out a temporally adjacent motion vector in the List0 prediction direction. In a case of having set that a temporal prediction motion vector in the List0 prediction direction is unavailable, the List0 temporal prediction control unit 261 inhibits the temporally adjacent motion vector buffer 256 from reading out a temporally adjacent motion vector in the List0 prediction direction.

The List1 temporal prediction control unit 262 acquires the information of a flag from the parameter acquisition unit 271, the flag indicating whether or not a temporal prediction motion vector in the List1 prediction direction is available. In response to the acquired information of the flag, the List1 temporal prediction control unit 262 sets whether or not a temporal prediction motion vector in the List1 prediction direction out of prediction motion vectors is available.

In a case of having set that a temporal prediction motion vector in the List1 prediction direction is available, the List1 temporal prediction control unit 262 causes the temporally adjacent motion vector buffer 256 to read out a temporally adjacent motion vector in the List1 prediction direction. In a case of having set that a temporal prediction motion vector in the List1 prediction direction is unavailable, the List1 temporal prediction control unit 262 inhibits the temporally adjacent motion vector buffer 256 from reading out a temporally adjacent motion vector in the List1 prediction direction.

The parameter acquisition unit 271 acquires and supplies header information (a parameter) added to the decoded data, to a corresponding unit. For example, the parameter acquisition unit 271 supplies, to the prediction motion vector information buffer 251, information indicating the index of a prediction motion vector. The parameter acquisition unit 271 supplies, to the difference motion vector information buffer 252, information indicating a difference motion vector. The parameter acquisition unit 271 supplies, to the List0 temporal prediction control unit 261, the information of a flag indicating whether or not the temporal prediction motion vector in the List0 prediction direction is available. The parameter acquisition unit 271 supplies, to the List0 temporal prediction control unit 261, the information of a flag indicating whether or not the temporal prediction motion vector in the List0 prediction direction is available.

[Flow of Decoding Processing]

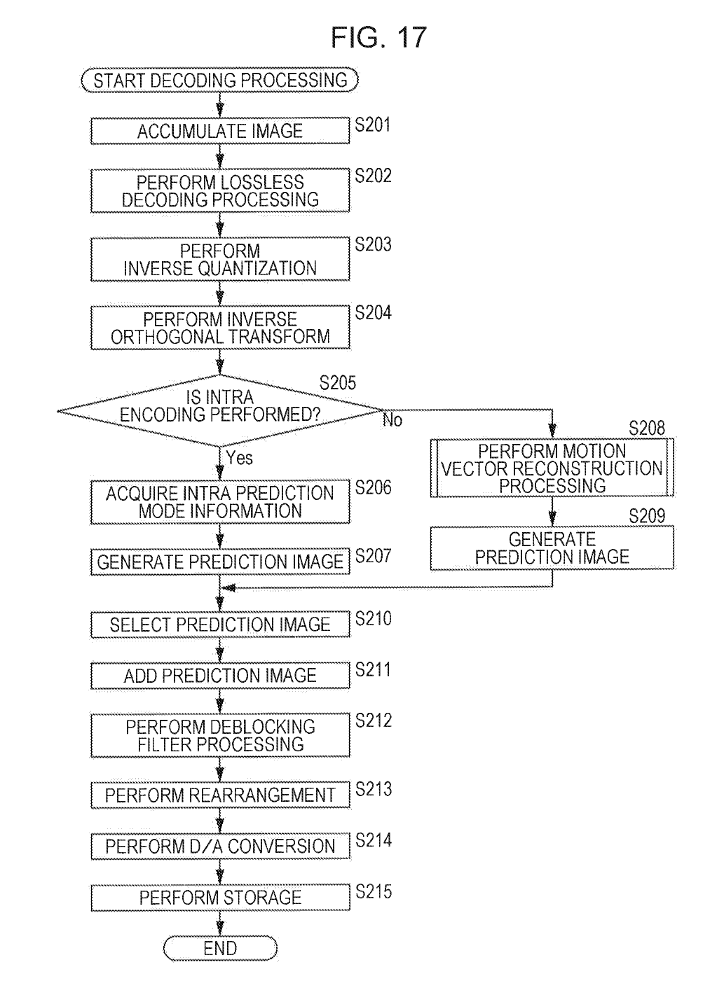

Next, the flow of individual processes executed by the image decoding device 200 as described above will be described. First, with reference to a flowchart in FIG. 17, an example of the flow of decoding processing will be described.

When the decoding processing has been started, in step S201 the accumulation buffer 201 accumulates therein a code stream transmitted thereto. In step S202, the lossless decoding unit 202 decodes a code stream (encoded difference image information) supplied from the accumulation buffer 201. In other words, an I picture, a P picture, and a B picture are decoded that have been encoded by the lossless encoding unit 106 in FIG. 1.

At this time, various kinds of information other than the difference image information, included in a code stream such as the header information, are also decoded. The parameter acquisition unit 271 acquires, for example, the prediction mode information, the information of the difference motion vector, a flag indicating the index of the prediction motion vector, the information of the difference quantization parameter, a flag indicating whether or not the temporal prediction motion vector in the prediction direction is available, and so forth. The parameter acquisition unit 271 supplies the acquired information to a corresponding unit. In addition, the flag indicating whether or not the temporal prediction motion vector in the prediction direction is available is acquired from, for example, the Picture Parameter Set or the like.

In step S203, the inverse quantization unit 203 performs inverse quantization on the quantized orthogonal transform coefficient obtained by the process in step S202. In addition, a quantization parameter obtained by a process in step S208 described below is used for this inverse quantization processing. In step S204, the inverse orthogonal transform unit 204 performs inverse orthogonal transform on the orthogonal transform coefficient subjected to the inverse quantization in step S203.

In step S205, on the basis of information relating to the optimal prediction mode, decoded in step S202, the lossless decoding unit 202 determines whether or not encoded data serving as a processing target has been intra encoded. In a case where having been intra encoded has been determined, the processing proceeds to step S206.

In step S206, the intra prediction unit 211 acquires the intra prediction mode information. In step S207, the intra prediction unit 211 performs intra prediction using the intra prediction mode information acquired in step S206, and generates a prediction image.

In addition, in a case where, in step S206, it has been determined that the encoded data serving as a processing target has not been intra encoded, in other words, the encoded data has been inter encoded, the processing proceeds to step S208.

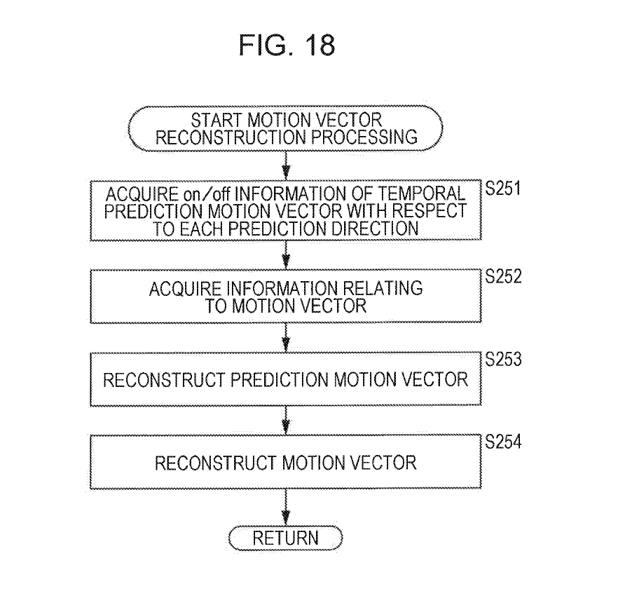

In step S208, the motion vector decoding unit 221 and the temporal prediction control unit 222 perform motion vector reconstruction processing. The detail of the motion vector reconstruction processing will be described later with reference to FIG. 18.

Owing to the process in step S208, the decoded information relating to the prediction motion vector is referenced, and the prediction motion vector of the relevant PU is reconstructed. On that occasion, on the basis of whether or not the temporal prediction motion vector in the prediction direction is available, indicated by the flag, the generation of the temporal prediction motion vector is controlled. In addition, using the reconstructed prediction motion vector of the relevant PU, a motion vector is reconstructed, and the reconstructed motion vector is supplied to the motion prediction/compensation unit 212.

In step S209, the motion prediction/compensation unit 212 performs inter motion prediction processing using the motion vector reconstructed by the process in step S208, and generates a prediction image. The generated prediction image is supplied to the selection unit 213.

In step S210, the selection unit 213 selects the prediction image generated in step S207 or step S209. In step S211, the computing unit 205 adds the prediction image selected in step S210 to the difference image information obtained by being subjected to the inverse orthogonal transform in step S204. Owing to this, an original image is decoded. In other words, the prediction image is generated using the motion vector, the generated prediction image and the difference image information from the inverse orthogonal transform unit 204 are added, and hence, the original image is decoded.

In step S212, the deblocking filter 206 arbitrarily performs deblocking filter processing on the decoded image obtained in step S211.

In step S213, the screen rearrangement buffer 207 rearranges the image subjected to the filter processing in step S212. In other words, the order of frames rearranged for encoding by the screen rearrangement buffer 102 in the image encoding device 100 is rearranged in the original display order.

In step S214, the D/A conversion unit 208 D/A-converts the image in which the order of the frames has been rearranged in step S213. This image is output to a display not illustrated in a drawing, and an image is displayed.

In step S215, the frame memory 209 stores therein the image subjected to the filter processing in step S212.

When the process in step S215 has finished, the decoding processing is finished.

[Flow of Motion Vector Reconstruction Processing]

Next, an example of the flow of the motion vector reconstruction processing executed in step S208 in FIG. 17 will be described with reference to a flowchart in FIG. 18. In addition, this motion vector reconstruction processing is processing in which a motion vector is decoded using information transmitted from an encoding side and decoded by the lossless decoding unit 202.

In step S202 in FIG. 17, the parameter acquisition unit 271 in the lossless decoding unit 202 acquires the decoded information of a parameter or the like, and supplies the acquired information to a corresponding unit.

In step S251, the List0 temporal prediction control unit 261 and the List1 temporal prediction control unit 262 acquire the on/off information of a temporal prediction motion vector in each prediction direction from the parameter acquisition unit 271.

In other words, the List0 temporal prediction control unit 261 acquires the information of a flag from the parameter acquisition unit 271, the flag indicating whether or not the temporal prediction motion vector in the List0 prediction direction is available. In response to the acquired information of the flag, the List0 temporal prediction control unit 261 sets whether or not the temporal prediction motion vector in the List0 prediction direction out of prediction motion vectors is available. On the basis of the setting of whether or not the temporal prediction motion vector in the List0 prediction direction is available, the List0 temporal prediction control unit 261 controls the reading of a temporally adjacent motion vector in the List0 prediction direction with respect to the temporally adjacent motion vector buffer 256.

In addition, the List1 temporal prediction control unit 262 acquires the information of a flag from the parameter acquisition unit 271, the flag indicating whether or not the temporal prediction motion vector in the List1 prediction direction is available. In response to the acquired information of the flag, the List1 temporal prediction control unit 262 sets whether or not the temporal prediction motion vector in the List1 prediction direction out of prediction motion vectors is available. On the basis of the setting of whether or not the temporal prediction motion vector in the List1 prediction direction is available, the List1 temporal prediction control unit 262 controls the reading of a temporally adjacent motion vector in the List1 prediction direction with respect to the temporally adjacent motion vector buffer 256.

In step S252, the prediction motion vector information buffer 251 and the difference motion vector information buffer 252 acquire information from the parameter acquisition unit 271, the information relating to a motion vector. In other words, as the information relating to a motion vector, the prediction motion vector information buffer 251 acquires information indicating the index of a prediction motion vector, and supplies the acquired information to the prediction motion vector reconstruction unit 253. In addition, as the information relating to a motion vector, the difference motion vector information buffer 252 acquires and supplies the information of a difference motion vector, to the motion vector reconstruction unit 254.

In step S253, on the basis of a method based on the MVP or the merge mode, described above with reference to FIG. 7 or FIG. 9, the prediction motion vector reconstruction unit 253 reconstructs the prediction motion vector of the relevant PU. In other words, the prediction motion vector reconstruction unit 253 reads out, from the spatially adjacent motion vector buffer 255, spatially adjacent motion vector information spatially adjacent to the target PU, and generates the spatial prediction motion vector of the relevant PU on the basis of a method based on the AMVP or the merge mode.

At this time, as described above in step S251, in the temporally adjacent motion vector buffer 256, the reading of the temporally adjacent motion vector in the List0 prediction direction is controlled by the List0 temporal prediction control unit 261. In addition, as described above in step S251, in the temporally adjacent motion vector buffer 256, the reading of the temporally adjacent motion vector in the List1 prediction direction is controlled by the List1 temporal prediction control unit 262.

In a case where the temporal prediction motion vector in the List0 prediction direction is available, under control of the List0 temporal prediction control unit 261, the temporally adjacent motion vector buffer 256 performs the reading of the temporally adjacent motion vector in the List0 prediction direction. In response to this, on the basis of a method based on the AMVP or the merge mode, the prediction motion vector reconstruction unit 253 generates the temporal prediction motion vector of the relevant PU using the temporally adjacent motion vector in the List0 prediction direction.

In a case where the temporal prediction motion vector in the List1 prediction direction is available, under control of the List1 temporal prediction control unit 162, the temporally adjacent motion vector buffer 152 performs the reading of the temporally adjacent motion vector in the List1 prediction direction. In response to this, on the basis of a method based on the AMVP or the merge mode, the prediction motion vector reconstruction unit 253 generates the temporal prediction motion vector of the relevant PU using the temporally adjacent motion vector in the List1 prediction direction.

In addition, in a case where the temporal prediction motion vector in the List0 prediction direction is unavailable, under control of the List0 temporal prediction control unit 261, the temporally adjacent motion vector buffer 256 inhibits the reading of the temporally adjacent motion vector in the List0 prediction direction. Therefore, the temporal prediction motion vector in the List0 prediction direction is not generated.

In the same way, in a case where the temporal prediction motion vector in the List1 prediction direction is available, under control of the List1 temporal prediction control unit 262, the temporally adjacent motion vector buffer 256 inhibits the reading of the temporally adjacent motion vector in the List1 prediction direction. Therefore, the temporal prediction motion vector in the List1 prediction direction is not generated.

The prediction motion vector reconstruction unit 253 reconstructs, as the prediction motion vector of the relevant PU, one out of the generated spatial prediction motion vector and temporal prediction motion vector of the relevant PU, the one being indicated by the index of the prediction motion vector of the target PU from the prediction motion vector information buffer 251. The prediction motion vector reconstruction unit 253 supplies the information of the reconstructed prediction motion vector to the motion vector reconstruction unit 254.

In step S254, by adding the difference motion vector of the target PU, indicated by information from the difference motion vector information buffer 252, and the reconstructed prediction motion vector of the target PU to each other, the motion vector reconstruction unit 254 reconstructs a motion vector. The motion vector reconstruction unit 254 supplies information indicating the reconstructed motion vector to the motion prediction/compensation unit 212, the spatially adjacent motion vector buffer 255, and the temporally adjacent motion vector buffer 256.

By performing individual processes as above, it is possible for the image decoding device 200 to correctly decode the encoded data encoded by the image encoding device 100 and to realize the improvement of an encoding efficiency.

In other words, in the image decoding device 200, the flag indicating whether or not a temporal prediction motion vector in each prediction direction is available is acquired from the encoded stream, and on the basis of the acquired flag, the use of the temporal prediction motion vector in each prediction direction is controlled.

Owing to this, it is possible to reduce the amount of computation and the amount of memory access with minimizing image deterioration.

In other words, since whether or not a temporal prediction motion vector generated on the basis of the MV competition or the merge mode is to be used is adjusted, it becomes possible for a user to adjust the amount of computation and the amount of memory access to desired values with minimizing image deterioration.

### 3. Third Embodiment

### Image Encoding Device

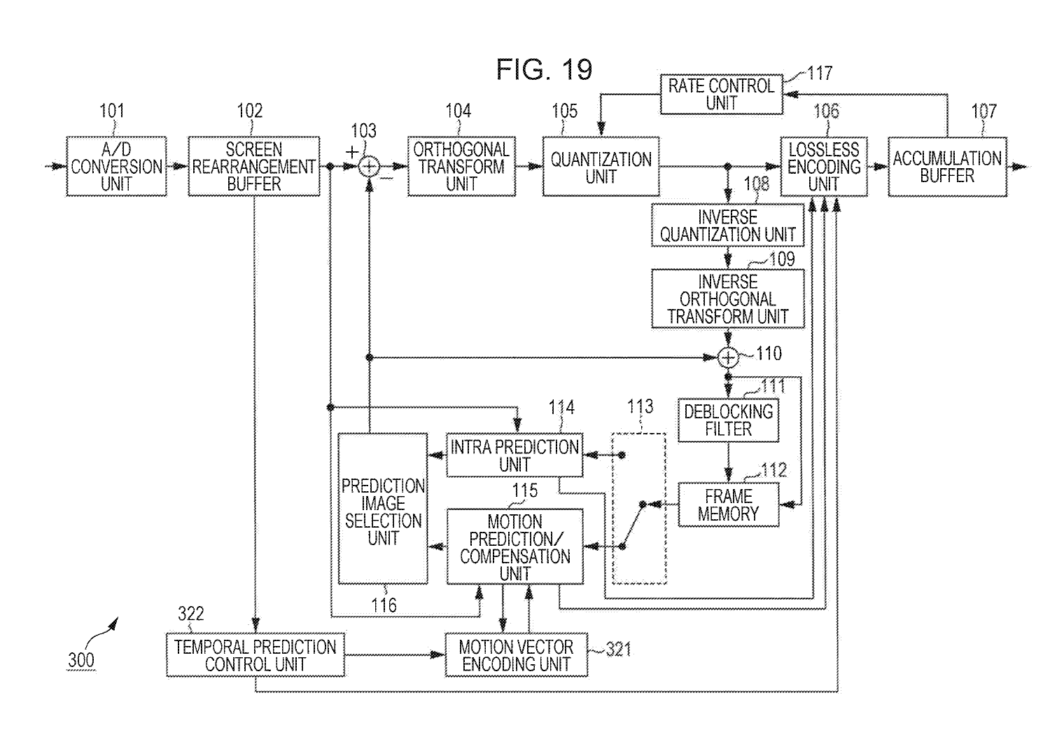

FIG. 19 is a block diagram illustrating another example of the configuration of an image encoding device. An image encoding device 300 illustrated in FIG. 19 is basically the same device as the image encoding device 100 in FIG. 1, has the same configuration, and performs the same processing. In this regard, however, the image encoding device 300 includes a motion vector encoding unit 321 in place of the motion vector encoding unit 121 in the image encoding device 100, and includes a temporal prediction control unit 322 in place of the temporal prediction control unit 122 in the image encoding device 100.

Under control of the temporal prediction control unit 322, the motion vector encoding unit 321 predicts the motion vector of a current block (processing target region) obtained in the motion prediction/compensation unit 115. In other words, the motion vector encoding unit 321 generates, as candidates, a temporal prediction motion vector (temporal predictor) and a spatial prediction motion vector (spacial predictor), and selects an optimal one from thereamong, as a prediction motion vector (predictor).

The temporal prediction control unit 322 sets whether or not a temporal prediction motion vector is available in the motion vector encoding unit 321.

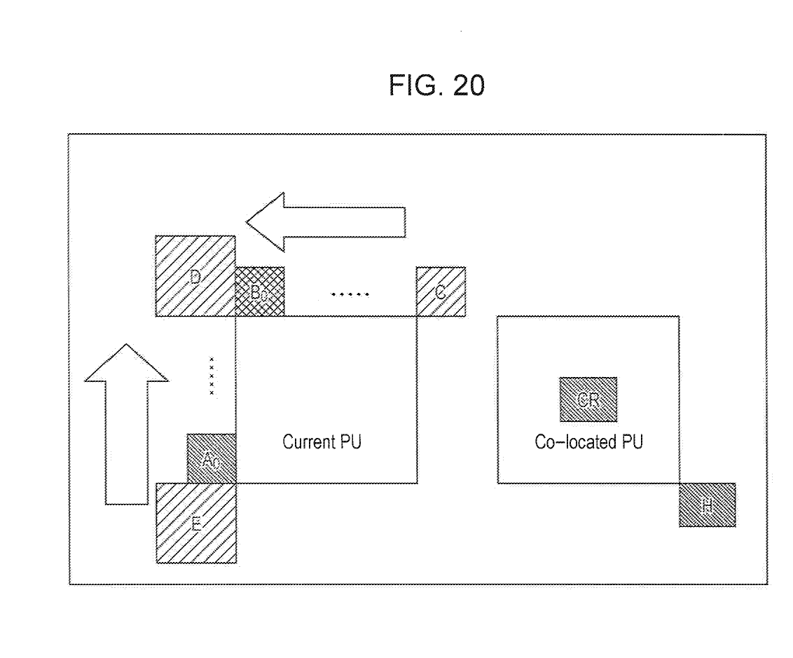

Here, using FIG. 20, an encoding method for motion vector information in the HEVC will be described.

As described above, in the HEVC, two motion vector information encoding methods called AMVP (Advanced Motion Vector Prediction) and the Merge (merge) are specified.

Both thereof generate the prediction value of motion vector information in a current block, from motion vector information in a neighboring block. In the AMVP, a difference value (difference motion vector) between the prediction motion vector information thereof and the motion vector information of the current block is transmitted. For example, the image encoding device 300 causes the difference motion vector to be included in generated image compression information (encoded data), and transmits the difference motion vector. In contrast, in the Merge, prediction motion vector information generated from a neighboring block is defined as motion vector information relating to a current block.

Neighboring motion vector information is generated using the temporal-directionally adjacent motion vector information of the current block and spatial-direction motion vector information.

In the case of the example in FIG. 20, as a spatial motion vector information candidate, one is selected from among A₀ and E, and one is selected from C, B₀, and D.

In what follows, it is assumed that VEC1 is motion vector information whose reference index (ref_idx) and list (list) are the same as those of the current PU serving as a processing target, VEC2 is motion vector information whose ref_idx is the same as that of the current PU and whose list is different from that of the current PU, VEC3 is motion vector information whose ref_idx is different from that of the current PU and whose list is the same as that of the current PU, and VEC4 is motion vector information whose ref_idx and list are different from those of the current PU.

First, the scan of the VEC1 of the E and the A₀ is performed.

Next, the scan of the VEC2, 3, and 4 of the E and the A₀ is performed.

Next, the scan of the VEC1 of the C, the Bₒ, and the D is performed.

Next, the scan of the VEC2, 3, and 4 of the C, the B₀, and the D is performed.

The above-mentioned scan processing finishes at the time of the detection of corresponding motion vector information.

In addition, such scaling (scaling) processing as illustrated in the following Expression (20) is performed on the VEC3 and 4.

mvLXZ=ClipMv(Sign(DistScaleFactor*mvLZ)*((Abs(DistScaleFactor*mvLXZ)+127)>>8)) (20)

As for the prediction motion vector information in the temporal direction, if H is unavailable (unavailable), motion vector information relating to CR is used.

In addition, the spatial-directionally adjacent motion vector information is able to be sequentially stored in the line buffer and sequentially extracted. However, since the temporal-directionally adjacent motion vector information is stored in the memory and extracted, there is a possibility that pressure is put on a memory bandwidth.

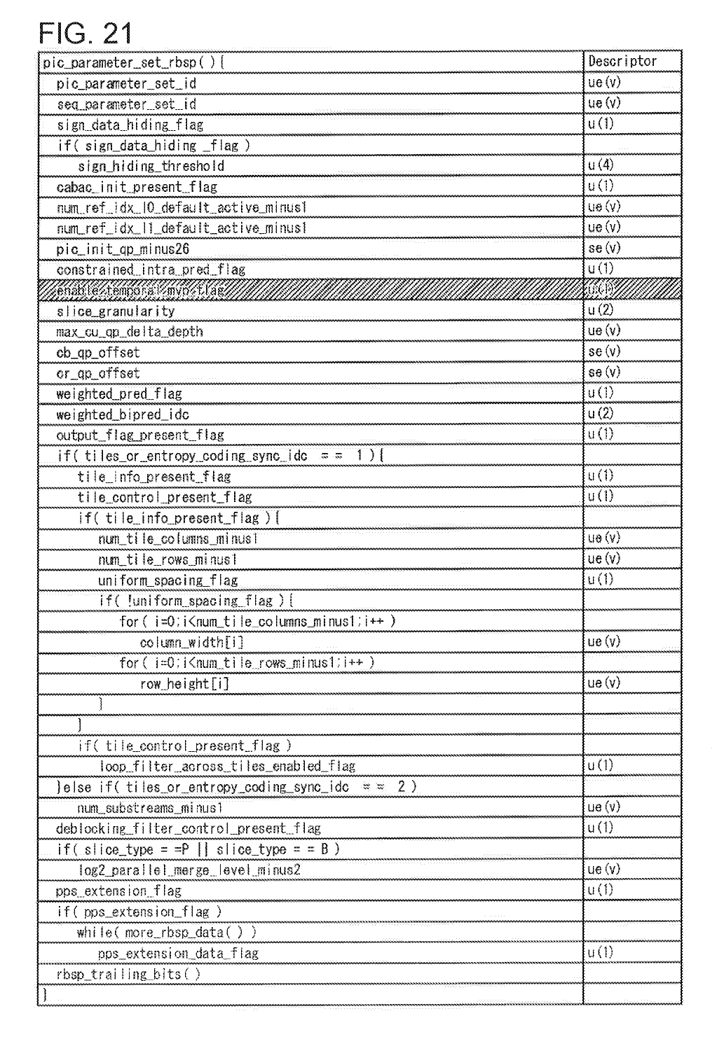

Therefore, in the HEVC, as illustrated in FIG. 21, in PPS (Picture Parameter Set), a parameter, enable_temporal_mvp_flag, is provided that controls whether or not motion vector prediction is available (on/off) that utilizes the motion vector information in the temporal axis direction in a current picture serving as a processing target.

For example, in a picture where “1” is set as the value of the enable_temporal_mvp_flag, it is possible to use not only prediction in the spatial direction but also prediction in the temporal direction, in the prediction of a motion vector. In other words, in this picture, it is possible to generate both the spatial prediction motion vector and the temporal prediction motion vector, and it is possible to define these as the candidates of the prediction motion vector.

In an opposite manner, for example, in a picture where “0” is set as the value of the enable_temporal_mvp_flag, it is not possible to use the prediction in the temporal direction, in the prediction of a motion vector. In other words, in this picture, the spatial prediction motion vector is only used, and defined as the candidate of the prediction motion vector.

Incidentally, in the HEVC, a CRA (Clean Random Access) picture is specified. The CRA picture is a picture only including an I slice, and the nal_unit_type of each slice is 4. A picture subsequent to the CRA picture in an decoding order or an outputting order is not able to reference a picture preceding the CRA picture in the decoding order or the outputting order. In addition, the picture preceding the CRA picture in the decoding order is also required to precede the CRA picture in the outputting order.

In addition, in the HEVC, a TLA (temporal layer access) picture is specified. In all slices included in the TLA picture, the nal_unit_type is 3. The TLA picture and a picture subsequent to the TLA picture in the decoding order, the picture having a temporal_id of a value comparable to or greater than or equal to that of the TLA picture, are not able to reference a picture preceding the TLA picture in the decoding order, the picture having a temporal_id of a value comparable to or greater than or equal to that of the TLA picture.

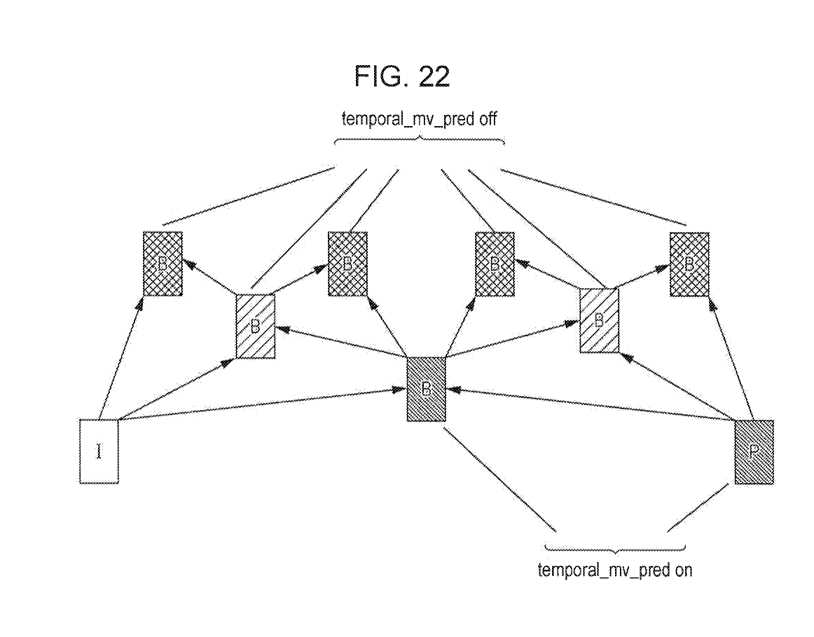

Incidentally, both image quality in image compression information to be an output and a load on the memory bandwidth are taken into consideration, and it is assumed that the temporal prediction motion vector (temporal my prefdiction) is permitted to be used in only some pictures. For example, in the HEVC, a plurality of pictures of moving image data form such a hierarchical structure as illustrated in FIG. 22 and are encoded. In FIG. 22, arrows indicate reference directions. In other words, in a drawing, since being directly or indirectly referenced by more pictures, a picture in a lower layer is more important. In other words, by improving the image quality of a picture in a lower layer, it is possible to improve the image quality of more pictures, and in an opposite manner, by reducing the image quality of a picture in a lower layer, the image quality of more pictures turns out to be reduced.

As described above, in general, in the prediction of the motion vector, it is possible to suppress the reduction of the image quality with an increase in the number of prediction directions to be candidates. However, the prediction in the temporal direction increases a load on the memory bandwidth.

Therefore, prediction in the temporal direction is only permitted with respect to more important pictures in a lower layer in FIG. 22, and prediction in the temporal direction is inhibited with respect to pictures in a upper layer.

In the case of the above-mentioned syntax of the HEVC, such control is performed on the basis of the value of the enable_temporal_mvp_flag. In other words, it is necessary to control whether or not prediction in the temporal direction is permitted to be used with respect to every one picture. Therefore, for example, when it is assumed that 10000 pictures are included in a relevant sequence, it is necessary to transmit the enable_temporal_mvp_flag of up to 10000 bits, and there has been a possibility that an encoding efficiency is greatly reduced.

Therefore, a plurality of pictures are divided into groups in accordance with a predetermined rule, and whether or not the prediction in the temporal direction (temporal my prediction) is available (on/off) is controlled with respect to each group. Whether or not prediction in the temporal direction (temporal my prediction) is available (on/off) is controlled in response to, for example, the hierarchical structure of a GOP. Since this hierarchical structure is well known, it is only necessary to specify, for example, whether the prediction in the temporal direction is permitted to be used (or inhibited) in a picture in which layer.

For example, in a case where pictures are classified on the basis of the degree of importance in such a way as in this hierarchical structure, it is desirable that the prediction in the temporal direction is permitted to be used in a picture in a lower layer (a more important picture). In other words, in this case, since a layer permitting the use of the prediction in the temporal direction and a layer inhibiting it are separated by one boundary, it is only necessary to specify the boundary.

As described above, it is possible to greatly reduce the amount of information (the amount of code) used for controlling whether or not the prediction in the temporal direction is available. In addition, since the prediction in the temporal direction is applied in a more important picture, it is also possible to suppress the deterioration of image quality.

In other words, in the above-mentioned control, the pattern of control of whether or not the prediction in the temporal direction is available is specified. Accordingly, it is only necessary to perform such specification only once within a range where the same pattern of control is applied.

In other words, as one of prediction methods for a motion vector, a pattern of whether or not the temporal prediction is to be used is set, the temporal prediction performing prediction using a motion vector in a temporally neighboring region temporally located on the periphery of a current region, and hence, it is possible to greatly reduce the amount of information (the amount of code) used for controlling whether or not the prediction in the temporal direction (temporal prediction) is available, with suppressing the deterioration of image quality.

In addition, such control information is transmitted with being included in, for example, the sequence parameter set (SPS (Sequence Parameter Set)).

[Temporal Prediction Control]

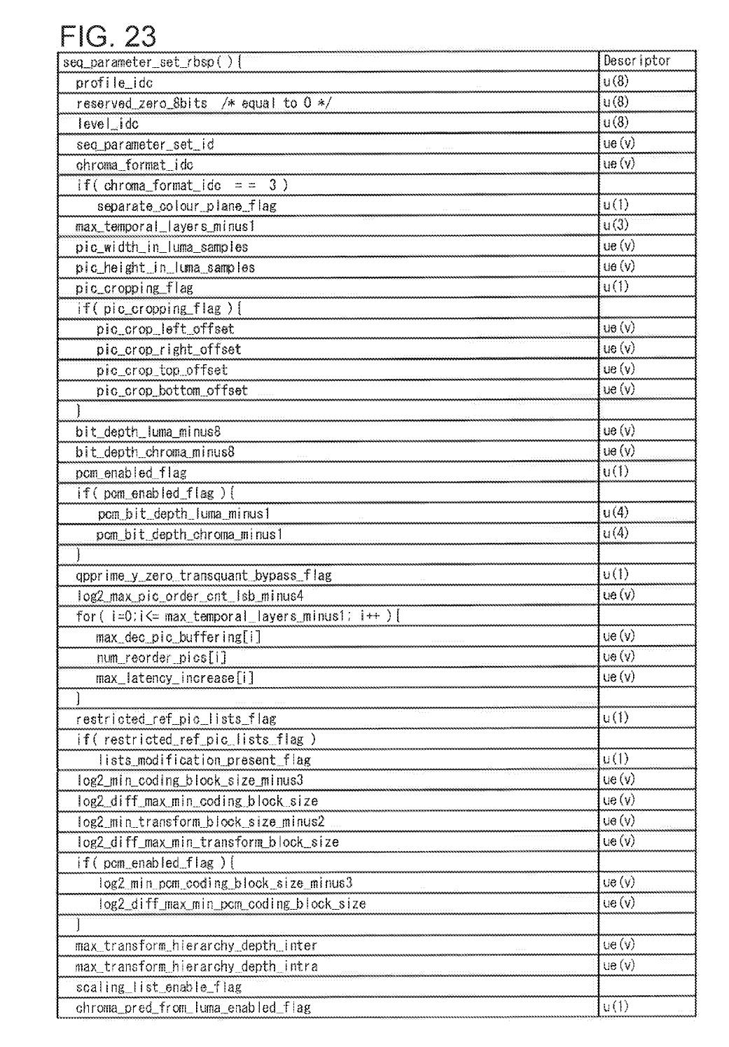

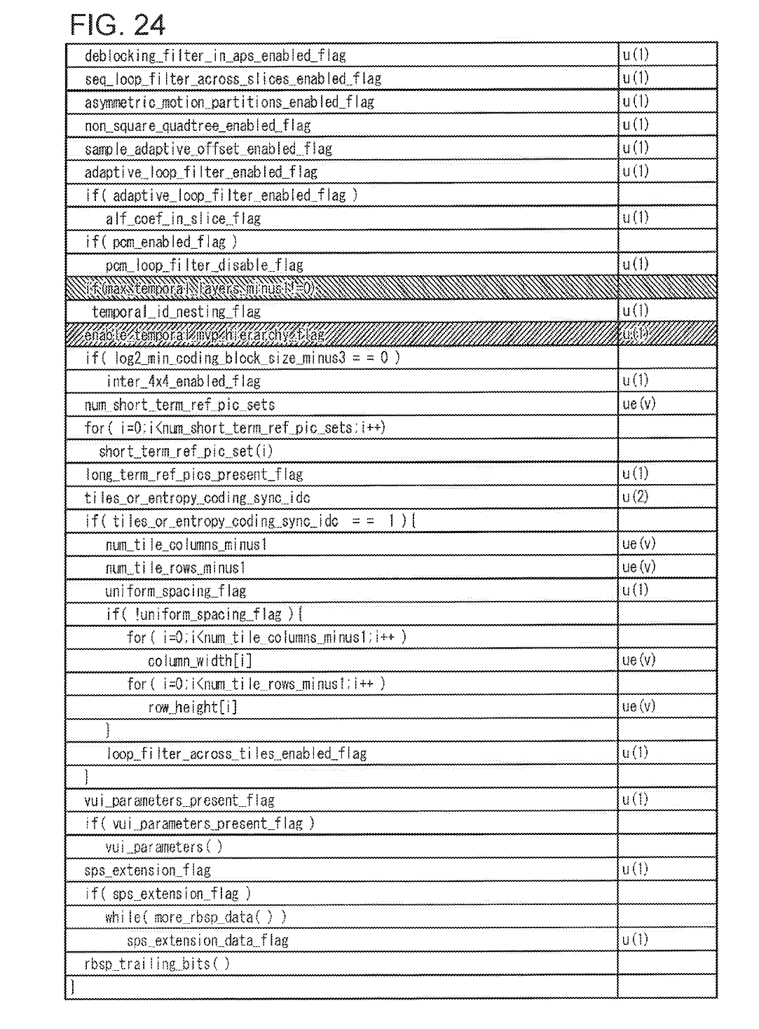

In order to realize such control as described above, in place of the enable_temporal_mvp_flag in the picture parameter set, described in FIG. 21, an enable_temporal_mvp_hierarchy_flag is set in, for example, the sequence parameter set (SPS), as illustrated in FIG. 23 and FIG. 24. This enable_temporal_mvp_hierarchy_flag is information indicating a pattern of whether or not the temporal prediction is to be used that performs prediction using the above-mentioned parameter in a temporally neighboring region temporally located on the periphery of a current region.

In addition, when the value of max_temporal_layers_minus1 is 0 in the syntax (syntax) of the HEVC, a temporal_id_nesting_flag becomes redundant information.

Therefore, as illustrated in FIG. 24, only when the value of the max_temporal_layers_minus1 is other than 0, the temporal_id_nesting_flag is to be transmitted in the image compression information to be an output.

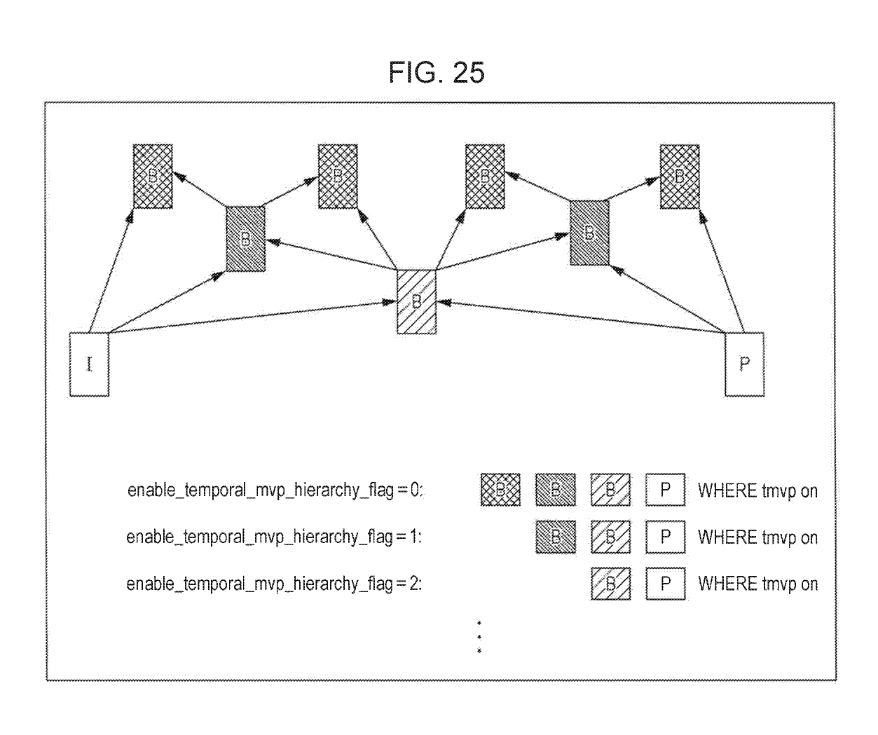

Semantics relating to the value of the enable_temporal_mvp_hierarchy_flag are illustrated in FIG. 25.

In other words, when the value thereof is 0, the temporal my prediction is applied to pictures in all layers, as illustrated in a drawing. Every time the value thereof is incremented by 1, the temporal my prediction corresponding to each layer becomes off (unavailable).

In addition, the upper limit value of the enable_temporal_mvp_hierarchy_flag is specified by the value of the max_temporal_layers_minus1.

As described above, in a case where the current sequence includes 10000 frames, it is necessary to transmit a flag of 10000 bits used for on/off in the worst case in a method based on the HEVC.

In contrast, in a method based on the present technology, since the upper limit value of the max_temporal_layers_minus1 is 7, the amount of information necessary for transmitting the enable_temporal_mvp_hierarchy_flag is required to be 8 in the worst case. Accordingly, the image encoding device 300 enables a trade-off between an encoding efficiency and memory access in the image compression information to be an output to be realized, with suppressing an increase in the amount of information required for an on/off_flag.

In addition, if the above-mentioned control of whether or not the temporal prediction is available is performed in a unit larger than a picture, it is possible to reduce the amount of information compared with at least the method of the HEVC. Accordingly, the transmission of the enable_temporal_mvp_hierarchy_flag is not limited to the SPS (with respect to each sequence). For example, the enable_temporal_mvp_hierarchy_flag may also be transmitted in an IDR picture, a CRA picture, or a TLA picture. In other words, if being larger than the picture, the transmission unit of the enable_temporal_mvp_hierarchy_flag is arbitrary.

In addition, in this way, the number of layers of the hierarchical structure where whether or not the temporal prediction is available is controlled is naturally arbitrary. Furthermore, as for such control of whether or not the temporal prediction is available, it is only necessary to be able to classify a plurality of pictures into pictures to which the temporal prediction is applied and pictures to which the temporal prediction is not applied. In other words, as one of prediction methods for parameters, it is not necessary for the pattern of whether or not the temporal prediction is to be used to be based on the hierarchical structure of pictures (not an indispensable condition). Therefore, the picture does not have to have the above-mentioned hierarchical structure, and the pattern of whether or not the temporal prediction is to be used may also be determined on the basis of a condition other than the hierarchical structure of pictures.

For example, it is also possible to apply to a sequence having an IPPP***structure. With respect to such a sequence, whether or not the temporal prediction is to be used may also be classified on the basis of the arrangement order of the plural pictures. For example, in a case where the value of the enable_temporal_mvp_hierarchy_flag is 1, the temporal my prediction may become off (off), in other words, the temporal prediction may become unavailable, with respect to one in every two P pictures.

Needless to say, any selection pattern for a picture where the temporal prediction is to be unavailable (or available) may be allocated to the value of the enable_temporal_mvp_hierarchy_flag.

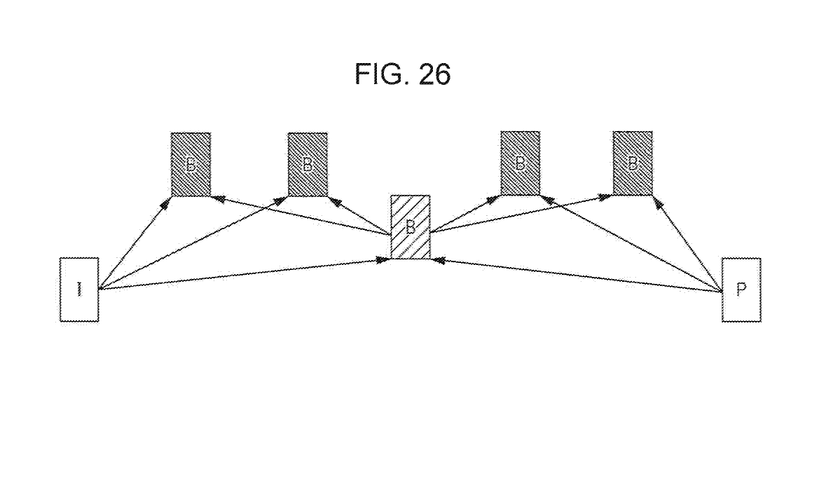

In addition, even in a case where the plural pictures form a hierarchical structure, the hierarchical structure is arbitrary. For example, the number of pictures that exist between pictures of reference sources and are to be referenced is not required to be a power of 2 as illustrated in FIG. 25, and, for example, such a GOP structure as illustrated in FIG. 26 may be also adopted.

In addition, while, in the description above, the control of whether or not the temporal prediction is available in the prediction of the motion vector (temporal motion vector prediction) has been described as an example, it is possible to apply the present technology to the prediction of an arbitrary parameter.

For example, while, in a document, “CE4 Subtest 2: QP prediction based on intra/inter prediction (test 2.4b)”, JCTVC-F103 July, 2011, a method has been proposed where the prediction value of a quantization parameter QP is generated in a temporal axis direction using motion vector information, it is possible to apply the present technology to prediction processing for every parameter, which utilizes the prediction in the temporal axis direction in this way. For example, it is possible to apply to the encoding parameter of the CABAC.

[Motion Vector Encoding Unit and Temporal Prediction Control Unit]

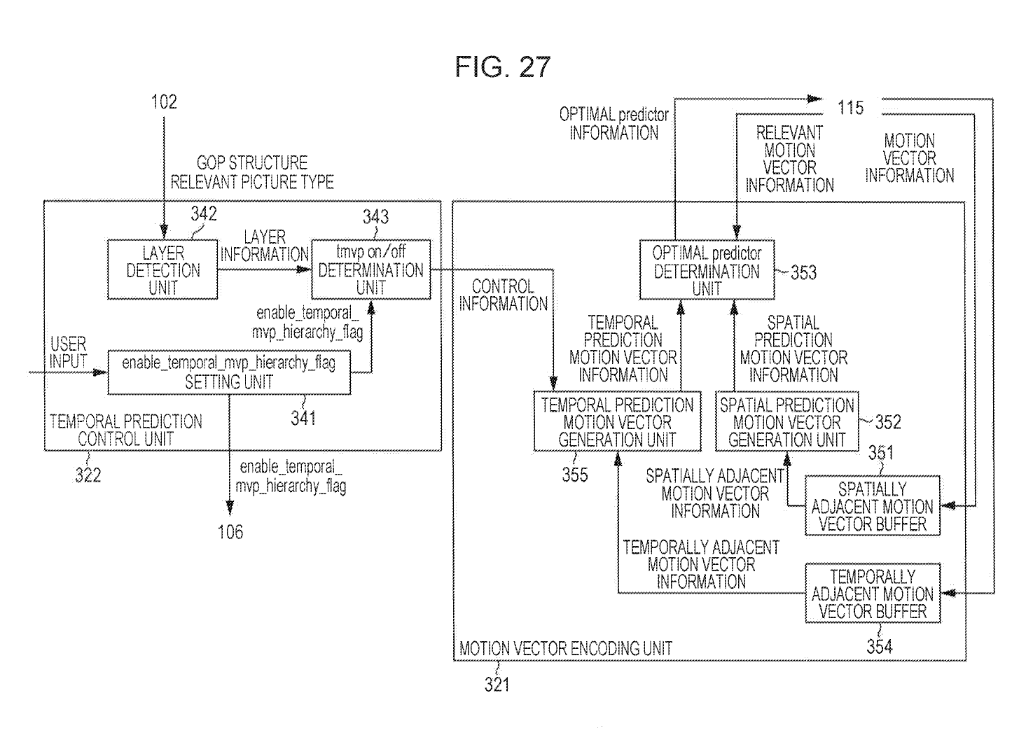

FIG. 27 is a block diagram illustrating examples of the main configurations of the temporal prediction control unit 322 and the motion vector encoding unit 321 in FIG. 19.

As illustrated in FIG. 27, the temporal prediction control unit 322 includes an enable_temporal_mvp_hierarchy_flag setting unit 341, a layer detection unit 342, and a tmvp on/off determination unit 343.

On the basis of an instruction from outside, such as a user input, the enable_temporal_mvp_hierarchy_flag setting unit 341 determines the value of the enable_temporal_mvp_hierarchy_flag serving as information indicating a pattern of whether or not the temporal prediction is to be used as one of prediction methods for a parameter. In other words, a pattern of whether or not the temporal prediction is to be used is determined with a pattern of whether or not the temporal prediction is available as one of prediction methods for a parameter. This processing is performed before the prediction of a parameter (for example, a motion vector) is performed. The enable_temporal_mvp_hierarchy_flag setting unit 341 supplies the determined enable_temporal_mvp_hierarchy_flag to the tmvp on/off determination unit 343. In addition, the enable_temporal_mvp_hierarchy_flag setting unit 341 also supplies the enable_temporal_mvp_hierarchy_flag serving as the information indicating a pattern of whether or not the temporal prediction is to be used, to the lossless encoding unit 106, and causes to be encoded. (For example, causes to be included in the SPS, or the like, and causes to be transmitted to a decoding side).

The layer detection unit 342 acquires pieces of information such as a GOP structure supplied from the screen rearrangement buffer 102 and the picture type of a current picture serving as a processing target (a relevant picture type), and detects the layer of the current picture on the basis of these pieces of information. The layer detection unit 342 supplies, to the tmvp on/off determination unit 343, layer information indicating the detected layer of the current picture.

On the basis of the enable_temporal_mvp_hierarchy_flag supplied from the enable_temporal_mvp_hierarchy_flag setting unit 341 and the layer information supplied from the layer detection unit 342, the tmvp on/off determination unit 343 determines whether or not the temporal prediction is to be available in the current picture. In other words, the tmvp on/off determination unit 343 determines whether or not the temporal prediction has been made available for the layer of the current picture, in the setting of the enable_temporal_mvp_hierarchy_flag. In accordance with the determination (in other words, in accordance with the setting), the tmvp on/off determination unit 343 determines whether or not the temporal prediction is to be available in the current picture, and supplies, to the motion vector encoding unit 321 (a temporal prediction motion vector generation unit 355), a control signal for realization to the effect.

The motion vector encoding unit 321 includes a spatially adjacent motion vector buffer 351, a spatial prediction motion vector generation unit 352, an optimal predictor determination unit 353, a temporally adjacent motion vector buffer 354, and the temporal prediction motion vector generation unit 355.

The spatially adjacent motion vector buffer 351 acquires motion vector information supplied from the motion prediction/compensation unit 115, and stores therein as the motion vector of a spatially neighboring block spatially located on the periphery of the current block. In other words, the spatially adjacent motion vector buffer 351 arbitrarily discards the motion vector of a block having become spatially located out of the periphery of the current block. On the basis of a request, the spatially adjacent motion vector buffer 351 supplies a motion vector stored therein to the spatial prediction motion vector generation unit 352, as the motion vector (spatially adjacent motion vector information) of the spatially neighboring block.

The spatial prediction motion vector generation unit 352 requests, from the spatially adjacent motion vector buffer 351, spatially adjacent motion vector information with respect to the current block, and predicts the motion vector of the current block (generates spatial prediction motion vector information) using the spatially adjacent motion vector information obtained with respect to the request. The spatial prediction motion vector generation unit 352 supplies the generated spatial prediction motion vector information to the optimal predictor determination unit 353.

The temporally adjacent motion vector buffer 354 acquires the motion vector information supplied from the motion prediction/compensation unit 115, and stores therein as the motion vector of a temporally neighboring block temporally located on the periphery of the current block. In other words, the temporally adjacent motion vector buffer 354 arbitrarily discards the motion vector of a block having become temporally located out of the periphery of the current block. On the basis of a request, the temporally adjacent motion vector buffer 354 supplies, to the temporal prediction motion vector generation unit 355, a motion vector stored therein as the motion vector (temporally adjacent motion vector information) of the temporally neighboring block.

In a case where the temporal prediction has been made available in the current picture serving as the processing target by a control signal supplied from the tmvp on/off determination unit 343, the temporal prediction motion vector generation unit 355 request, from the temporally adjacent motion vector buffer 354, temporally adjacent motion vector information with respect to the current block, and predicts the motion vector of the current block (generates temporal prediction motion vector information) using the temporally adjacent motion vector information obtained with respect to the request. The temporal prediction motion vector generation unit 355 supplies the generated temporal prediction motion vector information to the optimal predictor determination unit 353.

In addition, in a case where the temporal prediction has been made unavailable in the current picture by the control signal supplied from the tmvp on/off determination unit 343, the temporal prediction motion vector generation unit 355 does not predict the motion vector of the current block.

The motion vector information of the current block (relevant motion vector information) is further supplied from the motion prediction/compensation unit 115 to the optimal predictor determination unit 353.

In a case where the temporal prediction has been made available in the current picture, the optimal predictor determination unit 353 defines, as candidates, the spatial prediction motion vector information supplied from the spatial prediction motion vector generation unit 352 and the temporal prediction motion vector information supplied from the temporal prediction motion vector generation unit 355, obtains the cost function values thereof using the motion vector information of the current block, and determines an optimal predictor with respect to the current block from among candidates on the basis of the cost function values.

In addition, in a case where the temporal prediction has been made unavailable in the current picture, the optimal predictor determination unit 353 defines, as a candidate, the spatial prediction motion vector information supplied from the spatial prediction motion vector generation unit 352, obtains a cost function value using the motion vector information of the current block, and determines an optimal predictor with respect to the current block from among candidates on the basis of the cost function value.

The optimal predictor determination unit 353 supplies, to the motion prediction/compensation unit 115, optimal predictor information indicating the optimal predictor determined as above. Using the optimal predictor information, the motion prediction/compensation unit 115 determines the prediction mode of the motion vector of the current block.

By performing the prediction of the motion vector of the current block in this way, it is possible for the image encoding device 300 to greatly reduce the information of amount (the amount of code) used for controlling whether or not the predictive in the temporal direction is available.

[Flow of Processing]

In such an image encoding device 300, encoding processing is performed in the same way as in the case described with reference to the flowchart in FIG. 13.

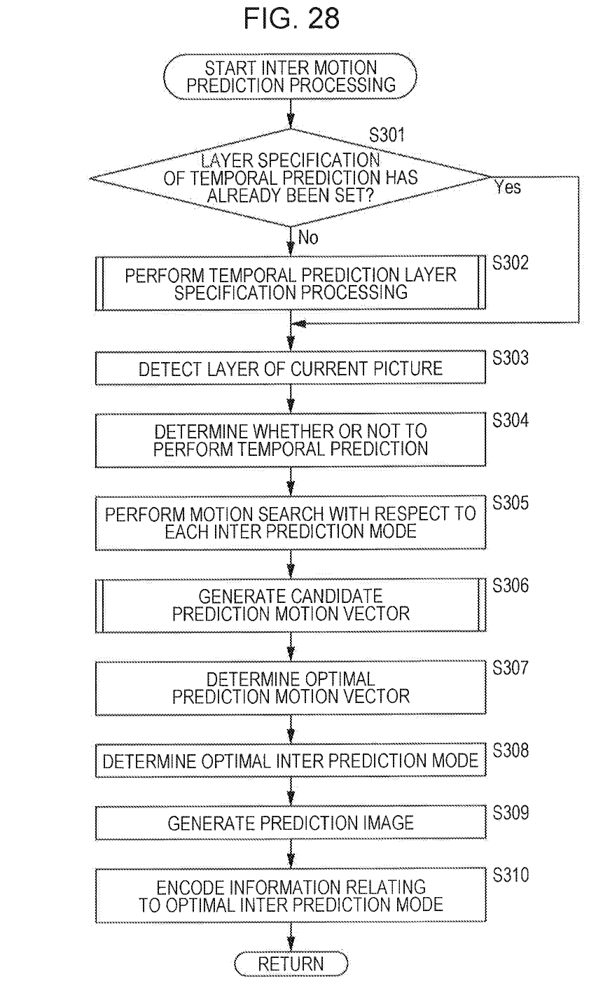

In this regard, however, inter motion prediction processing is executed in such a way as a flowchart in FIG. 28. With reference to the flowchart in FIG. 28, an example of the flow of the inter motion prediction processing will be described.

When the inter motion prediction processing has been started, in step S301 the enable_temporal_mvp_hierarchy_flag setting unit 341 determines whether or not the pattern of whether or not the temporal prediction is available (for example, layer specification) has already been set. In a case of being determined not to have been set yet, the processing proceeds to step S302.

In step S302, the enable_temporal_mvp_hierarchy_flag setting unit 341 executes temporal prediction layer specification processing for setting the pattern of whether or not the temporal prediction is available. When the pattern of whether or not the temporal prediction is available has been set, the processing proceeds to step S303.

In addition, in a case where, in step S301, it has been determined that the pattern of whether or not the temporal prediction is available has already been set, the process in step S302 is skipped, and the processing proceeds to step S303.

In step S303, the layer detection unit 342 detects the layer of the current picture on the basis of information supplied from the screen rearrangement buffer 102.

In step S304, on the basis of the patter of whether or not the temporal prediction is available, the pattern being set by the process in step S302, and the layer of the current picture, detected in step S303, the tmvp on/off determination unit 343 determines whether or not the temporal prediction is to be performed in the current picture.

In addition, the processes in step S303 and step S304 are required to be performed only once for I picture, and may be skipped if it has already been determined whether or not the temporal prediction is to be performed in the current picture.

In step S305, the motion prediction/compensation unit 115 makes a motion search with respect to each inter prediction mode.

In step S306, the spatial prediction motion vector generation unit 352, or the spatial prediction motion vector generation unit 352 and the temporal prediction motion vector generation unit 355 execute candidate prediction motion vector generation processing, and generate a candidate prediction motion vector.

In step S307, the optimal predictor determination unit 353 determines an optimal prediction motion vector from among candidate prediction motion vectors obtained by the process in step S306.

In step S308, using the optimal prediction motion vector generated in step S307, the motion prediction/compensation unit 115 determines an optimal inter prediction mode.

In step S309, the motion prediction/compensation unit 115 generates the prediction image of the optimal inter prediction mode determined in step S308. The generated prediction image is used in processing subsequent to step S105 in FIG. 13.

In step S310, in a case where the inter prediction has been selected as a prediction mode, the motion prediction/compensation unit 115 supplies, to the lossless encoding unit 106, information relating to the optimal inter prediction mode determined in step S308, and causes the information to be encoded.

When the process in step S310 has finished, the inter motion prediction processing finishes, and the processing returns to FIG. 13.

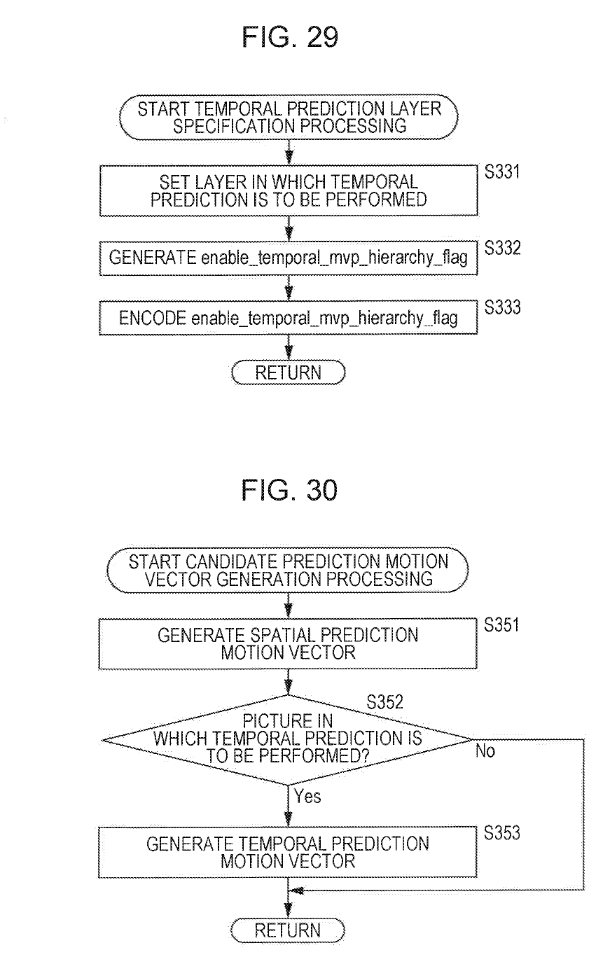

Next, with reference to a flowchart in FIG. 29, an example of the flow of the temporal prediction layer specification processing executed in step S302 in FIG. 28 will be described.

When the temporal prediction layer specification processing has been started, in step S331 the enable_temporal_mvp_hierarchy_flag setting unit 341 sets a pattern (layer) in which the temporal prediction is to be performed, on the basis of a user instruction or the like.

In step S332, the enable_temporal_mvp_hierarchy_flag setting unit 341 generates the enable_temporal_mvp_hierarchy_flag on the basis of that setting.

In step S333, the enable_temporal_mvp_hierarchy_flag setting unit 341 supplies, to the lossless encoding unit 106, the enable_temporal_mvp_hierarchy_flag generated in step S332, and causes the enable_temporal_mvp_hierarchy_flag to be encoded (transmitted to a decoding side).

When the process in step S333 has finished, the temporal prediction layer specification processing finishes, and the processing returns to FIG. 28.

Next, with reference to a flowchart in FIG. 30, an example of the flow of the candidate prediction motion vector generation processing executed in step S306 in FIG. 28 will be described.

When the candidate prediction motion vector generation processing has been started, in step S351 the spatial prediction motion vector generation unit 352 acquires, from the spatially adjacent motion vector buffer 351, spatially adjacent motion vector information corresponding to the current block, performs prediction in the spatial direction (spatial prediction) using the spatially adjacent motion vector information, and generates a spatial prediction motion vector. The generated spatial prediction motion vector is used in step S307 in FIG. 28.

In step S352, in accordance with the determination in step S304 in FIG. 28, the temporal prediction motion vector generation unit 355 determines whether or not the temporal prediction has been permitted in the current picture. In a case of being determined to be a picture in which the temporal prediction is to be performed, the processing proceeds to step S353.

In step S353, the temporal prediction motion vector generation unit 355 acquires, from the temporally adjacent motion vector buffer 354, temporally adjacent motion vector information corresponding to the current block, performs prediction in the temporal direction (temporal prediction) using the temporally adjacent motion vector information, and generates a temporal prediction motion vector. The generated temporal prediction motion vector is used in step S307 in FIG. 28.

When the process in step S353 has finished, the candidate prediction motion vector generation processing finishes, and the processing returns to FIG. 28. In addition, also in a case where, in step S352, it has been determined that the current picture is not a picture in which the temporal prediction is to be performed, the candidate prediction motion vector generation processing finishes, and the processing returns to FIG. 28.

As described above, by executing the individual processes, it is possible for the image encoding device 300 to realize a trade-off (trade-off) between an encoding efficiency and memory access in the image compression information to be an output, with suppressing an increase in the amount of information required for an on/off_flag.

### 4. Fourth Embodiment

### Image Decoding Device

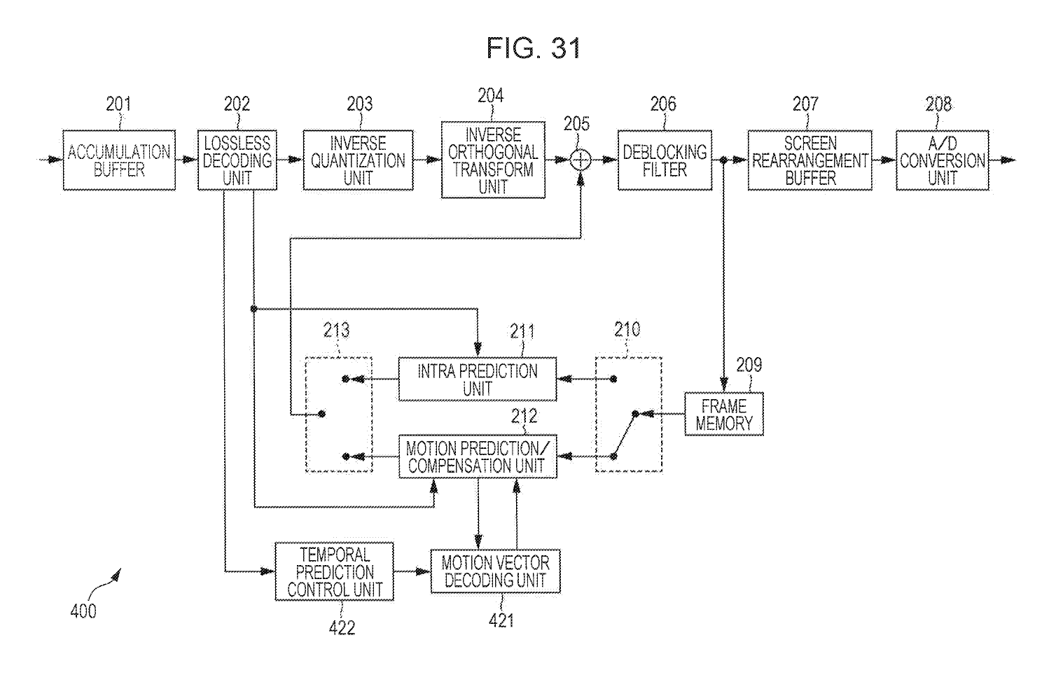

Next, the decoding of the encoded data (encoded stream) encoded as above will be described. FIG. 31 is a block diagram illustrating an example of the main configuration of an image decoding device corresponding to the image encoding device 300 in FIG. 19.

An image decoding device 400 illustrated in FIG. 31 decodes the encoded data generated by the image encoding device 300, using a decoding method corresponding to the encoding method thereof. In addition, it is assumed that, in the same way as the image encoding device 300, the image decoding device 400 performs inter prediction with respect to each prediction unit (PU).

The image decoding device 400 illustrated in FIG. 31 is basically the same as the image decoding device 200 in the FIG. 15, has the same configuration, and performs the same processing. In this regard, however, the image decoding device 400 includes a motion vector decoding unit 221 in place of the motion vector decoding unit 221 in the image decoding device 200, and includes a temporal prediction control unit 422 in place of the temporal prediction control unit 222 in the image decoding device 200.

Under control of the temporal prediction control unit 422, the motion vector decoding unit 421 predicts the motion vector of a current block used for generating a prediction image in the motion prediction/compensation unit 212. In other words, on the basis of information supplied from the image encoding device 300, the motion vector decoding unit 421 performs the prediction (for example, spatial prediction or temporal prediction) of a motion vector using the same prediction method as that performed in the image encoding device 300, generates the prediction motion vector information of the current block, and reconstructs the motion vector of the current block using the prediction motion vector information.

With respect to the current picture, the temporal prediction control unit 422 sets whether or not the temporal prediction is available in the motion vector decoding unit 421.

[Motion Vector Decoding Unit and Temporal Prediction Control Unit]

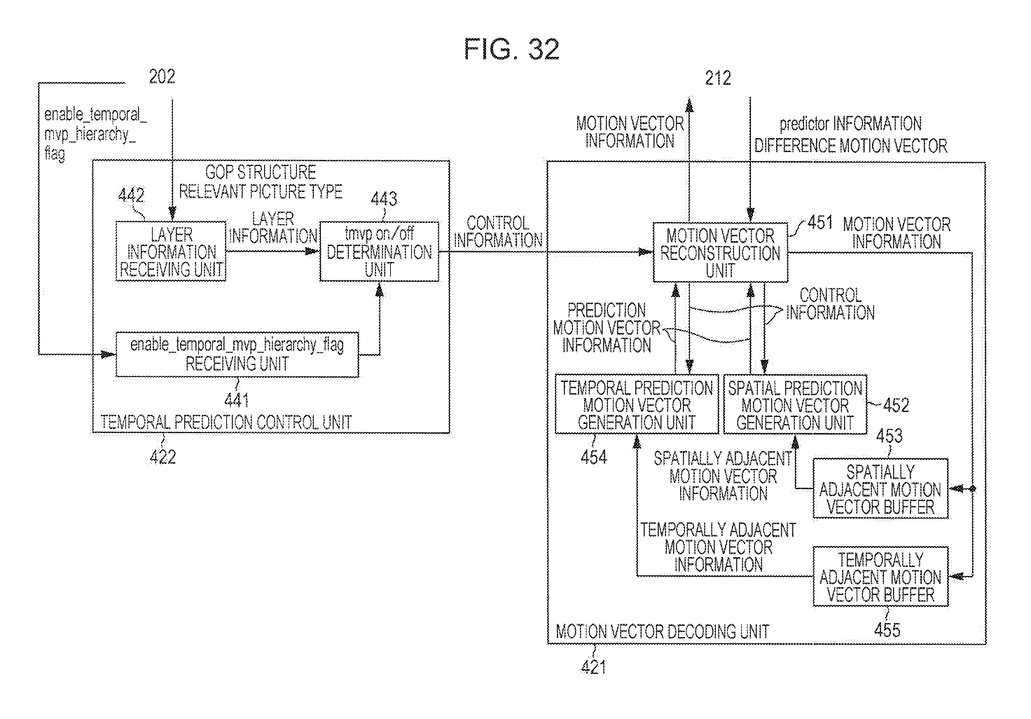

FIG. 32 is a block diagram illustrating examples of the main configurations of the temporal prediction control unit 422 and the motion vector decoding unit 421 in FIG. 31.

As illustrated in FIG. 32, the temporal prediction control unit 422 includes an enable_temporal_mvp_hierarchy_flag receiving unit 441, a layer information receiving unit 442, and a tmvp on/off determination unit 443.

The enable_temporal_mvp_hierarchy_flag receiving unit 441 acquires an enable_temporal_mvp_hierarchy_flag serving as information indicating a pattern of whether or not the temporal prediction is to be used as one of prediction methods for a parameter. This information is included in, for example, the SPS of a bit stream, and transmitted from the image encoding device 300 to the image decoding device 400. The lossless decoding unit 202 extracts the enable_temporal_mvp_hierarchy_flag thereof from, for example, the SPS, and supplies that to the enable_temporal_mvp_hierarchy_flag receiving unit 441.

On the basis of the value of the enable_temporal_mvp_hierarchy_flag acquired from the lossless decoding unit 202 in such a way, the enable_temporal_mvp_hierarchy_flag receiving unit 441 notifies the tmvp on/off determination unit 443 of the pattern of whether or not the temporal prediction is available.

The layer information receiving unit 442 acquires pieces of information such as a GOP structure supplied from the lossless decoding unit 202 and the picture type of a current picture serving as a processing target (a relevant picture type), and detects the layer of the current picture on the basis of these pieces of information. The layer information receiving unit 442 supplies, to the tmvp on/off determination unit 443, layer information indicating the detected layer of the current picture.

On the basis of the pattern of whether or not the temporal prediction is available, given notice of by the enable_temporal_mvp_hierarchy_flag setting unit 441, and the layer information supplied from the layer information receiving unit 442, the tmvp on/off determination unit 443 determines whether or not the temporal prediction is to be available in the current picture. In accordance with the determination, the tmvp on/off determination unit 443 supplies, to the motion vector decoding unit 421 (the temporal prediction motion vector generation unit 454), a control signal for controlling the motion vector decoding unit 421.

The motion vector decoding unit 421 includes a motion vector reconstruction unit 451, a spatial prediction motion vector generation unit 452, a spatially adjacent motion vector buffer 453, a temporal prediction motion vector generation unit 454, and a temporally adjacent motion vector buffer 455.

The motion vector reconstruction unit 451 acquires predictor information and a difference motion vector supplied from the motion prediction/compensation unit 212. These pieces of information are supplied from the image encoding device 300 with being included in a bit stream. The motion prediction/compensation unit 212 acquires this information from the lossless decoding unit 202, and supplies this information to the motion vector reconstruction unit 451.

In a case where the predictor information indicating a prediction method applied in the image encoding device 300 indicates the spatial prediction, the motion vector reconstruction unit 451 supplies a control signal to the spatial prediction motion vector generation unit 452, and causes a spatial prediction motion vector to be generated.

In addition, in a case where a prediction method indicated by the predictor information is the temporal prediction and the temporal prediction of the current picture is permitted by the control signal supplied from the tmvp on/off determination unit 443, the motion vector reconstruction unit 451 supplies a control signal to the temporal prediction motion vector generation unit 454, and causes a temporal prediction motion vector to be generated.

The motion vector reconstruction unit 451 acquires a prediction motion vector (a spatial prediction motion vector or a temporal prediction motion vector) supplied from the spatial prediction motion vector generation unit 452 or the temporal prediction motion vector generation unit 454, adds the prediction motion vector to the difference motion vector, and reconstructs the motion vector information of the current block. The motion vector reconstruction unit 451 supplies the reconstructed motion vector information to the motion prediction/compensation unit 212.

In addition, the motion vector reconstruction unit 451 supplies the reconstructed motion vector information to the spatially adjacent motion vector buffer 453 and the temporally adjacent motion vector buffer 455, and causes the reconstructed motion vector information to be stored therein.

The spatial prediction motion vector generation unit 452 is controlled by the motion vector reconstruction unit 451, and generates a spatial prediction motion vector. The spatial prediction motion vector generation unit 452 requests and acquires, from the spatially adjacent motion vector buffer 453, the motion vector (spatially adjacent motion vector information) of an spatially adjacent block corresponding to the current block. Using the spatially adjacent motion vector information, the spatial prediction motion vector generation unit 452 predicts the motion vector of the current block. The spatial prediction motion vector generation unit 452 supplies the generated spatial prediction motion vector to the motion vector reconstruction unit 451.

It is possible for the spatial prediction motion vector generation unit 452 to perform the same spatial prediction as the spatial prediction of the spatial prediction motion vector generation unit 352 in FIG. 27. Therefore, by adding the spatial prediction motion vector to the difference motion vector, it is possible for the motion vector reconstruction unit 451 to correctly reconstruct the motion vector of the current block.

The spatially adjacent motion vector buffer 453 acquires the motion vector information supplied from the motion vector reconstruction unit 451, and stores therein as the motion vector of a spatially neighboring block spatially located on the periphery of the current block. In other words, the spatially adjacent motion vector buffer 453 arbitrarily discards the motion vector of a block having become spatially located out of the periphery of the current block. On the basis of a request, the spatially adjacent motion vector buffer 453 supplies, to the spatial prediction motion vector generation unit 452, a motion vector stored therein, as the motion vector (spatially adjacent motion vector information) of the spatially neighboring block.

The temporal prediction motion vector generation unit 454 is controlled by the motion vector reconstruction unit 451, and generates a temporal prediction motion vector. The temporal prediction motion vector generation unit 454 requests and acquires, from the temporally adjacent motion vector buffer 455, the motion vector (temporally adjacent motion vector information) of a temporally adjacent block corresponding to the current block. Using the temporally adjacent motion vector information, the temporal prediction motion vector generation unit 454 predicts the motion vector of the current block. The temporal prediction motion vector generation unit 454 supplies the generated spatial prediction motion vector to the motion vector reconstruction unit 451.

The temporally adjacent motion vector buffer 455 acquires the motion vector information supplied from the motion vector reconstruction unit 451, and stores therein as the motion vector of a temporally neighboring block temporally located on the periphery of the current block. In other words, the temporally adjacent motion vector buffer 455 arbitrarily discards the motion vector of a block having become temporally located out of the periphery of the current block. On the basis of a request, the temporally adjacent motion vector buffer 455 supplies, to the temporal prediction motion vector generation unit 454, a motion vector stored therein, as the motion vector (temporally adjacent motion vector information) of the temporally neighboring block.

By performing the prediction of the motion vector of the current block in this way, it is possible for the image decoding device 400 to cause the reduction of the information of amount (the amount of code) to be realized, the information of amount (the amount of code) being used for controlling whether or not the predictive in the temporal direction is available.

[Flow of Processing]

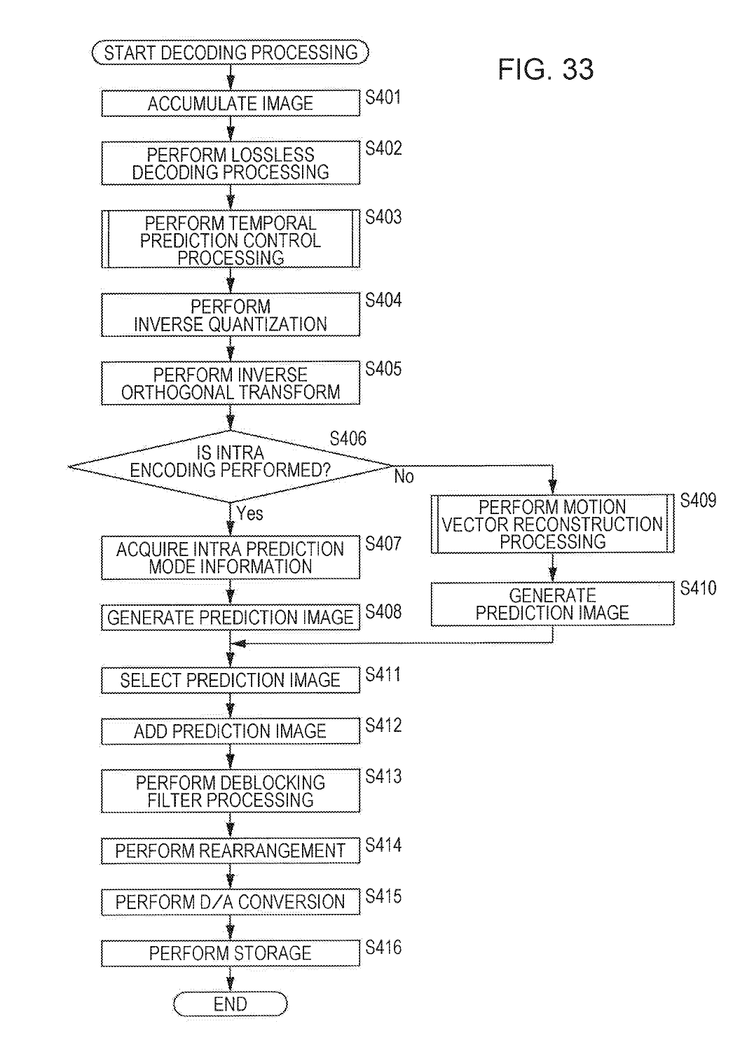

Next, the flow of individual processes executed by such an image decoding device 200 as above will be described. First, with reference to a flowchart in FIG. 33, an example of the flow of decoding processing will be described.

When the decoding processing has been started, individual processes in step S401 and step S402 are executed in the same way as the individual processes in step S201 and step S202 in FIG. 17.

In step S403, the temporal prediction control unit 422 performs temporal prediction control processing.

Individual processes in step S404 to step S416 are executed in the same way as the individual processes in step S203 to step S215 in FIG. 17.

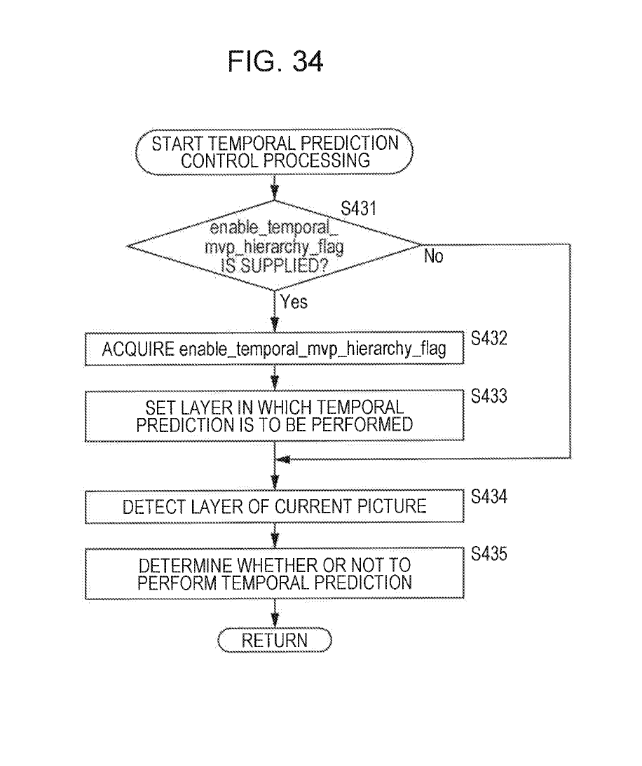

Next, with reference to a flowchart in FIG. 34, an example of the flow of the temporal prediction control processing executed in step S403 in FIG. 33 will be described.

When the temporal prediction control processing has been started, in step S431 the enable_temporal_mvp_hierarchy_flag setting unit 441 determines whether or not the enable_temporal_mvp_hierarchy_flag has been supplied. In a case of being determined to have been supplied, the processing is caused to proceed to step S432.

In step S432, the enable_temporal_mvp_hierarchy_flag setting unit 341 acquires the enable_temporal_mvp_hierarchy_flag supplied from the lossless decoding unit 202.

In step S433, using the enable_temporal_mvp_hierarchy_flag acquired in step S432, the enable_temporal_mvp_hierarchy_flag setting unit 441 sets a layer in which the temporal prediction is to be performed. When the setting has been completed, the processing proceeds to step S434. In addition, in a case where, in step S431, it has been determined that the enable_temporal_mvp_hierarchy_flag has not been supplied, the processing proceeds to step S434.

In step S434, on the basis of the information supplied from the lossless decoding unit 202, the layer information receiving unit 442 detects the layer of the current picture.

In step S435, the tmvp on/off determination unit 443 determines whether or not the temporal prediction is to be performed in the current picture, and supplies a control signal for controlling, to the motion vector reconstruction unit 451 in accordance with the determination.

When the process in step S435 has finished, the temporal prediction control processing finishes, and the processing returns to FIG. 33.

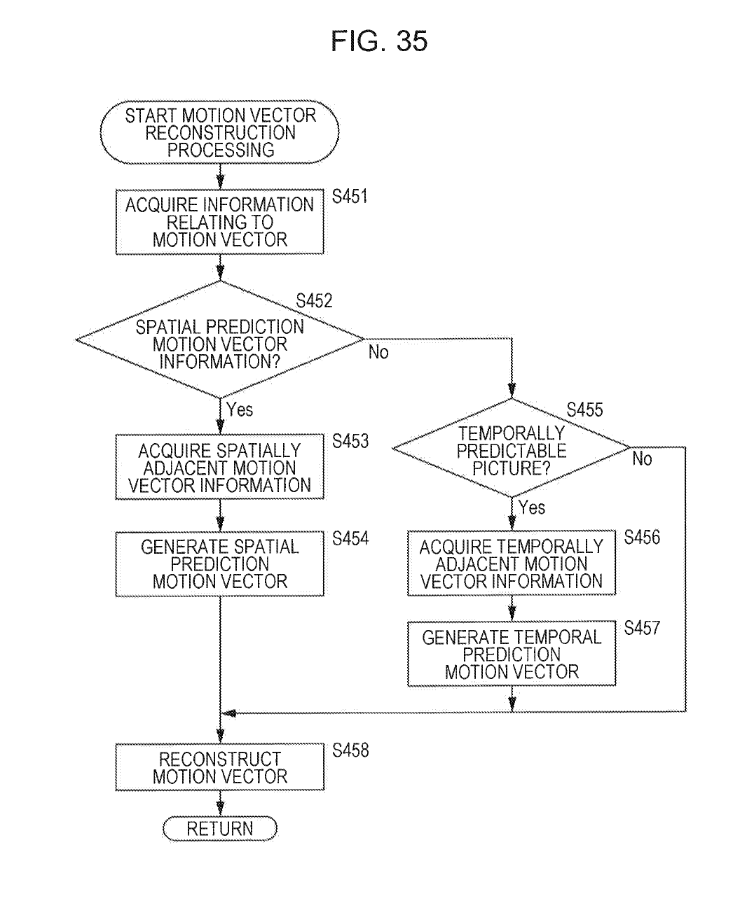

Next, with reference to a flowchart in FIG. 35, an example of the flow of the motion vector reconstruction processing executed in step S409 in FIG. 33 will be described.

When the motion vector reconstruction processing has been started, in step S451 the motion vector reconstruction unit 451 acquires information relating to a motion vector.

In step S452, the motion vector reconstruction unit 451 determines whether or not a prediction method indicated by the predictor information is the spatial prediction. In a case of being determined to be the spatial prediction, the processing proceeds to step S453.

In step S453, the spatial prediction motion vector generation unit 452 acquires spatially adjacent motion vector information from the spatially adjacent motion vector buffer 453.

In step S454, using the spatially adjacent motion vector information acquired in step S453, the spatial prediction motion vector generation unit 452 spatially predicts the motion vector of the current block, and generates a spatial prediction motion vector. When the process in step S454 has finished, the processing proceeds to step S458.

In addition, in a case where, in step S452, it has been determined that the prediction method indicated by the predictor information is the temporal prediction and the temporal prediction has been permitted in the current picture, the processing proceeds to step S455.

In step S456, the temporal prediction motion vector generation unit 454 acquires temporally adjacent motion vector information from the temporally adjacent motion vector buffer 455.

In step S457, using the temporally adjacent motion vector information acquired in step S456, the temporal prediction motion vector generation unit 454 temporally predicts the motion vector of the current block, and generates a temporal prediction motion vector. When the process in step S457 has finished, the processing proceeds to step S458.

In step S458, the motion vector reconstruction unit 451 adds, to the difference motion vector, the spatial prediction motion vector generated in step S454 or the temporal prediction motion vector generated in step S457, and reconstructs the motion vector of the current block. This motion vector is used in step S410 or the like in FIG. 33.

In addition, the motion vector reconstruction unit 451 supplies the reconstructed motion vector of the current block to the spatially adjacent motion vector buffer 453 and the temporally adjacent motion vector buffer 455, and causes the reconstructed motion vector of the current block to be stored therein.

When the process in step S458 has finished, the motion vector reconstruction processing finishes, and the processing returns to FIG. 33.

As described above, by executing the individual processes, it is possible for the image decoding device 400 to realize a trade-off (trade-off) between an encoding efficiency and memory access in the image compression information to be an output, with suppressing an increase in the amount of information required for an on/off_flag.

In addition, while, in the above description, a case based on the HEVC has been described as an example, it is also possible to apply the present technology to a device utilizing another encoding method if the device performs encoding processing and decoding processing for motion vector information based on the MV competition or the merge mode.

In addition, the present technology may be applied to image encoding devices and image decoding devices used when receiving image information (bit stream) compressed by an orthogonal transform, such as a discrete cosine transform, and motion compensation, in such a way as in MPEG, H.26×, or the like, via a network medium, such as satellite broadcast, cable TV, the Internet, or a mobile phone. In addition, the present technology may be applied to image encoding devices and image decoding devices used when processing is performed on storage media such as optical and magnetic discs and a flash memory. Furthermore, the present technology may also be applied to motion prediction/compensation devices included in these image encoding devices and image decoding devices.

### 5. Fifth Embodiment

### Syntax

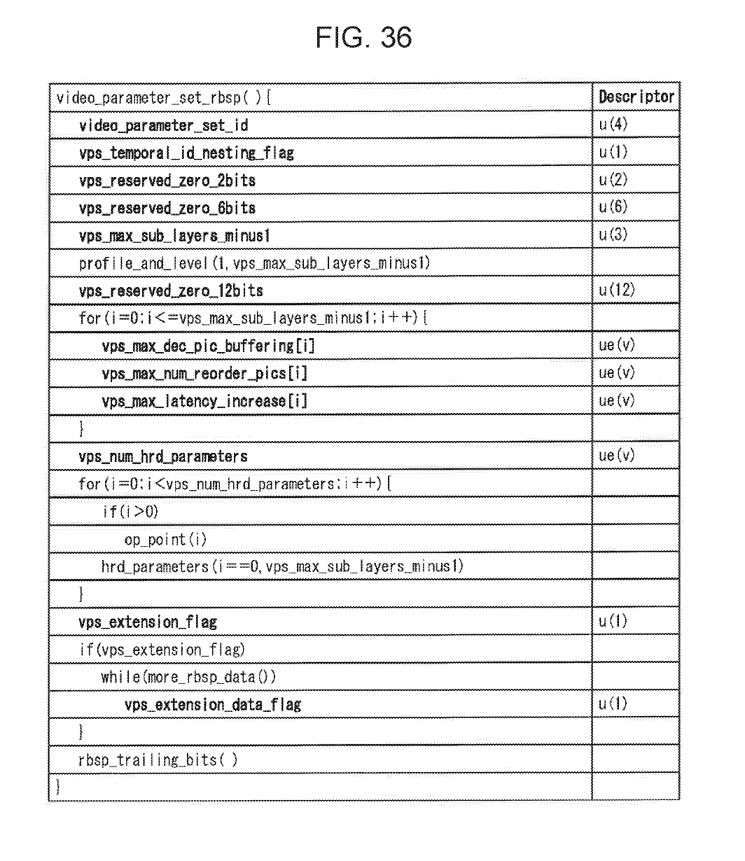

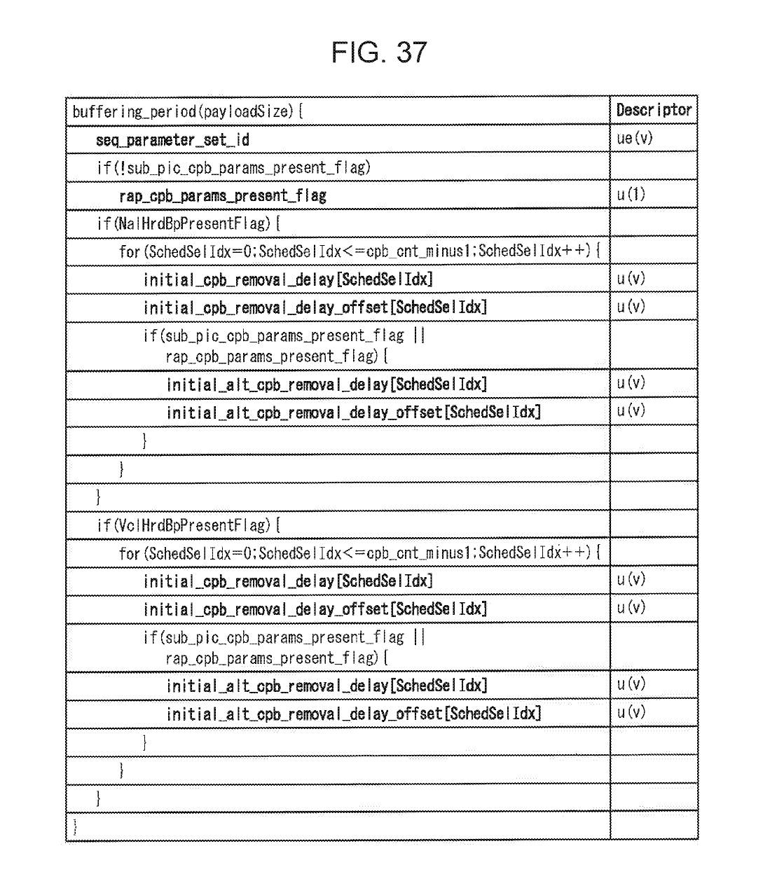

Incidentally, in a document, Ye-Kui Wang, Miska M. Hannuksela, “HRD parameters in VPS”, JCTVC-J0562, Joint Collaborative Team on Video Coding (JCT-VC) of ITU-T SG 16 WP 3 and ISO/IEC JTC 1/SC 29/WG 1110th Meeting: Stockholm, SE, 11-20 Jul. 2012, an example of the syntax of a video parameter set (VPS (Video Parameter Set)) and an example of the syntax of a buffering period SEI (buffering period SEI (Supplemental Enhancement Information)) are illustrated. FIG. 36 is a diagram illustrating an example of the syntax of the video parameter set (VPS). FIG. 37 is a diagram illustrating an example of the syntax of the buffering period SEI.

As illustrated in FIG. 36, in the syntax described in the above-mentioned document (JCTVC-J0562), an HRD parameter (HRD (Hypothetical Reference Decoder) parameter) is not transmitted in the sequence parameter set (SPS (Sequence Parameter Set)), and is transmitted in the video parameter set (VPS).

However, as indicated in the second line from the top in FIG. 37, since the buffering period SEI is associated with the sequence parameter set (SPS) (seq_parameter_set_id), there has been a possibility that the consistency of processing is not ensured in syntax (parsing processing).

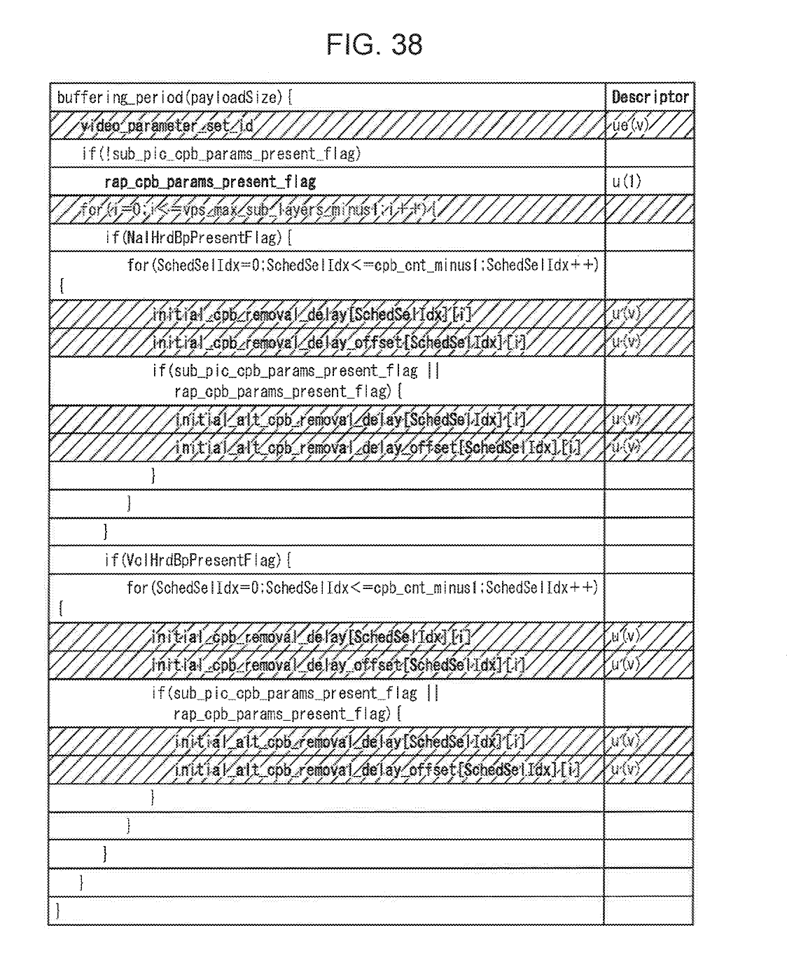

Therefore, the syntax of the buffering period SEI may be modified in such a way as illustrated in FIG. 38, and the buffering period SEI may also be associated with the video parameter set (VPS).

### 6. Sixth Embodiment

### Application to Multi-Image Point Coding/Multi-View Image Decoding

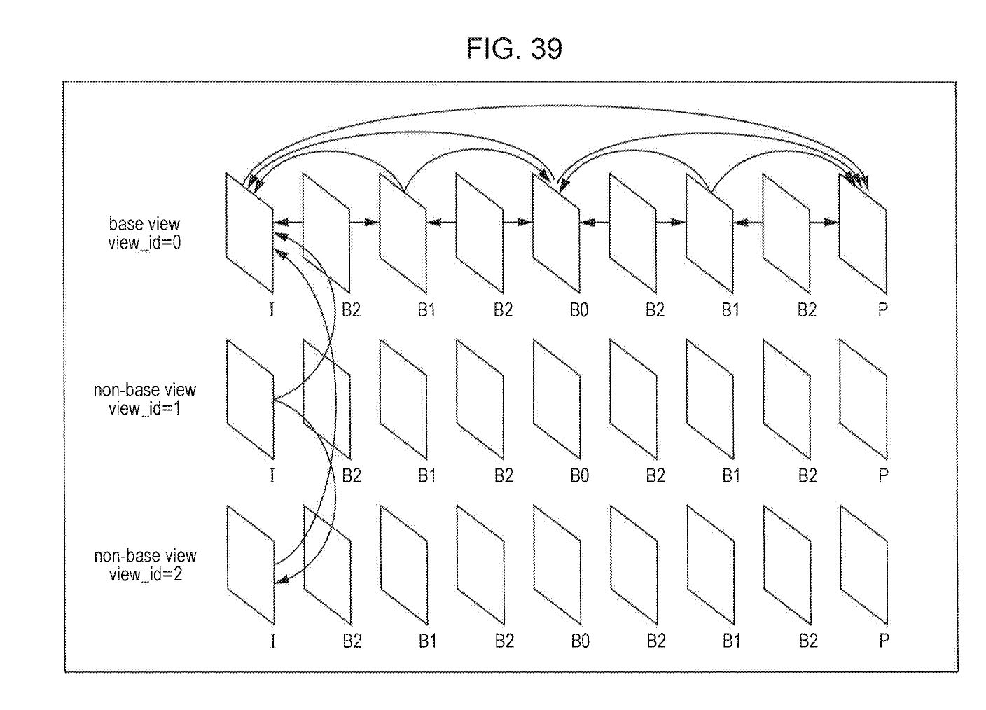

The above-mentioned series of processes may be applied to multi-view image coding/multi-view image decoding. FIG. 39 illustrates an example of a multi-view image coding method.

As illustrated in FIG. 39, a multi-view image includes images from a plurality of viewpoints and an image from a predetermined viewpoint out of the plural viewpoints is specified as a base view image. An image from each viewpoint other than the base view image is treated as a non-base view image.

In a case where such a multi-view image as in FIG. 39 is encoded/decoded, individual view images are encoded/decoded. However, the methods described above in the first embodiment to the fourth embodiment may also be applied to the encoding/decoding of the individual views. By doing in this way, it is possible to realize the reduction of the amount of memory access and the amount of computation with suppressing image deterioration.

Furthermore, in the encoding/decoding of the individual views, flags or parameters may also be shared that are used in the methods described above in the first embodiment to the fourth embodiment.

More specifically, for example, a flag (the L0_temp_prediction_flag or the L1_temp_prediction_flag) may also be shared in the encoding/decoding of individual views, the flag being described in the first embodiment or the second embodiment and indicating whether or not the temporal prediction motion vector is to be used in each of the prediction directions of the List0 and the List1. In addition, for example, a flag (the AMVP_L0_temp_prediction_flag or the merge_temp_prediction_flag) may also be shared in the encoding/decoding of individual views, the flag being described in the first embodiment or the second embodiment and indicating whether or not the temporal prediction motion vector with respect to each of the AMVP and the merge mode is to be used.

Furthermore, for example, information (the enable_temporal_mvp_hierarchy_flag) indicating the pattern of whether or not the temporal prediction is to be used or another piece of relevant information (for example, the max_temporal_layers_minus1 or the temporal_id_nesting_flag), described in the third embodiment or the fourth embodiment, may also be shared in the encoding/decoding of individual views.

Needless to say, necessary information other than these may also be shared in the encoding/decoding of individual views.

[Multi-View Image Coding Device]

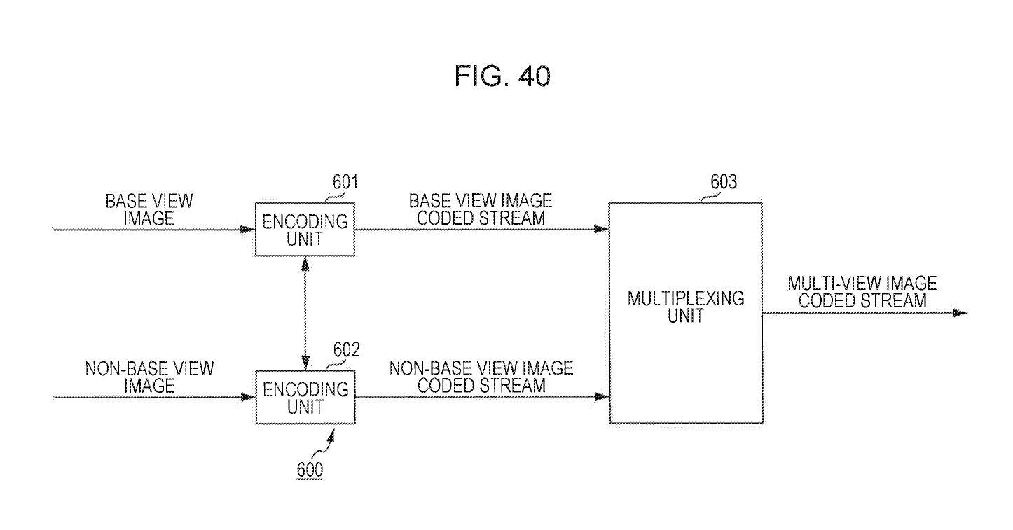

FIG. 40 is a diagram illustrating a multi-view image coding device performing the above-mentioned multi-view image coding. As illustrated in FIG. 40, a multi-view image coding device 600 includes an encoding unit 601, an encoding unit 602, and a multiplexing unit 603.

The encoding unit 601 encodes a base view image, and generates a base view image coded stream. The encoding unit 602 encodes a non-base view image, and generates a non-base view image coded stream. The multiplexing unit 603 multiplexes the base view image coded stream generated in the encoding unit 601 and the non-base view image coded stream generated in the encoding unit 602, and generates a multi-view image coded stream.

It is possible to apply the image encoding device 100 (FIG. 1) or the image encoding device 300 (FIG. 19) to the encoding unit 601 and the encoding unit 602 in the multi-view image coding device 600. As described above, using flags or parameters equal to each other, it is possible for the encoding unit 601 and the encoding unit 602 to perform the control of whether or not the temporal prediction is available in the prediction of the motion vector, or the like (in other words, the flag or the parameter may be shared).

[Multi-View Image Decoding Device]

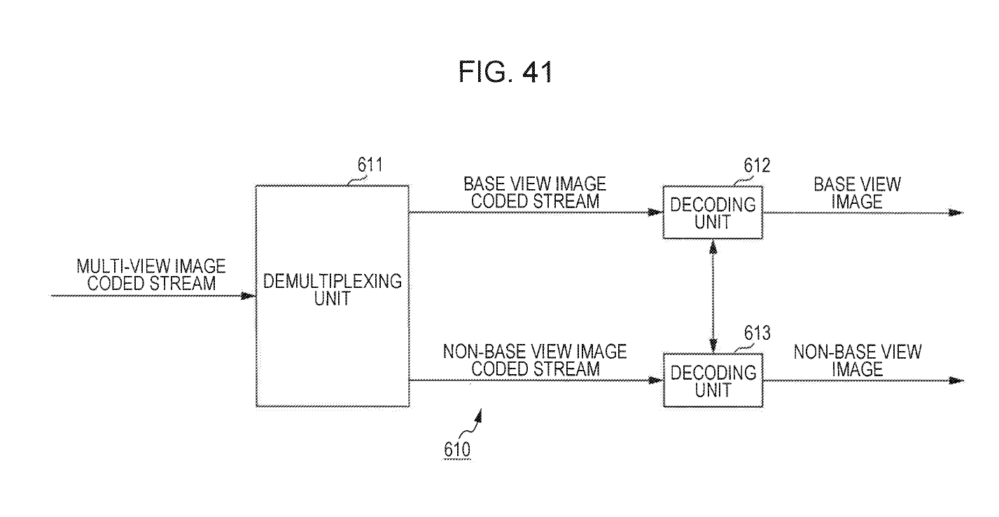

FIG. 41 is a diagram illustrating a multi-view image decoding device performing the above-mentioned multi-view image decoding. As illustrated in FIG. 41, a multi-view image decoding device 610 includes a demultiplexing unit 611, a decoding unit 612, and a decoding unit 613.

The demultiplexing unit 611 demultiplexes a multi-view image coded stream in which a base view image coded stream and a non-base view image coded stream are multiplexed, and extracts the base view image coded stream and the non-base view image coded stream. The decoding unit 612 decodes the base view image coded stream extracted by the demultiplexing unit 611, and obtains a base view image. The decoding unit 613 decodes the non-base view image coded stream extracted by the demultiplexing unit 611, and obtains a non-base view image.

It is possible to apply the image decoding device 200 (FIG. 15) or the image decoding device 400 (FIG. 31) to the decoding unit 612 and the decoding unit 613 in the multi-view image decoding device 610. As described above, using flags or parameters equal to each other, it is possible for the decoding unit 612 and the decoding unit 613 to perform the control of whether or not the temporal prediction is available in the prediction of the motion vector, or the like (in other words, the flag or the parameter may be shared).

### 7. Seventh Embodiment

### Application to Hierarchical Image Point Coding/Hierarchical Image Decoding

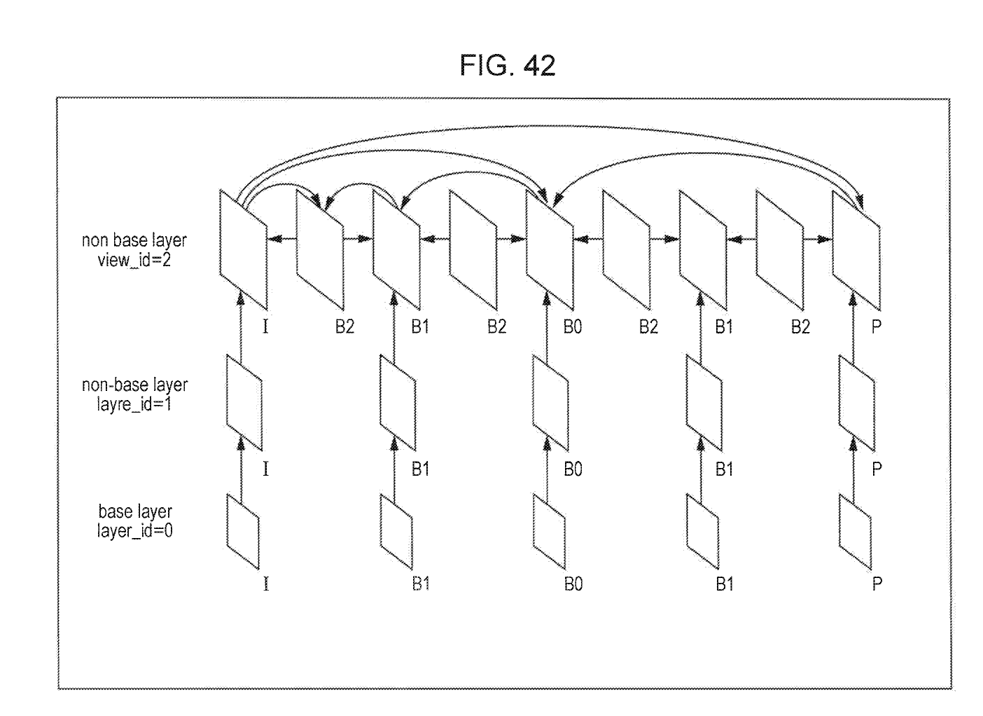

The above-mentioned series of processes may be applied to hierarchical image coding/hierarchical image decoding. FIG. 42 illustrates an example of a multi-view image coding method.

As illustrated in FIG. 42, a hierarchical image includes a plurality of layers (resolutions), and an image of a predetermined layer out of the plural resolutions is specified as a base layer image. An image of each layer other than the base layer image is treated as a non-base layer image.

In a case where such a hierarchical image as in FIG. 42 is encoded/decoded, images of individual layers are encoded/decoded. However, the methods described above in the first embodiment to the fourth embodiment may also be applied to the encoding/decoding of the individual layers. By doing in this way, it is possible to realize the reduction of the amount of memory access and the amount of computation with suppressing image deterioration.

Furthermore, in the encoding/decoding of the individual layers, flags or parameters may also be shared that are used in the methods described above in the first embodiment to the fourth embodiment.

More specifically, for example, a flag (the L0_temp_prediction_flag or the L1_temp_prediction_flag) may also be shared in the encoding/decoding of individual layers, the flag being described in the first embodiment or the second embodiment and indicating whether or not the temporal prediction motion vector is to be used in each of the prediction directions of the List0 and the List1. In addition, for example, a flag (the AMVP_L0_temp_prediction_flag or the merge_temp_prediction_flag) may also be shared in the encoding/decoding of individual layers, the flag being described in the first embodiment or the second embodiment and indicating whether or not the temporal prediction motion vector with respect to each of the AMVP and the merge mode is to be used.

Furthermore, for example, information (the enable_temporal_mvp_hierarchy_flag) indicating the pattern of whether or not the temporal prediction is to be used or another piece of relevant information (for example, the max_temporal_layers_minus1 or the temporal_id_nesting_flag), described in the third embodiment or the fourth embodiment, may also be shared in the encoding/decoding of individual layers.

Needless to say, necessary information other than these may also be shared in the encoding/decoding of individual layers.

[Hierarchical Image Coding Device]

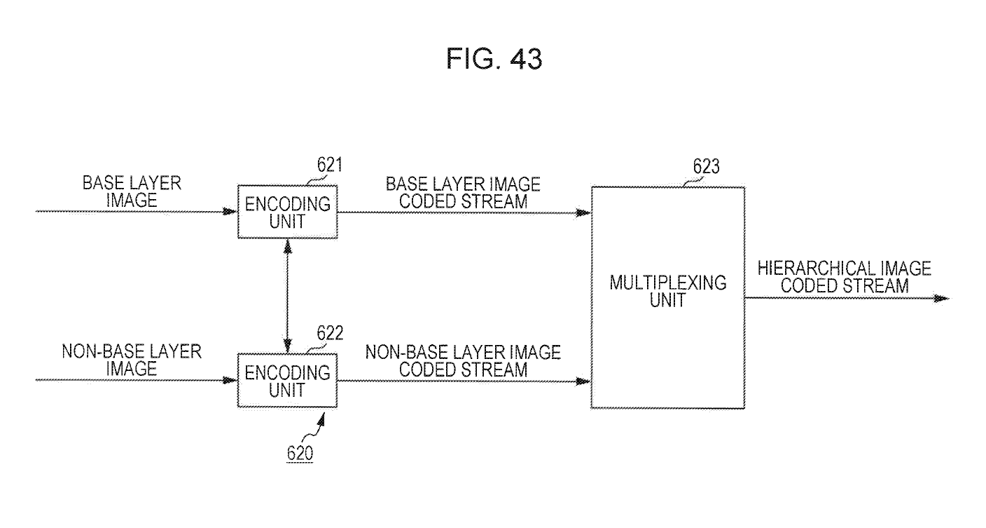

FIG. 43 is a diagram illustrating a hierarchical image coding device performing the above-mentioned hierarchical image coding. As illustrated in FIG. 43, the hierarchical image coding device 620 includes an encoding unit 621, an encoding unit 622, and a multiplexing unit 623.

The encoding unit 621 encodes a base layer image, and generates a base layer image coded stream. The encoding unit 622 encodes a non-base layer image, and generates a non-base layer image coded stream. The multiplexing unit 623 multiplexes the base layer image coded stream generated in the encoding unit 621 and the non-base layer image coded stream generated in the encoding unit 622, and generates a hierarchical image coded stream.

It is possible to apply the image encoding device 100 (FIG. 1) or the image encoding device 300 (FIG. 19) to the encoding unit 621 and the encoding unit 622 in the hierarchical image coding device 620. As described above, using flags or parameters equal to each other, it is possible for the encoding unit 621 and the encoding unit 622 to perform the control of whether or not the temporal prediction is available in the prediction of the motion vector, or the like (in other words, the flag or the parameter may be shared).

[Hierarchical Image Decoding Device]

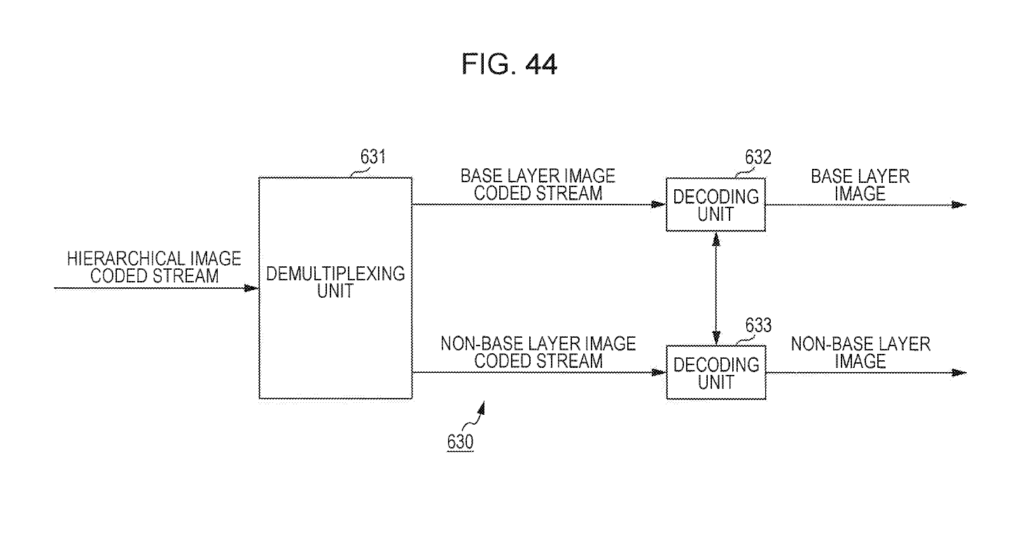

FIG. 44 is a diagram illustrating a hierarchical image decoding device performing the above-mentioned hierarchical image decoding. As illustrated in FIG. 44, the hierarchical image decoding device 630 includes a demultiplexing unit 631, a decoding unit 632, and a decoding unit 633.

The demultiplexing unit 631 demultiplexes a hierarchical image coded stream in which a base layer image coded stream and a non-base layer image coded stream are multiplexed, and extracts the base layer image coded stream and the non-base layer image coded stream. The decoding unit 632 decodes the base layer image coded stream extracted by the demultiplexing unit 631, and obtains a base layer image. The decoding unit 633 decodes the non-base layer image coded stream extracted by the demultiplexing unit 631, and obtains a non-base layer image.

It is possible to apply the image decoding device 200 (FIG. 15) or the image decoding device 400 (FIG. 31) to the decoding unit 632 and the decoding unit 633 in the hierarchical image decoding device 630. As described above, using flags or parameters equal to each other, it is possible for the decoding unit 632 and the decoding unit 633 to perform the control of whether or not the temporal prediction is available in the prediction of the motion vector, or the like (in other words, the flag or the parameter may be shared).

### 8. Eighth Embodiment

### Computer

The above-described series of processes may be executed by hardware or executed by software. In a case where the series of processes is executed by software, a program configuring the software is installed into a computer. Here, computers include a computer incorporated into dedicated hardware, a general-purpose personal computer capable of executing various kinds of functions by installing various kinds of programs, and so forth.

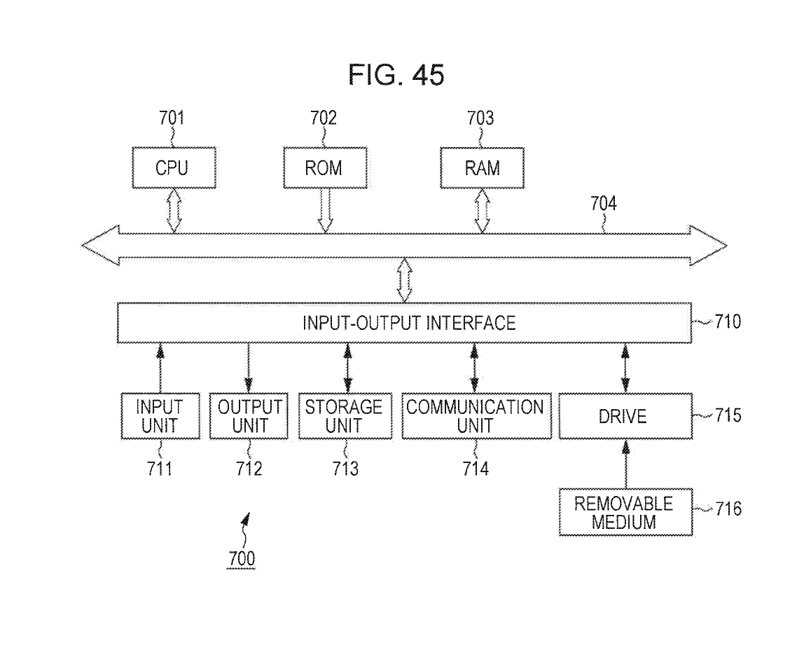

In FIG. 45, it is a block diagram illustrating an example of the configuration of the hardware of the computer executing the above-described series of processes on the basis of the program.

In a computer 700, a CPU (Central Processing Unit) 701, a ROM (Read Only Memory) 702, and a RAM (Random Access Memory) 703 are connected to one another through a bus 704.

Furthermore, an input-output interface 710 is connected to the bus 704. An input unit 711, an output unit 712, a storage unit 713, a communication unit 714, and a drive 715 are connected to the input-output interface 710.

The input unit 711 is configured by a keyboard, a mouse, a microphone, or the like. The output unit 712 is configured by a display, a speaker, or the like. The storage unit 713 is configured by a hard disk, a non-volatile memory, or the like. The communication unit 714 is configured by a network interface, or the like. The drive 715 drives a removable medium 716 such as a magnetic disc, an optical disc, a magnet-optical disc, or a semiconductor memory.

In the computer configured as described above, the CPU 701 loads the program stored in, for example, the storage unit 713 into the RAM 703 via the input-output interface 710 and the bus 704 and executes the program, and hence, the above-mentioned series of processes is performed.

The program the computer 700 (CPU 701) executes may be recorded in, for example, the removable medium 716 as a package medium or the like and provided. In addition, the program may be provided via a wired or wireless transmission medium such as a local-area network, the Internet, or digital satellite broadcasting.

In the computer, by mounting the removable medium 716 to the drive 715, it is possible to install the program into the storage unit 713 via the input-output interface 710. In addition, it is possible for the program to be received by the communication unit 714 via the wired or wireless transmission medium and installed into the storage unit 713. In addition to this, it is also possible to install the program into the ROM 702 or the storage unit 713 in advance.

In addition, the program the computer executes may be a program in which processes are performed in time series in accordance with the order described in the present specification, or may be a program in which processes are performed in parallel or at a required timing such as when calling is performed.

In addition, in the present specification, a step of describing the program recorded in the recording medium includes not only the processes performed in a time-series manner in accordance with the described order but also the processes executed in parallel or individually, which are not necessarily performed in a time-series manner.

In addition, in the present specification, a system expresses an entire device including a plurality of devices (devices).

In addition, the configuration described above as a single device (or processing unit) may be divided to be configured as a plurality of devices (or processing units). In contrast, the configurations described above as a plurality of devices (or processing units) may be combined to be configured as a single device (or processing unit). In addition, a configuration other than that described above may of course be added to the configuration of each device (or each unit). Furthermore, as long as a configuration and an operation as the entire system are substantially the same, part of the configuration of a certain device (or processing unit) may be included in the configuration of another device (or another processing unit). In other words, the present technology is not limited to the above-described embodiments, and various modifications may be made without departing from the scope of the present technology.

Although, as above, preferred embodiments of the present disclosure have been described in detail with reference to the attached drawings, the technical scope of the present disclosure is not limited to such examples. It is clear that a person having ordinary skill in the technical field of the present disclosure may conceive of various modifications or alterations within the scope of the technical idea described in claims and it is understood that they also naturally belong to the technical scope of the present disclosure.

For example, the present technology may have the configuration of cloud computing where one function is shared via a network and processed in cooperation by a plurality of devices.

In addition, each step described in the above-mentioned flowcharts may be shared and executed by a plurality of devices in addition to being executed in one device.

Furthermore, in a case where a plurality of processes are included in one step, the plural processes included in the one step may be shared and executed by a plurality of devices in addition to being executed in one device.

The image encoding devices and the image decoding devices according to the above-mentioned embodiments may be applied to various electronic devices such as transmitters or receivers in satellite broadcasting, wired broadcasting such as cable television, distribution on the Internet, distribution to terminals based on cellular communication, and the like, recording devices recording images in media such as an optical disc, a magnetic disc, and a flash memory, or reproducing devices reproducing images from these storage media. Hereinafter, four examples of application will be described.

### 9. Examples of Application

### First Example of Application

### Television Receiver

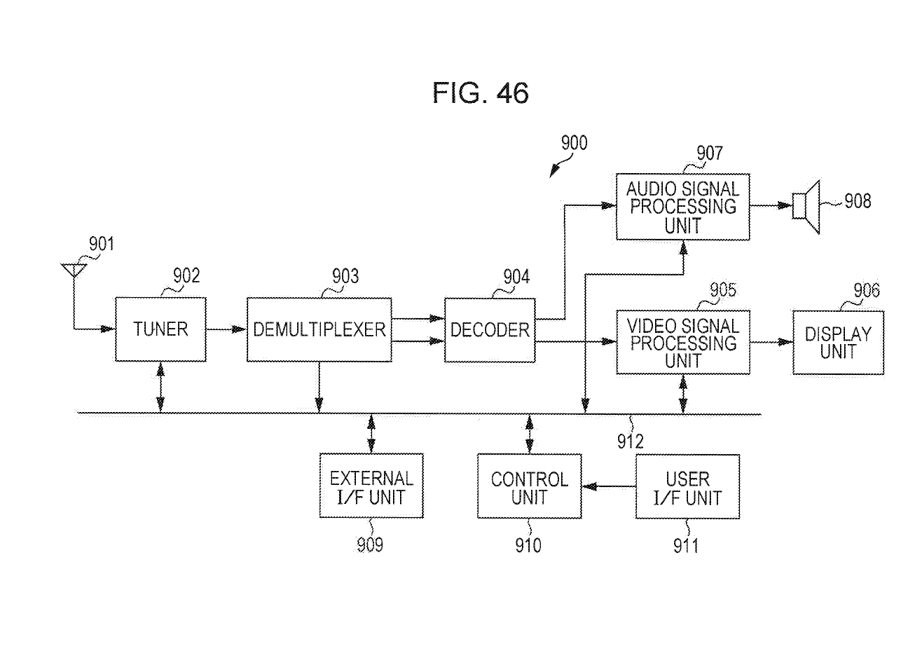

FIG. 46 illustrates an example of the schematic configuration of a television device to which the above-mentioned embodiment is applied. A television device 900 includes an antenna 901, a tuner 902, a demultiplexer 903, a decoder 904, a video signal processing unit 905, a display unit 906, an audio signal processing unit 907, a speaker 908, an external interface 909, a control unit 910, a user interface 911, and a bus 912.

The tuner 902 extracts the signal of a desired channel from a broadcast signal received through the antenna 901 and demodulates the extracted signal. In addition, the tuner 902 outputs, to the demultiplexer 903, an encoded bit stream obtained by demodulation. In other words, the tuner 902 has a role as a transmission mechanism in the television device 900, which receives an encoded stream in which an image is encoded.

The demultiplexer 903 separates a video stream and an audio stream of a program serving as a viewing and listening target from the encoded bit stream and outputs each separated stream to the decoder 904. In addition, the demultiplexer 903 extracts auxiliary data such as EPG (Electronic Program Guide) from the encoded bit stream and supplies the extracted data to the control unit 910. In addition, in a case where the encoded bit stream is scrambled, the demultiplexer 903 may also perform descrambling.

The decoder 904 decodes the video stream and the audio stream input from the demultiplexer 903. In addition, the decoder 904 outputs video data generated by a decoding process to the video signal processing unit 905. In addition, the decoder 904 outputs audio data generated by the decoding process to the audio signal processing unit 907.

The video signal processing unit 905 reproduces the video data input from the decoder 904 and causes the display unit 906 to display video. In addition, the video signal processing unit 905 may also cause the display unit 906 to display an application screen supplied through a network. In addition, the video signal processing unit 905 may also perform an additional process such as, for example, noise removal, on the video data in accordance a setting. Furthermore, the video signal processing unit 905 may also generate a GUI (Graphical User Interface) image such as, for example, a menu, a button, or a cursor and superimpose the generated image on an output image.

The display unit 906 is driven by a drive signal supplied from the video signal processing unit 905 and displays the video or image on a video screen of a display device (for example, a liquid crystal display, a plasma display, an OELD (Organic ElectroLuminescence Display (organic EL display), or the like).

The audio signal processing unit 907 performs a reproducing process such as D/A conversion and amplification on the audio data input from the decoder 904 and causes the audio to be output from the speaker 908. In addition, the audio signal processing unit 907 may also perform an additional process such as the noise removal on the audio data.

The external interface 909 is an interface for connecting the television device 900 and an external device or the network to each other. For example, the video stream or the audio stream received through the external interface 909 may be decoded by the decoder 904. In other words, the external interface 909 also has a role as a transmission mechanism in the television device 900, which receives the encoded stream in which the image is encoded.

The control unit 910 includes a processor such as a CPU, and memories such as a RAM and a ROM. The memory stores therein a program executed by the CPU, program data, EPG data, data obtained through the network, and the like. The program stored by the memory is read by the CPU at the time of, for example, the activation of the television device 900, and executed. By executing the program, the CPU controls the operation of the television device 900 in accordance with an operation signal input from, for example, the user interface 911.

The user interface 911 is connected to the control unit 910. The user interface 911 includes, for example, a button and a switch for the user to operate the television device 900, a receiving unit for a remote control signal, and the like. The user interface 911 generates an operation signal by detecting an operation by the user through these configuration elements, and outputs the generated operation signal to the control unit 910.

The bus 912 connects the tuner 902, the demultiplexer 903, the decoder 904, the video signal processing unit 905, the audio signal processing unit 907, the external interface 909, and the control unit 910 to one another.

In the television device 900 configured in this way, the decoder 904 has functions of an image decoding device according to the above-described embodiments. Owing to that, in decoding an image in the television device 900, it is possible to realize the reduction of the amount of memory access and the amount of computation with minimizing image deterioration.

### Second Example of Application

### Mobile Phone

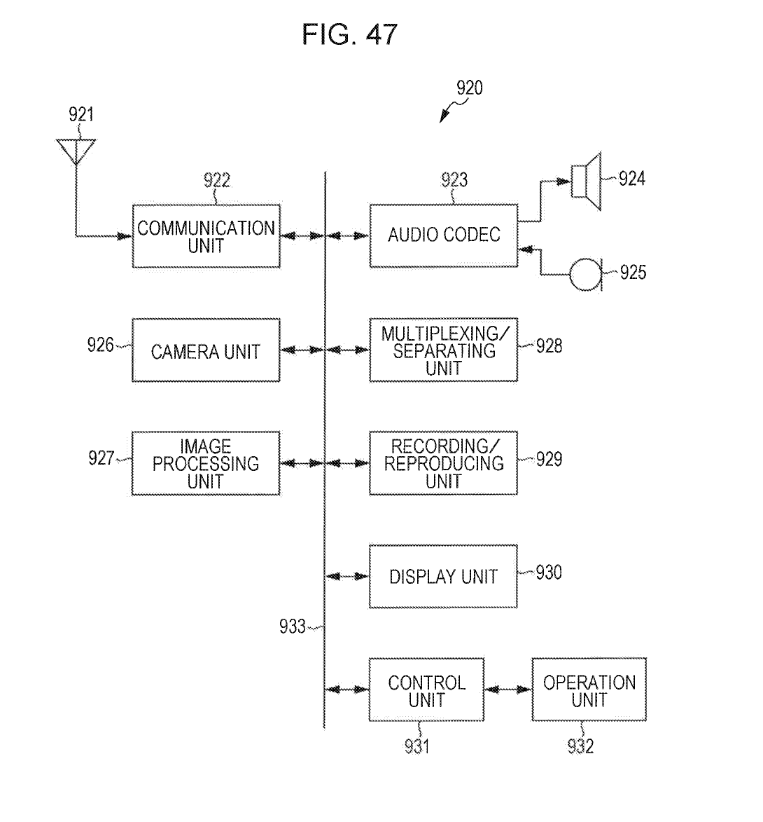

FIG. 47 illustrates an example of the schematic configuration of a mobile phone to which the above-mentioned embodiment is applied. A mobile phone 920 includes an antenna 921, a communication unit 922, an audio codec 923, a speaker 924, a microphone 925, a camera unit 926, an image processing unit 927, a multiplexing/separating unit 928, a recording/reproducing unit 929, a display unit 930, a control unit 931, an operation unit 932, and a bus 933.

The antenna 921 is connected to the communication unit 922. The speaker 924 and the microphone 925 are connected to the audio codec 923. The operation unit 932 is connected to the control unit 931. The bus 933 connects the communication unit 922, the audio codec 923, the camera unit 926, the image processing unit 927, the multiplexing/separating 928, the recording/reproducing unit 929, the display unit 930, and the control unit 931 to one another.

The mobile phone 920 performs operations such as the transmission/reception of an audio signal, the transmission/reception of an electronic mail or image data, the capturing of an image, and the recording of data in various operation modes including a voice call mode, a data communication mode, an imaging mode, and a television-phone mode.

In the voice call mode, an analog audio signal generated by the microphone 925 is supplied to the audio codec 923. The audio codec 923 converts the analog audio signal into audio data, and A/D-converts and compresses the converted audio data. In addition, the audio codec 923 outputs the audio data after compression to the communication unit 922. The communication unit 922 encodes and modulates the audio data, and generates a transmission signal. In addition, the communication unit 922 transmits the generated transmission signals to a base station (not illustrated in a drawing) through the antenna 921. In addition, the communication unit 922 amplifies a wireless signal received through the antenna 921, performs thereon frequency conversion, and acquires a reception signal. In addition, the communication unit 922 generates audio data by demodulating and decoding the reception signal, and outputs the generated audio data to the audio codec 923. The audio codec 923 expands and D/A converts the audio data, and generates an analog audio signal. In addition, the audio codec 923 outputs the generated audio signal to the speaker 924, and causes audio to be output.

In addition, in the data communication mode, for example, the control unit 931 generates character data composing an electronic mail in response to an operation by a user through the operation unit 932. In addition, the control unit 931 causes the display unit 930 to display characters. In addition, the control unit 931 generates electronic mail data in response to a transmission instruction from the user through the operation unit 932, and outputs the generated electronic mail data to the communication unit 922. The communication unit 922 encodes and modulates the electronic mail data, and generates a transmission signal. In addition, the communication unit 922 transmits the generated transmission signal to a base station (not illustrated in a drawing) through the antenna 921. In addition, the communication unit 922 amplifies a wireless signal received through the antenna 921, performs thereon frequency conversion, and acquires a reception signal. In addition, the communication unit 922 restores electronic mail data by demodulating and decoding the reception signal, and outputs the restored electronic mail data to the control unit 931. The control unit 931 causes the display unit 930 to display the content of an electronic mail, and causes the electronic mail data to be stored in a storage medium in the recording/reproducing unit 929.

The recording/reproducing unit 929 includes an arbitrary readable/writable storage medium. For example, the storage medium may be a built-in storage medium such as a RAM or a flash memory, and may also be an externally-mounted storage medium such as a hard disk, a magnetic disc, a magneto-optical disc, an optical disc, a USB (Unallocated Space Bitmap) memory, or a memory card.

In addition, in the imaging mode, for example, the camera unit 926 generates image data by capturing the image of an object, and outputs the generated image data to the image processing unit 927. The image processing unit 927 encodes the image data input from the camera unit 926, and causes an encoded stream to be stored in the storage medium in the storing/reproducing unit 929.

In addition, in the television-phone mode, for example, the multiplexing/separating 928 multiplexes a video stream encoded by the image processing unit 927 and an audio stream input from the audio codec 923, and outputs the multiplexed stream to the communication unit 922. The communication unit 922 encodes and modulates the stream, and generates a transmission signal. In addition, the communication unit 922 transmits the generated transmission signal to a base station (not illustrated in a drawing) through the antenna 921. In addition, the communication unit 922 amplifies a wireless signal received through the antenna 921, and performs thereon frequency conversion, and acquires a reception signal. These transmission signal and reception signal may include encoded bit streams. In addition, the communication unit 922 restores a stream by demodulating and decoding the reception signal, and outputs the restored stream to the multiplexing/separating 928. The multiplexing/separating 928 separates a video stream and an audio stream from the input stream, and outputs the video stream and the audio stream to the image processing unit 927 and the audio codec 923, respectively. The image processing unit 927 decodes the video stream, and generates video data. The video data is supplied to the display unit 930, and a series of images is displayed by the display unit 930. The audio codec 923 expands and D/A converts the audio stream, and generates an analog audio signal. In addition, the audio codec 923 supplies the generated audio signal to the speaker 924, and causes audio to be output.

In the mobile phone 920 configured in this manner, the image processing unit 927 has the functions of an image encoding device and an image decoding device according to the above-mentioned embodiment. Owing to that, in encoding and decoding an image in the mobile phone 920, it is possible to realize the reduction of the amount of memory access and the amount of computation with minimizing image deterioration.

### Third Example of Application

### Recording/Reproducing Device

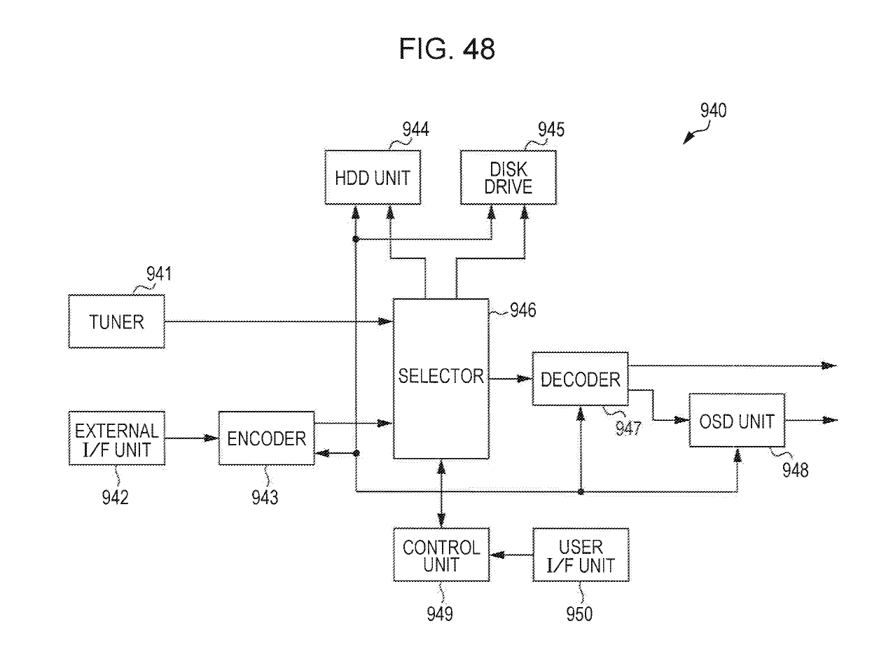

FIG. 48 illustrates an example of the schematic configuration of a recording/reproducing device to which the above-mentioned embodiment is applied. A recording/reproducing device 940 encodes and records, for example, the audio data and the video data of a received broadcast program, in a recording medium. In addition, the recording/reproducing device 940 may also encode and record, for example, audio data and video data, acquired from another device, in a recording medium. In addition, the recording/reproducing device 940 reproduces data recorded in a recording medium on a monitor and a speaker, in response to, for example, the instruction of a user. At this time, the recording/reproducing device 940 decodes audio data and video data.

The recording/reproducing device 940 includes a tuner 941, an external interface 942, an encoder 943, an HDD (Hard disk Drive) 944, a disc drive 945, a selector 946, a decoder 947, an OSD (On-Screen Display) 948, a control unit 949, and a user interface 950.

The tuner 941 extracts the signal of a desired channel from a broadcast signal received through an antenna (not illustrated in a drawing) and demodulates the extracted signal. In addition, the tuner 941 outputs, to the selector 946, an encoded bit stream obtained by demodulation. In other words, the tuner 941 has a role as a transmission mechanism in the recording/reproducing device 940.

The external interface 942 is an interface for connecting the recording/reproducing device 940 and an external device or a network to each other. The external interface 942 may be, for example, an IEEE1394 interface, a network interface, a USB interface, a flash memory interface, or the like. For example, video data and audio data, received through the external interface 942, are input to the encoder 943. In other words, the external interface 942 has a role as a transmission mechanism in the recording/reproducing device 940.

In a case where the video data and the audio data, input from the external interface 942, are not encoded, the encoder 943 encodes the video data and the audio data. In addition, the encoder 943 outputs an encoded bit stream to the selector 946.

The HDD 944 records, in a hard disk therewithin, an encoded bit stream in which contents data such as video or audio is compressed, various kinds of programs, and other data. In addition, at the reproduction of video and audio, the HDD 944 reads out these pieces of data from a hard disk.

The disc drive 945 records and reads data in and from a mounted recording medium. The recording medium mounted to the disc drive 945 may be, for example, a DVD disc (DVD-Video, DVD-RAM, DVD-R, DVD-RW, DVD+R, DVD+RW, or the like), a Blu-ray (registered trademark) disc, or the like.

At the time of recording video and audio, the selector 946 selects an encoded bit stream input from the tuner 941 or the encoder 943, and outputs the selected encoded bit stream to the HDD 944 or the disc drive 945. In addition, at the time of reproducing video and audio, the selector 946 outputs, to the decoder 947, an encoded bit stream input from the HDD 944 or the disc drive 945.

The decoder 947 decodes the encoded bit stream, and generates video data and audio data. In addition, the decoder 947 outputs the generated video data to the OSD 948. In addition, the decoder 904 outputs the generated audio data to an external speaker.

The OSD 948 reproduces the video data input from the decoder 947, and displays video. In addition, the OSD 948 may also superimpose a GUI image such as, for example, a menu, a button, or a cursor on the displayed video.

The control unit 949 includes a processor such as a CPU and memories such as a RAM and a ROM. The memory stores therein a program executed by the CPU, program data, and the like. The program stored in the memory is read by the CPU and executed at the time of, for example, the activation of the recording/reproducing device 940. By executing the program, the CPU controls the operation of the recording/reproducing device 940 in accordance with an operation signal input from, for example, the user interface 950.

The user interface 950 is connected to the control unit 949. The user interface 950 includes, for example, a button and a switch for the user to operate the recording/reproducing apparatus 940 and a receiving unit for a remote control signal. The user interface 950 generates an operation signal by detecting an operation by the user through these configuration elements, and outputs the generated operation signal to the control unit 949.

In the recording/reproducing device 940 configured in this manner, the encoder 943 has the function of an image encoding device according to the above-mentioned embodiment. In addition, the decoder 947 has the function of an image decoding device according to the above-mentioned embodiment. Owing to that, in encoding and decoding an image in the recording/reproducing device 940, it is possible to realize the reduction of the amount of memory access and the amount of computation with minimizing image deterioration.

### Fourth Example of Application

### Imaging Device

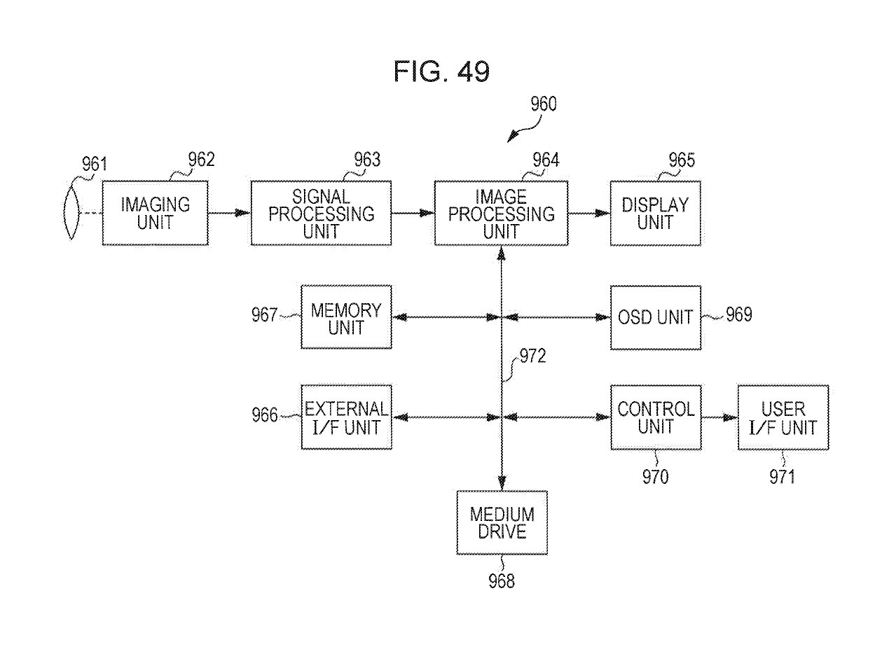

FIG. 49 illustrates an example of the schematic configuration of an imaging device to which the above-mentioned embodiment is applied. An imaging device 960 generates an image by capturing the image of an object, and encodes and records image data, in a recording medium.

The imaging device 960 includes an optical block 961, an imaging unit 962, a signal processing unit 963, an image processing unit 964, a display unit 965, an external interface 966, a memory 967, a medium drive 968, an OSD 969, a control unit 970, a user interface 971, and a bus 972.

The optical block 961 is connected to the imaging unit 962. The imaging unit 962 is connected to the signal processing unit 963. The display unit 965 is connected to the image processing unit 964. The user interface 971 is connected to the control unit 970. The bus 972 connects the image processing unit 964, the external interface 966, the memory 967, the medium drive 968, the OSD 969, and the control unit 970 to one another.

The optical block 961 includes a focus lens, a diaphragm mechanism, and so forth. The optical block 961 image-forms an optical image of an object on the imaging surface of the imaging unit 962. The imaging unit 962 includes an image sensor such as a CCD (Charge Coupled Device) or a CMOS (Complementary Metal Oxide Semiconductor), and converts the optical image image-formed on the imaging surface into an image signal as an electric signal through photoelectric conversion. In addition, the imaging unit 962 outputs the image signal to the signal processing unit 963.

The signal processing unit 963 performs various camera signal processes such as knee correction, gamma correction, and color correction on the image signal input from the imaging unit 962. The signal processing unit 963 outputs image data after the camera signal processes to the image processing unit 964.

The image processing unit 964 encodes the image data input from the signal processing unit 963, and generates encoded data. In addition, the image processing unit 964 outputs the generated encoded data to the external interface 966 or the medium drive 968. In addition, the image processing unit 964 decodes the encoded data input from the external interface 966 or the medium drive 968, and generates the image data. In addition, the image processing unit 964 outputs the generated image data to the display unit 965. In addition, the image processing unit 964 may also output the image data input from the signal processing unit 963 to the display unit 965 and cause an image to be displayed. In addition, the image processing unit 964 may also superimpose data for display obtained from the OSD 969, on the image output to the display unit 965.

The OSD 969 generates a GUI image such as, for example, a menu, a button, or a cursor, and outputs the generated image to the image processing unit 964.

The external interface 966 is configured as, for example, a USB input/output terminal. The external interface 966 connects the imaging device 960 and a printer to each other at the time of, for example, printing an image. In addition, a drive is connected to the external interface 966 as appropriate. A removable medium such as, for example, a magnetic disc and an optical disc is mounted to the drive, and a program read from the removable medium may be installed into the imaging device 960. Furthermore, the external interface 966 may be configured as a network interface connected to a network such as a LAN and the Internet. In other words, the external interface 966 has a role as a transmission mechanism in the imaging device 960.

A recording medium mounted to the medium drive 968 may be an arbitrary readable/writable removable medium such as, for example, a magnetic disc, a magneto-optical disc, an optical disc, or a semiconductor memory. The recording medium may also be fixedly mounted to the medium drive 968, and a non-portable storage unit such as, for example, a built-in hard disk drive or an SSD (Solid State Drive) may be configured.

The control unit 970 includes a processor such as a CPU and memories such as a RAM and a ROM. The memory stores therein a program executed by the CPU, program data, and so forth. The program stored by the memory is read by the CPU at the time of, for example, the activation of the imaging device 960, and executed. By executing the program, the CPU controls the operation of the imaging device 960 in accordance with an operation signal input from, for example, the user interface 971.

The user interface 971 is connected to the control unit 970. The user interface 971 includes, for example, a button, a switch, and so forth for the user to operate the imaging device 960. By detecting an operation by the user through these configuration elements, the user interface 971 generates an operation signal, and outputs the generated operation signal to the control unit 970.

In the imaging device 960 configured in this manner, the image processing unit 964 has the functions of an image encoding device and an image decoding device according to the above-mentioned embodiment. Owing to that, in encoding and decoding an image in the imaging device 960, it is possible to realize the reduction of the amount of memory access and the amount of computation with minimizing image deterioration.

In addition, in the present specification, a case has been described where various kinds of information such as the code number of a prediction motion vector, the difference motion vector information, and the flag information indicating on/off of a temporal prediction motion vector in each prediction direction are multiplexed with an encoded stream and transmitted from an encoding side to a decoding side. However, a method for transmitting these pieces of information is not limited to such an example. For example, these pieces of information may also be transmitted or recorded as individual pieces of data associated with an encoded bit stream, without being multiplexed with the encoded stream. Herein, the term “associate” means that an image included in the bit stream (may also be a part of the image such as a slice or a block) and information corresponding to a relevant image may be linked with each other at the time of decoding. In other words, the information may be transmitted on a transmission path other than that of the image (or the bit stream). In addition, the information may be recorded in a recording medium other than that of the image (or the bit stream) (or another recording area of the same recording medium). Furthermore, the information and the image (or the bit stream) may be associated with each other in an arbitrary unit such as, for example, a plurality of frames, one frame, or a part within the frame.

Although, as above, preferred embodiments of the present disclosure have been described in detail with reference to the attached drawings, the present disclosure is not limited to such examples. It is clear that a person having ordinary skill in the technical field to which the present disclosure belongs may conceive of various modifications or alterations within the scope of the technical idea described in claims and it is understood that they also naturally belong to the technical scope of the present disclosure.

In addition, the present technology may also adopt the following configurations.

(1) An image processing device including

a reception unit that receives a flag with respect to each prediction direction and an encoded stream with a prediction motion vector as a target, the prediction motion vector being used in decoding a motion vector of a current region in an image, the flag indicating whether or not a temporal prediction vector generated using a motion vector of a temporally neighboring region temporally located on the periphery of the current region is available,

a prediction motion vector generation unit that generates a prediction motion vector of the current region using a motion vector of a neighboring region located on the periphery of the current region, on the basis of whether or not the temporal prediction vector is available, which is indicated by the flag received by the reception unit,

a motion vector decoding unit that decodes the motion vector of the current region using the prediction motion vector generated by the prediction motion vector generation unit, and

a decoding unit that decodes, using the motion vector decoded by the motion vector decoding unit, the encoded stream received by the reception unit and generates the image.

(2) The image processing device according to the above-mentioned (1), wherein

the reception unit receives a flag with respect to each prediction direction, the flag indicating whether or not the temporal prediction vector is available and being set in a parameter in a picture unit.

(3) The image processing device according to any one of the above-mentioned (1) and (2), wherein

the temporal prediction vector is set to be available with respect to one of the prediction directions, and set to be unavailable with respect to the other of the prediction directions.

(4) The image processing device according to the above-mentioned (3), wherein

in a case where a current picture is a picture in which rearrangement exists, the one of the prediction directions is a List0 direction, and in a case where the current picture is a picture in which rearrangement does not exist, the one of the prediction directions is a List1 direction.

(5) The image processing device according to the above-mentioned (3), wherein

in a case where a distance of a reference picture from a current picture in a List0 direction is different from a distance of a reference picture from the current picture in a List1 direction, the one of the prediction directions is a direction with respect to a reference picture near to the current picture on a temporal axis.

(6) The image processing device according to any one of the above-mentioned (2) to (5), wherein

the flag with respect to each prediction direction, which indicates whether or not the temporal prediction vector is available, is generated independently in AMVP (Advanced Motion Vector Prediction) and a merge mode.

(7) An image processing method, wherein

an image processing device

receives a flag with respect to each prediction direction and an encoded stream with a prediction motion vector as a target, the prediction motion vector being used in decoding a motion vector of a current region in an image, the flag indicating whether or not a temporal prediction vector generated using a motion vector of a temporally neighboring region temporally located on the periphery of the current region is available,

generates a prediction motion vector of the current region using a motion vector of a neighboring region located on the periphery of the current region, on the basis of whether or not the temporal prediction vector is available, which is indicated by the received flag,

decodes the motion vector of the current region using the generated prediction motion vector, and

decodes, using the decoded motion vector, the received encoded stream and generates the image.

(8) An image processing device including

a temporal prediction control unit that sets, with respect to each prediction direction, whether or not a temporal prediction vector is available, with a prediction motion vector as a target, the prediction motion vector being used in encoding a motion vector of a current region in an image, the temporal prediction vector being generated using a motion vector of a temporally neighboring region temporally located on the periphery of the current region, a prediction motion vector generation unit that generates a prediction motion vector of the current region using a motion vector of a neighboring region located on the periphery of the current region, on the basis of whether or not the temporal prediction vector is available, which is set by the temporal prediction control unit,

a flag setting unit that sets a flag with respect to each prediction direction, the flag indicating whether or not the temporal prediction vector is available, which is set by the temporal prediction control unit, and

a transmitting unit that transmits the flag set by the flag setting unit and an encoded stream to which the image is encoded.

(9) The image processing device according to the above-mentioned (8), wherein

the flag setting unit sets, in a parameter in a picture unit, the flag with respect to each prediction direction, the flag indicating whether or not the temporal prediction vector is available, which is set by the temporal prediction control unit, and adds the flag to the encoded stream.

(10) The image processing device according to any one of the above-mentioned (8) and (9), wherein

the temporal prediction control unit sets the temporal prediction vector to be available with respect to one of the prediction directions, and sets the temporal prediction vector to be unavailable with respect to the other of the prediction directions.

(11) The image processing device according to the above-mentioned (10), wherein

in a case where a current picture is a picture in which rearrangement exists, the one of the prediction directions is a List0 direction, and in a case where the current picture is a picture in which rearrangement does not exist, the one of the prediction directions is a List1 direction.

(12) The image processing device according to any one of the above-mentioned (10), wherein

in a case where a distance of a reference picture from a current picture in a List0 direction is different from a distance of a reference picture from the current picture in a List1 direction, the one of the prediction directions is a direction with respect to a reference picture near to the current picture on a temporal axis.

(13) The image processing device according to any one of the above-mentioned (9) to (12), wherein

the temporal prediction control unit sets independently whether or not the temporal prediction vector is available, in AMVP (Advanced Motion Vector Prediction) and a merge mode.

(14) An image processing method including

setting, with respect to each prediction direction, whether or not a temporal prediction vector is available, with a prediction motion vector as a target, the prediction motion vector being used in encoding a motion vector of a current region in an image, the temporal prediction vector being generated using a motion vector of a temporally neighboring region temporally located on the periphery of the current region,

generating a prediction motion vector of the current region using a motion vector of a neighboring region located on the periphery of the current region, on the basis of whether or not the temporal prediction vector is available, which is set,

setting a flag with respect to each prediction direction, the flag indicating whether or not the temporal prediction vector is available, which is set, and

transmitting the set flag and an encoded stream to which the image is encoded.

(15) An image processing device including

a reception unit that receives encoded data of a parameter used in encoding an image and information indicating a pattern of whether or not temporal prediction is to be used that performs prediction using the parameter of a temporally neighboring region temporally located on the periphery of a current region,

a prediction parameter generation unit that generates a prediction parameter serving as a prediction value of the parameter, in accordance with the pattern received by the reception unit, and

a parameter decoding unit that decodes the encoded data of the parameter received by the reception unit, using the prediction parameter generated by the prediction parameter generation unit, and reconstructs the parameter.

(16) The image processing device according to the above-mentioned (15), wherein

the pattern is a pattern specifying, for each picture, whether or not the temporal prediction is to be used, with respect to a plurality of pictures.

(17) The image processing device according to the above-mentioned (16), wherein

the pattern classifies whether or not the temporal prediction is to be used, on the basis of a layer of a hierarchical structure formed by the plural pictures.

(18) The image processing device according to the above-mentioned (16), wherein

the pattern classifies whether or not the temporal prediction is to be used, on the basis of an arrangement order of the plural pictures.

(19) The image processing device according to any one of the above-mentioned (15) to (18), wherein

the parameter is a motion vector and the prediction parameter is a prediction motion vector,

the reception unit receives encoded data of the motion vector and the information indicating a pattern of whether or not the temporal prediction is to be used,

the prediction parameter generation unit generates the prediction motion vector using a prediction method specified in the encoded data of the motion vector, in accordance with the pattern received by the reception unit, and

the parameter decoding unit decodes the encoded data of the motion vector received by the reception unit, using the prediction motion vector generated by the prediction parameter generation unit, and reconstructs the motion vector.

(20) The image processing device according to any one of the above-mentioned (15) to (19), wherein the parameter is a difference between a quantization parameter of a block processed with preceding by one and a quantization parameter of a current block.

(21) The image processing device according to any one of the above-mentioned (15) to (20), wherein

the parameter is a parameter of arithmetic coding utilizing a context.

(22) The image processing device according to any one of the above-mentioned (15) to (21), wherein

the reception unit further receives encoded data of the image, and

the image processing device further includes

an image decoding unit that decodes the encoded data of the image received by the reception unit, using the parameter reconstructed by the parameter decoding unit.

(23) An image processing method for an image processing device, wherein

the image processing device
receives encoded data of a parameter used in encoding an image and information indicating a pattern of whether or not temporal prediction is to be used that performs prediction using the parameter of a temporally neighboring region temporally located on the periphery of a current region,
generates a prediction parameter serving as a prediction value of the parameter, in accordance with the received pattern, and
decodes the received encoded data of the parameter, using the generated prediction parameter, and reconstructs the parameter.

(24) An image processing device including

a setting unit that sets a pattern of whether or not temporal prediction is to be used that performs prediction using a parameter of a temporally neighboring region temporally located on the periphery of a current region,

a prediction parameter generation unit that generates a prediction parameter serving as a prediction value of the parameter, in accordance with the pattern set by the setting unit,

a parameter encoding unit that encodes the parameter using the prediction parameter generated by the prediction parameter generation unit, and

a transmitting unit that transmits encoded data of the parameter, generated by the parameter encoding unit, and information indicating the pattern set by the setting unit.

(25) The image processing device according to the above-mentioned (24), further including

a parameter generation unit that generates the parameter, and

an image encoding unit that encodes the image using the parameter generated by the parameter generation unit, wherein

the setting unit sets a pattern of whether or not the temporal prediction is to be used,

the parameter encoding unit encodes the parameter generated by the parameter generation unit, using the prediction parameter, and

the transmitting unit transmits encoded data of the image generated by the image encoding unit.

(26) An image processing method for an image processing device, wherein

the image processing device
sets a pattern of whether or not temporal prediction is to be used that performs prediction using a parameter of a temporally neighboring region temporally located on the periphery of a current region,
generates a prediction parameter serving as a prediction value of the parameter, in accordance with the set pattern, and
encodes the parameter using the generated prediction parameter, and
transmits generated encoded data of the parameter and information indicating the set pattern.

### EXPLANATION OF REFERENCE (NUMERALS)

100 image encoding device
106 lossless encoding unit
115 motion prediction/compensation unit
121 motion vector encoding unit
122 temporal prediction control unit
151 spatially adjacent motion vector buffer
152 temporally adjacent motion vector buffer
153 candidate prediction motion vector generation unit
154 cost function value calculation unit
155 optimal prediction motion vector determination unit
161 List0 temporal prediction control unit
162 List1 temporal prediction control unit.
171 parameter setting unit
200 image decoding device
202 lossless decoding unit
212 motion prediction/compensation unit
221 motion vector decoding unit
222 temporal prediction control unit
251 prediction motion vector information buffer
252 difference motion vector information buffer
253 prediction motion vector reconstruction unit
254 motion vector reconstruction unit
255 spatially adjacent motion vector buffer
256 temporally adjacent motion vector buffer
261 List0 temporal prediction control unit
262 List1 temporal prediction control unit
271 parameter acquisition unit
300 image encoding device
321 motion vector encoding unit
322 temporal prediction control unit
341 enable_temporal_mvp_hierarchy_flag setting unit
342 layer detection unit
343 tmvp on/off determination unit
351 spatially adjacent motion vector buffer
352 spatial prediction motion vector generation unit
353 optimal predictor determination unit
354 temporally adjacent motion vector buffer
355 temporal prediction motion vector generation unit
400 image decoding device
421 motion vector decoding unit
422 temporal prediction control unit
441 enable_temporal_mvp_hierarchy_flag receiving unit
442 layer information receiving unit
443 tmvp on/off determination unit
451 motion vector reconstruction unit
452 spatial prediction motion vector generation unit
453 spatially adjacent motion vector buffer
454 temporal prediction motion vector generation unit
455 temporally adjacent motion vector buffer

1. An image processing device comprising:
a reception unit that receives a flag with respect to each prediction direction and an encoded stream with a prediction motion vector as a target, the prediction motion vector being used in decoding a motion vector of a current region in an image, the flag indicating whether or not a temporal prediction vector generated using a motion vector of a temporally neighboring region temporally located on the periphery of the current region is available;
a prediction motion vector generation unit that generates a prediction motion vector of the current region using a motion vector of a neighboring region located on the periphery of the current region, on the basis of whether or not the temporal prediction vector is available, which is indicated by the flag received by the reception unit;
a motion vector decoding unit that decodes the motion vector of the current region using the prediction motion vector generated by the prediction motion vector generation unit; and
a decoding unit that decodes, using the motion vector decoded by the motion vector decoding unit, the encoded stream received by the reception unit and generates the image.

2. The image processing device according to claim 1, wherein
the reception unit receives a flag with respect to each prediction direction, the flag indicating whether or not the temporal prediction vector is available and being set in a parameter in a picture unit.

3. The image processing device according to claim 2, wherein
the temporal prediction vector is set to be available with respect to one of the prediction directions, and set to be unavailable with respect to the other of the prediction directions.

4. The image processing device according to claim 3, wherein
in a case where a current picture is a picture in which rearrangement exists, the one of the prediction directions is a List0 direction, and in a case where the current picture is a picture in which rearrangement does not exist, the one of the prediction directions is a List1 direction.

5. The image processing device according to claim 3, wherein
in a case where a distance of a reference picture from a current picture in a List0 direction is different from a distance of a reference picture from the current picture in a List1 direction, the one of the prediction directions is a direction with respect to a reference picture near to the current picture on a temporal axis.

6. The image processing device according to claim 2, wherein
the flag with respect to each prediction direction, which indicates whether or not the temporal prediction vector is available, is generated independently in AMVP (Advanced Motion Vector Prediction) and a merge mode.

7. An image processing method, wherein
an image processing device
receives a flag with respect to each prediction direction and an encoded stream with a prediction motion vector as a target, the prediction motion vector being used in decoding a motion vector of a current region in an image, the flag indicating whether or not a temporal prediction vector generated using a motion vector of a temporally neighboring region temporally located on the periphery of the current region is available,
generates a prediction motion vector of the current region using a motion vector of a neighboring region located on the periphery of the current region, on the basis of whether or not the temporal prediction vector is available, which is indicated by the received flag,
decodes the motion vector of the current region using the generated prediction motion vector, and
decodes, using the decoded motion vector, the received encoded stream and generates the image.

8. An image processing device comprising:
a temporal prediction control unit that sets, with respect to each prediction direction, whether or not a temporal prediction vector is available, with a prediction motion vector as a target, the prediction motion vector being used in encoding a motion vector of a current region in an image, the temporal prediction vector being generated using a motion vector of a temporally neighboring region temporally located on the periphery of the current region;
a prediction motion vector generation unit that generates a prediction motion vector of the current region using a motion vector of a neighboring region located on the periphery of the current region, on the basis of whether or not the temporal prediction vector is available, which is set by the temporal prediction control unit;
a flag setting unit that sets a flag with respect to each prediction direction, the flag indicating whether or not the temporal prediction vector is available, which is set by the temporal prediction control unit; and
a transmitting unit that transmits the flag set by the flag setting unit and an encoded stream to which the image is encoded.

9. The image processing device according to claim 8, wherein
the flag setting unit sets, in a parameter in a picture unit, the flag with respect to each prediction direction, the flag indicating whether or not the temporal prediction vector is available, which is set by the temporal prediction control unit.

10. The image processing device according to claim 9, wherein
the temporal prediction control unit sets the temporal prediction vector to be available with respect to one of the prediction directions, and sets the temporal prediction vector to be unavailable with respect to the other of the prediction directions.

11. The image processing device according to claim 10, wherein
in a case where a current picture is a picture in which rearrangement exists, the one of the prediction directions is a List0 direction, and in a case where the current picture is a picture in which rearrangement does not exist, the one of the prediction directions is a List1 direction.

12. The image processing device according to claim 10, wherein
in a case where a distance of a reference picture from a current picture in a List0 direction is different from a distance of a reference picture from the current picture in a List1 direction, the one of the prediction directions is a direction with respect to a reference picture near to the current picture on a temporal axis.

13. The image processing device according to claim 9, wherein
the temporal prediction control unit sets independently whether or not the temporal prediction vector is available, in AMVP (Advanced Motion Vector Prediction) and a merge mode.

14. An image processing method comprising:
setting, with respect to each prediction direction, whether or not a temporal prediction vector is available, with a prediction motion vector as a target, the prediction motion vector being used in encoding a motion vector of a current region in an image, the temporal prediction vector being generated using a motion vector of a temporally neighboring region temporally located on the periphery of the current region;
generating a prediction motion vector of the current region using a motion vector of a neighboring region located on the periphery of the current region, on the basis of whether or not the temporal prediction vector is available, which is set;
setting a flag with respect to each prediction direction, the flag indicating whether or not the temporal prediction vector is available, which is set; and
transmitting the set flag and an encoded stream to which the image is encoded.

15. An image processing device comprising:
a reception unit that receives encoded data of a parameter used in encoding an image and information indicating a pattern of whether or not temporal prediction is to be used that performs prediction using the parameter of a temporally neighboring region temporally located on the periphery of a current region;
a prediction parameter generation unit that generates a prediction parameter serving as a prediction value of the parameter, in accordance with the pattern received by the reception unit; and
a parameter decoding unit that decodes the encoded data of the parameter received by the reception unit, using the prediction parameter generated by the prediction parameter generation unit, and reconstructs the parameter.

16. The image processing device according to claim 15, wherein
the pattern is a pattern specifying, for each picture, whether or not the temporal prediction is to be used, with respect to a plurality of pictures.

17. The image processing device according to claim 16, wherein
the pattern classifies whether or not the temporal prediction is to be used, on the basis of a layer of a hierarchical structure formed by the plural pictures.

18. The image processing device according to claim 16, wherein
the pattern classifies whether or not the temporal prediction is to be used, on the basis of an arrangement order of the plural pictures.

19. The image processing device according to claim 15, wherein
the parameter is a motion vector and the prediction parameter is a prediction motion vector,
the reception unit receives encoded data of the motion vector and the information indicating a pattern of whether or not the temporal prediction is to be used,
the prediction parameter generation unit generates the prediction motion vector using a prediction method specified in the encoded data of the motion vector, in accordance with the pattern received by the reception unit, and
the parameter decoding unit decodes the encoded data of the motion vector received by the reception unit, using the prediction motion vector generated by the prediction parameter generation unit, and reconstructs the motion vector.

20. The image processing device according to claim 15, wherein
the parameter is a difference between a quantization parameter of a block processed with preceding by one and a quantization parameter of a current block.

21. The image processing device according to claim 15, wherein
the parameter is a parameter of arithmetic coding utilizing a context.

22. The image processing device according to claim 15, wherein
the reception unit further receives encoded data of the image, and
the image processing device further comprises
an image decoding unit that decodes the encoded data of the image received by the reception unit, using the parameter reconstructed by the parameter decoding unit.

23. An image processing method for an image processing device, wherein
the image processing device
receives encoded data of a parameter used in encoding an image and information indicating a pattern of whether or not temporal prediction is to be used that performs prediction using the parameter of a temporally neighboring region temporally located on the periphery of a current region,
generates a prediction parameter serving as a prediction value of the parameter, in accordance with the received pattern, and
decodes the received encoded data of the parameter using the generated prediction parameter, and reconstructs the parameter.

24. An image processing device comprising:
a setting unit that sets a pattern of whether or not temporal prediction is to be used that performs prediction using a parameter of a temporally neighboring region temporally located on the periphery of a current region;
a prediction parameter generation unit that generates a prediction parameter serving as a prediction value of the parameter, in accordance with the pattern set by the setting unit;
a parameter encoding unit that encodes the parameter using the prediction parameter generated by the prediction parameter generation unit; and
a transmitting unit that transmits encoded data of the parameter, generated by the parameter encoding unit, and information indicating the pattern set by the setting unit.

25. The image processing device according to claim 24, further comprising:
a parameter generation unit that generates the parameter; and
an image encoding unit that encodes the image using the parameter generated by the parameter generation unit, wherein
the setting unit sets a pattern of whether or not the temporal prediction is to be used,
the parameter encoding unit encodes the parameter generated by the parameter generation unit, using the prediction parameter, and
the transmitting unit transmits encoded data of the image generated by the image encoding unit.

26. An image processing method for an image processing device, wherein
the image processing device
sets a pattern of whether or not temporal prediction is to be used that performs prediction using a parameter of a temporally neighboring region temporally located on the periphery of a current region,
generates a prediction parameter serving as a prediction value of the parameter, in accordance with the set pattern,
encodes the parameter using the generated prediction parameter, and
transmits generated encoded data of the parameter and information indicating the set pattern.
